(19) United States
(12) Patent Application Publication
(10) Pub. No.: US 2025/0309791 A1
(43) Pub. Date: Oct. 2, 2025

(54) VIBRATION TYPE DRIVING DEVICE

(71) Applicant: CANON KABUSHIKI KAISHA, Tokyo (JP)

(72) Inventors: Kosuke FUJIMOTO, Tochigi (JP); Kenichi KATAOKA, Kanagawa (JP)

(21) Appl. No.: 19/093,032

(22) Filed: Mar. 27, 2025

(30) Foreign Application Priority Data
Mar. 29, 2024 (JP) 2024-057459

(51) Int. Cl. H02N 2/06; H02N 2/02

(52) U.S. Cl. CPC H02N 2/062; H02N 2/026

(57) ABSTRACT

A driving device is provided for a vibration type actuator including a vibrating body including an elastic body and an electro-mechanical energy conversion element, and a contact body that comes into contact with the elastic body, the vibrating body and the contact body relatively moving by a vibration generated in the vibrating body. The vibration includes a first vibration component generated in the vibrating body by a voltage applied to the electro-mechanical energy conversion element, and a second vibration component generated in the vibrating body by contact between the contact body and the elastic body. The driving device detects a signal corresponding to the second vibration component, cancels the second vibration component by superimposing a superimposition voltage component on the voltage, and detects a speed between the vibrating body and the contact body based on the superimposition voltage component.

### BACKGROUND OF THE DISCLOSURE

### Field of the Disclosure

The present disclosure relates to a device that detects and controls the position, speed, and thrust of a vibration type driving device.

### Description of the Related Art

The movement speed of a contact body driven by the vibration of a vibrating body of a vibration type actuator is substantially proportional to the vibration amplitude of the vibrating body in a no-load state, and hence speed control is performed by using a detector that detects the vibration amplitude instead of a speed sensor in the application of simple speed control.

In Japanese Patent Laid-Open No. 5-336765, the speed control is performed by using the vibration amplitude of the vibrating body instead of the speed sensor to control the speed. However, when an external force acts on a moving body, the speed cannot be detected with high accuracy.

Moreover, when the speed is detected by using an encoder or the like, it is difficult to detect the stop state at high speed.

### SUMMARY OF THE DISCLOSURE

To address the above problem, a driving device is provided for a vibration type actuator including a vibrating body including an elastic body and an electro-mechanical energy conversion element, and a contact body that comes into contact with the elastic body, the vibrating body and the contact body relatively moving by a vibration generated in the vibrating body. The vibration includes a first vibration component generated in the vibrating body by a voltage applied to the electro-mechanical energy conversion element, and a second vibration component generated in the vibrating body by contact between the contact body and the elastic body. The driving device detects a signal corresponding to the second vibration component, cancels the second vibration component by superimposing a superimposition voltage component on the voltage, and detects a speed between the vibrating body and the contact body based on the superimposition voltage component.

Further features of the present disclosure will become apparent from the following description of exemplary embodiments with reference to the attached drawings.

### BRIEF DESCRIPTION OF THE DRAWINGS

FIGS. 1A to 1E are views illustrating a first example of a general configuration and vibration shapes of a vibration type actuator of a first embodiment.

FIG. 2 is a diagram illustrating a first example of a configuration of a driving device for the vibration type actuator of the first embodiment.

FIG. 3 provides schematic diagrams illustrating the relationship between the relative speed between a vibrating body and a contact body, and the vibration locus of the vibrating body.

FIGS. 4A to 4D are diagrams explaining first and second examples of detecting a second vibration component according to the first embodiment.

FIGS. 5A to 5F are complex plane diagrams expressing applied voltages, excitation forces, and vibration responses of the vibration type actuator of the first embodiment of the present disclosure, and a superimposition voltage for canceling a friction excitation force and a method of generating the superimposition voltage.

FIGS. 6A to 6F are complex plane diagrams expressing applied voltages, excitation forces, and vibration responses of the vibration type actuator of the first embodiment of the present disclosure, and a superimposition voltage for canceling a friction excitation force and a method of generating the superimposition voltage.

FIGS. 7A and 7B are graphs presenting the relationship between the speed and the superimposition voltage coefficient according to the first embodiment.

FIGS. 8A to 8E are complex plane diagrams expressing a method of generating a superimposition voltage component in a second example of the superimposition voltage component according to the first embodiment.

FIGS. 9A to 9E are complex plane diagrams expressing a method of generating the superimposition voltage component in the second example of the superimposition voltage component according to the first embodiment.

FIG. 10 provides diagrams explaining a fourth example of detecting the second vibration component according to the first embodiment.

FIG. 11 provides diagrams explaining a method of obtaining the magnitudes of vectors of a same-direction component and a normal-direction component of a push-up vibration direction from vibration waveforms according to the first embodiment.

FIG. 12 is a diagram explaining a fifth example of detecting the second vibration component according to the first embodiment.

FIG. 13 provides diagrams explaining sixth and seventh examples of detecting the second vibration component according to the first embodiment.

FIGS. 14A and 14B are diagrams illustrating an equivalent circuit model of a driving circuit and the vibrating body according to the first embodiment, and a second example of the configuration of the driving device for the vibration type actuator using the equivalent circuit model.

FIGS. 15A and 15B are diagrams explaining a third example of the configuration of the driving device for the vibration type actuator according to the first embodiment, and a function of a current signal generation unit used in this example.

FIGS. 16A and 16B are diagrams illustrating fourth and fifth examples of the configuration of the driving device for the vibration type actuator according to the first embodiment.

FIG. 17 is a flowchart presenting an operation of controlling a speed executed by a central processing unit (CPU) according to the first embodiment.

FIGS. 18A and 18B are flowcharts presenting an operation of controlling a push-up vibration amplitude executed by the CPU according to the first embodiment.

FIG. 19 is a diagram illustrating a sixth example of the configuration of the driving device for the vibration type actuator according to the first embodiment.

FIGS. 20A to 20D are views illustrating a second example of the general configuration and the vibration shapes of the vibration type actuator according to the first embodiment.

FIGS. 21A to 21D are views illustrating a third example of the general configuration and the vibration shapes of the vibration type actuator according to the first embodiment.

FIGS. 22A and 22B are graphs presenting a reference speed and a ratio (B) of a change in thrust to a change in speed according to the first embodiment.

FIGS. 23A and 23B are views illustrating a first example of a general configuration of a vibration type actuator according to a second embodiment.

FIG. 24 is a diagram illustrating a first example of a configuration of a driving device for the vibration type actuator according to the second embodiment.

FIGS. 25A to 25D are diagrams explaining first and second examples of detecting a second vibration component according to the second embodiment.

FIGS. 26A to 26F are complex plane diagrams expressing applied voltages, excitation forces, and vibration responses of the vibration type actuator of the second embodiment of the present disclosure, and a superimposition voltage for canceling a friction excitation force and a method of generating the superimposition voltage.

FIG. 27 provides diagrams explaining a fourth example of detecting the second vibration component according to the second embodiment.

FIG. 28 provides diagrams explaining a method of obtaining the magnitudes of vectors of a same-direction component and a normal-direction component of a push-up vibration direction from vibration waveforms according to the second embodiment.

FIG. 29 is a diagram explaining a fifth example of detecting the second vibration component according to the second embodiment.

FIG. 30 provides diagrams explaining sixth and seventh examples of detecting the second vibration component according to the second embodiment.

FIGS. 31A and 31B are diagrams illustrating an equivalent circuit model of a driving circuit and a vibrating body according to the second embodiment, and a second example of the configuration of the driving device for the vibration type actuator using the equivalent circuit model.

FIG. 32 is a diagram illustrating a third example of the configuration of the driving device for the vibration type actuator according to the second embodiment.

FIG. 33 is a flowchart presenting an operation of controlling a speed executed by a CPU according to the second embodiment.

FIGS. 34A and 34B are graphs presenting a reference speed and a ratio (B) of a change in torque to a change in speed according to the second embodiment.

FIG. 35 is a view illustrating an example of a general configuration of a vibration type actuator according to a third embodiment.

FIG. 36 is a diagram illustrating a configuration example of a driving device for the vibration type actuator according to the third embodiment.

FIGS. 37A to 37C are views illustrating a general configuration of a vibration type actuator according to a fourth embodiment, electrical connection of piezoelectric body electrodes, and a first example of the positional relationship between a protruding structure of a vibrating body and a piezoelectric body.

FIGS. 38A and 38B are diagrams illustrating first and second examples of a configuration of a driving device for the vibration type actuator according to the fourth embodiment.

FIGS. 39A and 39B are views illustrating second and third examples of the positional relationship between the protruding structure provided on the vibrating body and the piezoelectric body of the vibration type actuator according to the fourth embodiment.

FIG. 40 is a diagram illustrating a third example of the configuration of the driving device for the vibration type actuator according to the fourth embodiment.

FIGS. 41A and 41B are graphs presenting a reference speed and a ratio (B) of a change in torque to a change in speed according to the fourth embodiment.

FIGS. 42A and 42B are diagrams illustrating first and second examples of a configuration of a driving device for a vibration type actuator according to a fifth embodiment.

FIGS. 43A to 43C are views illustrating an example of a general configuration of a vibration type actuator according to a sixth embodiment.

FIGS. 44A to 44C are views illustrating vibration modes of the vibration type actuator according to the sixth embodiment.

FIGS. 45A and 45B are diagrams illustrating first and second examples of a configuration of a driving device for the vibration type actuator according to the sixth embodiment.

### DESCRIPTION OF THE EMBODIMENTS

A vibration type driving device for implementing the present disclosure includes the following.

First, the vibration type driving device includes a vibration type actuator including a vibrating body including an elastic body and an electro-mechanical energy conversion element, and a contact body that comes into contact with the elastic body; and a control device for the vibration type actuator.

In the vibration type driving device, the vibrating body and the contact body relatively move in a predetermined movement direction by a vibration of the vibrating body.

The vibration includes a first vibration component generated in the vibrating body by a voltage applied to the electro-mechanical energy conversion element, and a second vibration component generated in the vibrating body by contact between the contact body and the elastic body. Based on this, the control device detects a signal corresponding to the second vibration component, and cancels the second vibration component by superimposing a superimposition voltage component on the voltage that is applied to the electro-mechanical energy conversion element. In addition, the control device detects a relative speed between the vibrating body and the contact body based on the superimposition voltage component.

Hereinafter, the detailed description will be given with reference to the drawings.

### First Embodiment

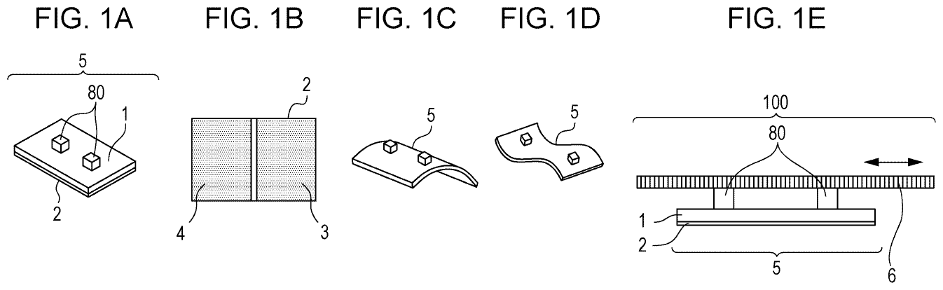

FIGS. 1A to 1E are views illustrating an example of a general configuration and vibration shapes of a vibration type actuator 100 according to a first embodiment of the present disclosure. The general configuration and an operation principle of the vibration type actuator 100 according to the first embodiment will be described with reference to FIGS. 1A to 1E.

As illustrated in FIG. 1E, the vibration type actuator 100 according to the first embodiment includes a vibrating body 5 and a contact body 6. As illustrated in FIG. 1A and FIG. 1E, the vibrating body 5 includes a piezoelectric element 2, and an elastic body 1 including two protruding portions 80 that come into contact with the contact body 6. The piezoelectric element 2 is a component that forms a portion of the vibrating body 5 and excites the vibrating body 5.

The piezoelectric element 2 is made of a piezoelectric material and includes electrodes. As illustrated in FIG. 1B, an electrode 3 and an electrode 4 are formed on the front surface of the piezoelectric material subjected to poling. Piezoelectric ceramics can be used as the piezoelectric material.

The two electrodes are electrodes electrically insulated from each other. Two alternating voltages whose phases can be independently changed are applied to the two electrodes. The entire back surface of the piezoelectric element 2 is an electrode and is configured to be connected at a ground potential from the front surface of the piezoelectric element 2 through a via (not illustrated) provided in a portion of the piezoelectric element 2. Although the piezoelectric material is a piece of piezoelectric material, the electrode 3, the electrode at the ground potential, and the portion of the piezoelectric material sandwiched therebetween may be referred to as a piezoelectric body 3 for the description on an electric circuit. A piezoelectric body 4 may also be referred to likewise.

The contact body 6 illustrated in FIG. 1E is a slider that comes into pressure contact with the protruding portions 80 of the vibrating body 5 with a constant pressure by a pressure mechanism (not illustrated). The contact body 6 (slider) is configured to relatively move in the left-right direction of the paper surface by the vibration excited in the vibrating body 5.

FIG. 1C and FIG. 1D are views illustrating examples of vibration modes of the vibrating body 5. FIG. 1C illustrates a vibration shape of a vibration mode (push-up vibration mode) excited in the vibrating body 5 when alternating voltages having the same amplitude and phase are applied to the piezoelectric body 3 and the piezoelectric body 4. The push-up vibration mode is one of the natural vibration modes of the vibrating body 5. The direction of the natural vibration is, at a contact surface of the vibrating body 5 with the contact body 6, substantially perpendicular to the contact surface. The degree of identity of the amplitudes and the phases may be determined depending on the quality of vibration waves desired by the user.

In contrast, FIG. 1D illustrates a vibration shape of a vibration mode (feed vibration mode) excited in the vibrating body 5 when alternating voltages having the same amplitude and opposite phases are applied to the piezoelectric body 3 and the piezoelectric body 4.

The feed vibration mode is one of the natural vibration modes of the vibrating body 5. The direction of the natural vibration is, at the contact surface of the vibrating body 5 with the contact body 6, substantially parallel to the contact surface and substantially meets the movement direction.

As an example, when the phase difference between the alternating voltages that are applied to the piezoelectric body 3 and the piezoelectric body 4 is 0°, the vibration in the vibration mode (push-up vibration mode) illustrated in FIG. 1C is excited. When the phase difference between the alternating voltages that are applied to the piezoelectric body 3 and the piezoelectric body 4 is 180°, the vibration in the vibration mode (feed vibration mode) illustrated in FIG. 1D is excited.

When the phase difference between the alternating voltages that are applied to the piezoelectric body 3 and the piezoelectric body 4 is a phase difference other than 0° and 180° (actually, a range of about 0° to about +120° is used), both the vibration modes illustrated in FIG. 1C and FIG. 1D are simultaneously excited. In this case, the contact body 6 (slider) brought into pressure contact with the protruding portions 80 provided on the vibrating body 5 moves in the longitudinal direction of the rectangle of the vibrating body 5. As the phase difference is away from 0°, the amplitude of the vibration mode (feed vibration mode) illustrated in FIG. 1D increases, and the relative speed between the contact body 6 (slider) and the vibrating body 5 increases.

The force received by the vibrating body 5 includes a piezoelectric excitation force generated by the alternating voltages being applied to the piezoelectric body 3 and the piezoelectric body 4 and causing the vibrating body 5 to vibrate, a reaction force received by the vibrating body 5 from a support member (not illustrated), and a reaction force received from the contact body 6 (slider). Among these, the vibration corresponding to the force (piezoelectric excitation force) generated by the alternating voltages being applied to the piezoelectric body 3 and the piezoelectric body 4 included in the vibrating body 5 is classified as a first vibration component, and the vibration generated in the vibrating body 5 by the reaction force received from the contact body 6 (slider) is classified as a second vibration component.

Further, the vibration component caused by the piezoelectric excitation force generated by the piezoelectric body 3 alone is classified as a third vibration component. The vibration component caused by the piezoelectric excitation force generated by the piezoelectric body 4 alone is classified as a fourth vibration component.

Hereinafter, the sum or the difference of the third vibration component generated by a first drive voltage and the fourth vibration component generated by a second drive voltage may be described. In this case, a drive vibration in a first direction generated based on one of the sum and the difference and a drive vibration in a second direction generated based on the other one of the sum and the difference may be described. The direction of the drive vibration represents a direction in which the vibrating body vibrates at the contact surfaces of the vibrating body and the contact body in a state in which the drive vibration is generated. The same applies to the direction of the natural vibration and the direction in a case of expressing the vibration component in the same direction.

The “contact body” refers to a member that comes into contact with the vibrating body and moves relative to the vibrating body by the vibration generated in the vibrating body. The contact between the contact body and the vibrating body is not limited to direct contact in which no other member is interposed between the contact body and the vibrating body. The contact between the contact body and the vibrating body may be indirect contact in which another member is interposed between the contact body and the vibrating body as long as the contact body moves relative to the vibrating body by the vibration generated in the vibrating body. The “other member” is not limited to a member (for example, a high friction material made of a sintered body) independent of the contact body and the vibrating body. The “other member” may be a portion subjected to surface treatment and formed on the contact body or the vibrating body by plating, nitriding, or the like.

The “vibrating body” refers to a member that includes an elastic body and an electro-mechanical energy conversion element and vibrates when an alternating voltage is applied to the electro-mechanical energy conversion element. The elastic body is mainly made of metal or ceramic. The electro-mechanical energy conversion element may also serve as the elastic body.

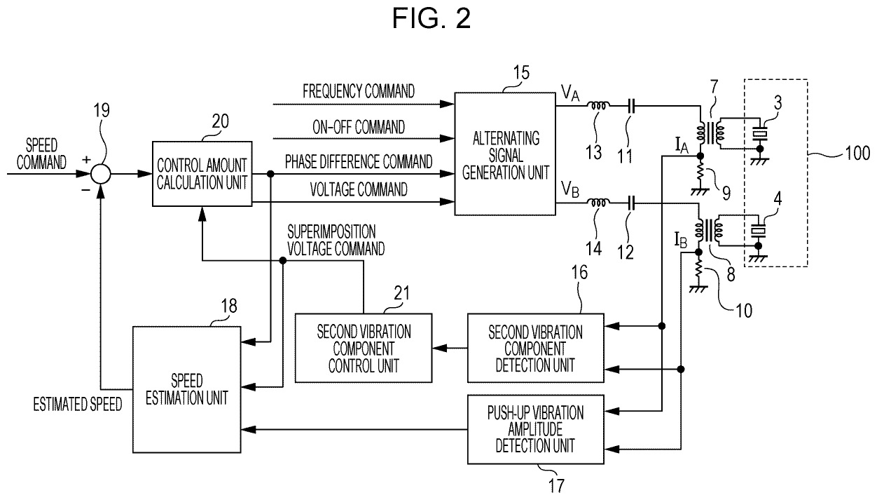

FIG. 2 is a diagram illustrating a first configuration example of a driving device for the vibration type actuator 100 according to the first embodiment of the present disclosure. FIG. 2 includes the vibration type actuator 100, a generation unit of alternating voltages that are applied to the vibration type actuator 100, and a speed estimation unit and a portion related to speed control for the vibration type actuator 100. First, the generation unit of the alternating voltages will be described. An alternating signal generation unit 15 generates a two-phase alternating signal V_{A} (first signal) and an alternating signal V_{B} (second signal) based on a frequency command and an ON-OFF command from a command unit (not illustrated) and a phase difference command output from a control amount calculation unit 20 (described later). The alternating signal V_{A} and the alternating signal V_{B} are connected to the primary windings of a transformer 7 and a transformer 8 via series resonance circuits composed of inductors 13 and 14 and capacitors 11 and 12, respectively. Here, the transformer 7 and the transformer 8 are connected via the series resonance circuits in order to shape the waveforms and suppress a change in voltage amplitude to the piezoelectric body 3 and the piezoelectric body 4 in this example. However, only the inductors or the capacitors may be connected, or the series resonance circuits do not have to be connected. The voltages input to the primary windings of the transformer 7 and the transformer 8 are boosted and applied as a first drive voltage and a second drive voltage to the piezoelectric body 3 and the piezoelectric body 4 included in the vibrating body 5 of the vibration type actuator 100 and connected to the secondary windings of the transformer 7 and the transformer 8. As described above, the piezoelectric body 3 and the piezoelectric body 4 are illustrated in this manner for the description on the electric circuit, but are portions of the vibrating body 5.

The inductor values of the secondary windings of the transformer 7 and the transformer 8 are frequency-matched with the damping capacities of the piezoelectric body 3 and the piezoelectric body 4. Accordingly, currents substantially proportional to the vibration speeds of the strains generated in the piezoelectric body 3 and the piezoelectric body 4 flow through the primary windings of the transformer 7 and the transformer 8.

A resistor 9 and a resistor 10 for current detection are connected in series to the primary windings of the transformer 7 and the transformer 8, and detect the currents flowing through the primary windings of the transformers to generate a current signal I_{A} as a first detection signal and a current signal I_{B} as a second detection signal. The relationship between the current signal I_{A} and the current signal I_{B}, and the vibrations of the vibrating body 5 will be described later.

Next, a configuration related to the speed estimation unit will be described. A second vibration component detection unit 16 and a push-up vibration amplitude detection unit 17 receive the current signal I_{A} and the current signal I_{B}, and detect a second vibration component and a component corresponding to a push-up vibration amplitude.

Here, when the waveforms of the current signal I_{A} and the current signal I_{B} include harmonic waves by a large amount, the current signal I_{A} and the current signal I_{B} may be input to the second vibration component detection unit 16 and the push-up vibration amplitude detection unit 17 after harmonic components are sufficiently attenuated by a low-pass filter or a band-pass filter.

As described above, the vibration component corresponding to the vibration caused by the force received by the vibrating body 5 from the contact body 6 (slider) is the second vibration component.

Next, control of minimizing the second vibration component with a superimposition voltage will be described.

The detected second vibration component is input to a second vibration component control unit 21. The second vibration component control unit 21 calculates a command value of the superimposition voltage that is superimposed on the voltages of the alternating signal V_{A} and the alternating signal V_{B} so that an excitation force having a sign opposite to that of the excitation force of the second vibration component is generated in accordance with the magnitude and the time phase of the second vibration component to decrease the second vibration component. The superimposition voltage command is input to the control amount calculation unit 20, and a phase difference command and a voltage command updated by the control amount calculation unit 20 based on the superimposition voltage command are output to the alternating signal generation unit 15, thereby forming a control loop for decreasing the second vibration component to a predetermined range.

The superimposition voltage command in the state in which the control of minimizing the second vibration component is performed by the control loop for decreasing the second vibration component described above corresponds to an excitation force for canceling an excitation force of the second vibration component, that is, a friction excitation force. The superimposition voltage command and the component corresponding to the vibration amplitude in the direction in which the vibrating body 5 pushes up the contact body 6 (slider) are input to a speed estimation unit 18, and a speed is estimated in accordance with the value of a phase difference command signal input simultaneously. Details of the speed estimation method and the vibration detection will be described later.

Next, an operation of the speed control unit will be described. First, an estimated speed from the speed estimation unit 18 and a speed command from a command unit (not illustrated) are compared by a comparator 19. Then, the control amount calculation unit 20 performs a proportional integral calculation on the comparison result of the comparator 19 to generate a phase difference command signal. Then, the phase difference between the alternating signal V_{A} and the alternating signal V_{B} is set, and the speed is controlled in accordance with the magnitude of the amplitude of the feed direction vibration excited in the vibrating body 5.

Here, the relationship between the current signal I_{A} and the current signal I_{B}, and the vibrations of the vibrating body 5 will be described. As described above, the piezoelectric body 3 and the piezoelectric body 4 generate the piezoelectric excitation forces for vibrating the vibrating body 5 by alternating signals being applied to the electrode 3 and the electrode 4 provided on the piezoelectric element 2 included in the vibrating body 5. The vibrations of the vibrating body generated by the piezoelectric excitation forces generate strain vibrations in the piezoelectric body. It is considered that the average of the strain vibrations distributed in the piezoelectric body is proportional to the vibration displacement of the interval with the piezoelectric body bonded.

The electric charges proportional to the strain are generated in the piezoelectric body by the piezoelectric effect. Hence the current signal I_{A}, which is the time differential of the generated electric charges, is a signal corresponding to the average vibration speed of a portion of the elastic body 1 (that is, the piezoelectric body 3) to which the interval with the electrode 3 bonded is projected.

Similarly, the current signal I_{B} is a signal corresponding to the vibration speed of a portion of the elastic body 1 (that is, the piezoelectric body 4) to which the interval with the electrode 4 bonded is projected.

The current signal I_{A} mainly includes a vibration component in the same direction as the direction of the third vibration component. The current signal I_{B} mainly includes a vibration component in the same direction as the direction of the fourth vibration component. The vibration component caused by the piezoelectric excitation force generated by the piezoelectric body 3 alone is the third vibration component. The vibration component caused by the piezoelectric excitation force generated by the piezoelectric body 4 alone is the fourth vibration component.

The second vibration component detection unit 16 detects the second vibration component by using the current signal I_{A} and the current signal I_{B} that are the two detected signals.

Next, the detection of the push-up vibration amplitude performed by the push-up vibration amplitude detection unit 17 will be described. The push-up vibration corresponds to the component in the direction perpendicular to the flat plate of the flat plate-shaped vibrating body 5.

An example of the vibration mode of the push-up vibration is the vibration mode illustrated in FIG. 1C, and is, for example, a vibration mode generated when the amplitudes of the alternating signal V_{A} and the alternating signal V_{B} that are applied to the piezoelectric body 3 and the piezoelectric body 4 are equal to each other and the phase difference is 0°. Thus, the amplitude of the vibration speed of the push-up vibration is substantially proportional to the amplitude of the sum signal of the current signal I_{A} and the current signal I_{B}.

In a case where the vibration displacements are equal to each other, the amplitude of the vibration speed increases or decreases in proportion to the vibration frequency, but the frequency of the alternating signal V_{A} and the alternating signal V_{B} does not change greatly, and hence it may be considered that the amplitude of the vibration speed is substantially proportional to the vibration amplitude. Thus, in the following description, the current signal I_{A} is treated as a signal corresponding to the displacement of the piezoelectric body 3, the current signal I_{B} is treated as a signal corresponding to the displacement of the piezoelectric body 4, and the amplitude of the sum signal of the current signal I_{A} and the current signal I_{B} is described as the push-up vibration amplitude. A command corresponding to such a displacement may be referred to as a signal of a displacement command, and a command corresponding to a force may be referred to as a signal of a force command.

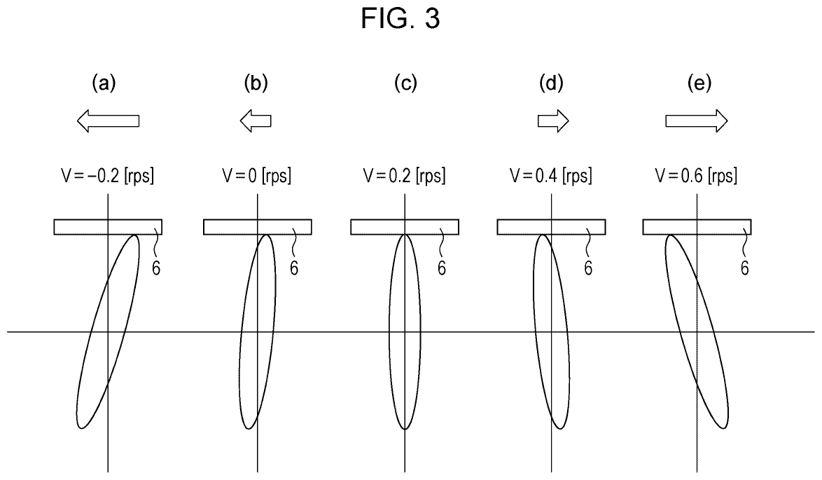

The principle of the speed estimation will be described below. FIG. 3 provides diagrams schematically illustrating the relationship between the elliptical vibration locus of the tip of the protruding portion 80 of the elastic body 1, and the relative force acting between and the relative speed of the vibrating body 5 and the contact body 6 (slider) via the protruding portion 80. All the vibration loci in FIG. 3 are vibration loci of the tip of the protruding portion 80 when the amplitudes of the alternating signal V_{A} and the alternating signal V_{B} are equal to each other and the phase difference is 45°. FIG. 3(a) to FIG. 3(e) illustrate vibration loci when the speed V between the vibrating body 5 and the contact body 6 (slider) is changed from −0.2 [rps] to 0.6 [rps] by a force that is applied to the contact body 6 (slider) from the outside. The direction of an arrow in FIG. 3 indicates the direction of the force acting on the protruding portion 80 of the elastic body 1 from the contact body 6 (slider), and the length of the arrow indicates the magnitude of the force. In the state in FIG. 3(c) without an arrow, the force acting on the contact body 6 (slider) from the outside is 0 [N], and the contact body 6 (slider) is moving at 0.2 [rps] relative to the vibrating body 5. The vibrating body 5 and the contact body 6 intermittently come into contact with each other in the contact region at the tip of the protruding portion 80, and the relative speed (speed difference) between the vibrating body 5 and the contact body 6 changes and is distributed even in the contact period. The distribution of the friction force is generated in accordance with the distribution of the speed difference and the contact pressure in the contact region. When the force that is applied to the contact body 6 (slider) is changed, the distribution of the speed difference between the vibrating body 5 and the contact body 6 (slider) in the contact region between the vibrating body 5 and the contact body 6 (slider) changes, and the distribution of the friction force generated in the contact region also changes accordingly. The vibrating body 5 is excited by the friction force generated when the vibrating body 5 intermittently comes into contact with the contact body 6 (slider), and hence a vibration corresponding to the speed difference is superimposed on the vibrating body 5.

As seen in FIG. 3, the vibration locus of the tip of the protruding portion 80 is elliptical, and the vibration ellipse is inclined in a direction opposite to the direction of the force acting on the tip of the protruding portion 80 in accordance with the magnitude of the force acting on the protruding portion 80 from the contact body 6. This phenomenon occurs when the vibration caused by the excitation received by the vibrating body 5 at the time of the contact between the protruding portion 80 and the contact body 6 (slider) is superimposed on the vibrating body 5. The present disclosure detects the superimposed vibration component (second vibration component) and performs the control of minimizing the superimposed vibration component using a superimposition voltage component that is superimposed on the voltage that is applied to the piezoelectric body. Thus, a superimposition voltage component corresponding to the excitation force of the second vibration component (=the excitation force caused by the friction force) is obtained, and hence the relative speed between the vibrating body 5 and the contact body 6 (slider) is estimated.

The characteristics illustrated in FIG. 3 are characteristics obtained when the vibrating body 5 is driven under the condition that the frequency of the alternating signals V_{A} and V_{B} is higher than the natural frequencies of the vibration modes of the vibrating body 5. Although the characteristics may be different from the above characteristics under the condition that the frequency of the alternating signals V_{A} and V_{B} is lower than the natural frequencies of the vibration modes of the vibrating body 5, the principle of estimating the speed by detecting the second vibration component that changes depending on the speed is not changed.

Since the characteristics in FIG. 3 change depending on the relationship between the natural frequencies of the vibration modes of the vibrating body 5 and the frequency of the alternating signals V_{A} and V_{B}, the phase difference between the alternating signals V_{A} and V_{B}, and the like, detection of the second vibration component in accordance with the driving condition, and minimization and speed estimation using the superimposition voltage are necessary.

In the following description, an example in the case where the driving is performed under the condition that the frequency of the alternating signals V_{A} and V_{B} is higher than the natural frequencies of the vibration modes of the vibrating body 5 will be described.

The operation of the second vibration component detection unit 16 that detects the second vibration component, which is the vibration generated in the vibrating body 5 by the excitation received from the contact body 6 (slider), will now be described in detail.

There are various methods of detecting the second vibration component, and one of the methods is to detect the slope of the vibration ellipse as illustrated in FIG. 3. As described above, the slope of the vibration ellipse has a high correlation with the relative speed between the vibrating body 5 and the contact body 6 (slider), and detection of such a value is considered as detection of a signal corresponding to the second vibration component.

A first example of second vibration component detection according to the first embodiment will be described below.

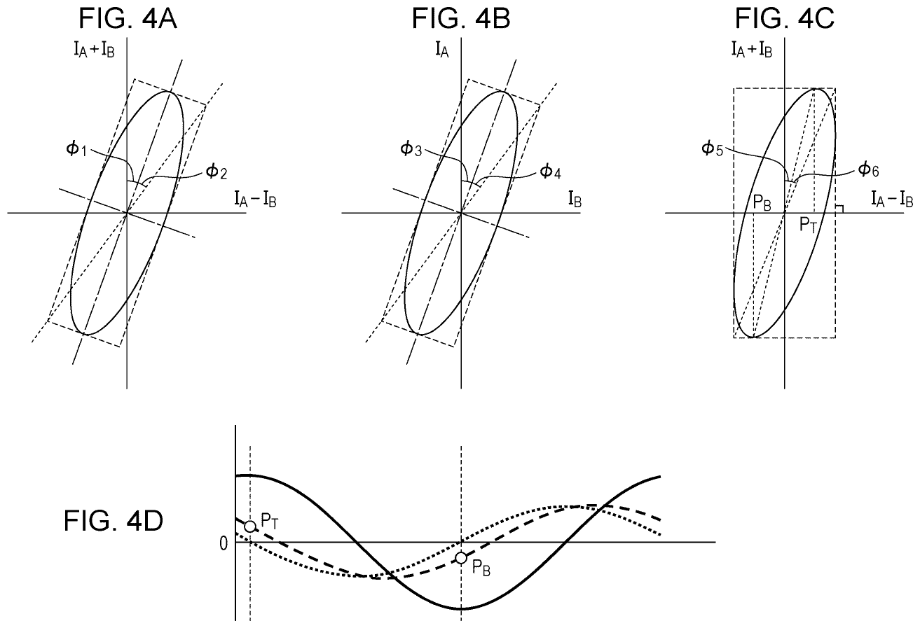

FIGS. 4A and 4B are diagrams illustrating Lissajous waveforms (vibration ellipses) explaining the first example of detecting the second vibration component according to the first embodiment. FIG. 4A illustrates a Lissajous waveform (vibration ellipse) drawn with the vertical axis as (current signal I_{A}+current signal I_{B}) and the horizontal axis as (current signal I_{A}−current signal I_{B}). (Current signal I_{A}+current signal I_{B}) represents a vibration waveform corresponding to the vibration mode (push-up vibration mode) in FIG. 1C. (Current signal I_{A}−current signal I_{B}) represents a vibration waveform corresponding to the vibration mode (feed vibration mode) in FIG. 1D. Here, when the current signal I_{A} is expressed by Equation 1 and the current signal I_{B} is expressed by Equation 2,

$${I}_{A} = ρ sin ( ω t + {δ}_{1} ) \qquad Equation 1$$

$${I}_{B} = σ sin ( ω t + {δ}_{2} ) \qquad Equation 2$$

an inclination angle φ₁ of the vibration ellipse is expressed by Equation 3.

$${φ}_{1} = \frac{1}{2} {tan}^{- 1} ( \frac{{σ}^{2} - {ρ}^{2}}{2 ρσ cos ( {δ}_{1} - {δ}_{2} )} ) \qquad Equation 3$$

The second vibration component detection unit 16 detects an amplitude p of the current signal I_{A}, an amplitude σ of the current signal I_{B}, and a phase difference (81-82) between the current signal I_{A} and the current signal I_{B}, and substitutes the detected values into Equation 3 to obtain the second vibration component (the inclination angle of the vibration ellipse).

Next, generation of a superimposition voltage in the first embodiment will be described.

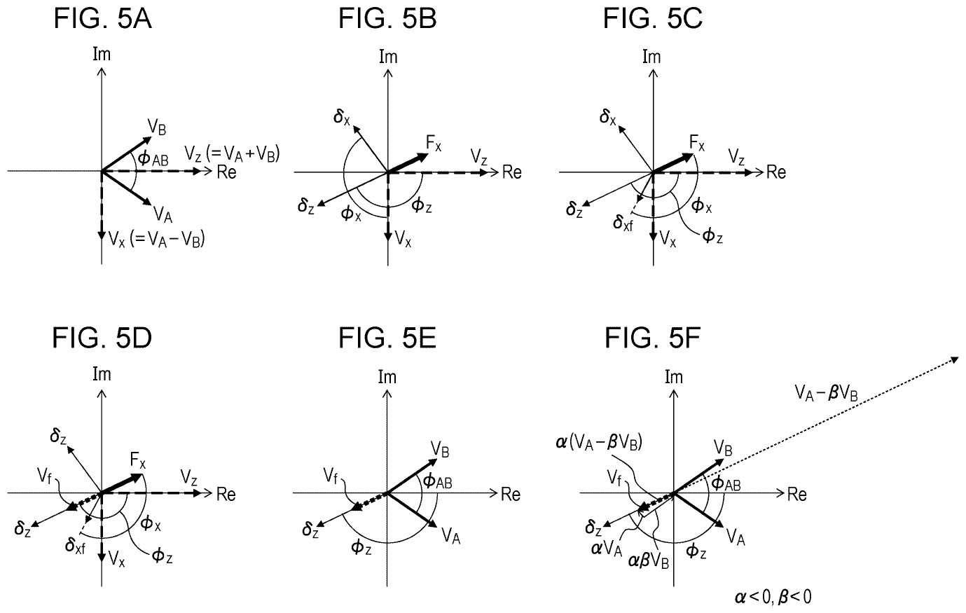

FIGS. 5A to 5F are complex plane diagrams expressing applied voltages, excitation forces, and vibration responses of the vibration type actuator of the first embodiment of the present disclosure, and a superimposition voltage for canceling a friction excitation force and a method of generating the superimposition voltage. FIG. 5A is a diagram illustrating voltages that are applied to the piezoelectric bodies. In FIG. 5A, V_{A} and V_{B} are alternating signals that are applied to the two piezoelectric bodies 3 and 4 of the vibrating body 5, and the phase at the center of a temporal phase difference φ_{AB} is made to meet the real axis. Here, V_{z} is a push-up vibration excitation voltage corresponding to a voltage for exciting the push-up vibration, and Vₓ is a feed vibration excitation voltage corresponding to a voltage for exciting the feed vibration, which are respectively represented by the sum and difference of the alternating signals V_{A} and V_{B}, and V_{z}=V_{A}+V_{B} and Vₓ=V_{A}-V_{B}. When the voltage amplitudes of V_{A} and V_{B} are equal to each other, V_{z} and Vₓ have the relationship of phases different from each other by 90°.

FIG. 5B is a diagram illustrating mechanical response displacements to voltages. A response displacement 82 of the push-up vibration is generated with a delay of a phase φ_{z} using the push-up vibration excitation voltage V_{z} as an excitation force.

Similarly, a response displacement δₓ of the feed vibration is generated with a phase delay of a phase φₓ using the feed vibration excitation voltage Vₓ as an excitation force. Here, the phase φ_{z} and the phase φₓ are values different from each other and each are 90° or more. This is because the vibrating body has the different natural frequencies for the push-up vibration and the feed vibration, and the responses are obtained when the alternating voltages having the frequency higher than the natural frequencies are applied. The values of these phases change in accordance with the magnitude relationship between the two natural frequencies and the frequency of the alternating voltages to be applied, and hence the values of these phases are not limited thereto. In the present embodiment, the response displacements δ_{z} and δₓ have a time phase of about 90°, and form the vibration that draws the above-described elliptical vibration locus.

When the contact body is brought into contact with the vibrating body, the feed vibration displacement relatively drives the contact body in the positive direction. At this time, the contact pressure with the contact body becomes the maximum in the time domain where the response displacement δ_{z} of the push-up vibration becomes the maximum, that is, in the phase φ_{z}. Further, when an external force acts in the direction in which the relative driving of the contact body is suppressed, and a thrust is exerted in the direction of the relative driving, a friction excitation force Fₓ, which becomes the maximum force in the time domain centered on the time phase φ_{z} where the contact pressure becomes the maximum, acts. This friction force is synchronized with the time phase φ_{z} and becomes a harmonic excitation force of the feed direction vibration in the phase opposite to that of the feed direction excitation force caused by the voltage, so that it is expressed as a vector Fₓ in the opposite direction in the phase φ_{z} of the response displacement δ_{z} as illustrated in FIG. 5C. A friction response displacement δ_{xf}, which is a response displacement of the vibrating body caused by the friction excitation force Fₓ, is generated as a feed vibration displacement having the phase delay φₓ (the phase is inverted because the sign is opposite). The friction response displacement δ_{xf} is a main element of the second vibration component, and the friction response displacement δ_{xf} having a different time phase is added to the feed vibration displacement δₓ generated as a response to the applied voltage, which causes the inclination of the vibration ellipse or the like. The friction excitation force Fₓ is a parameter directly corresponding to the relative speed of the vibration type actuator, but cannot be directly detected.

As illustrated in FIG. 5D, control of decreasing the second vibration component δ_{xf} is performed by superimposing a piezoelectric excitation force V_{f} having the same phase as that of the friction excitation force Fₓ and the sign opposite to that of the friction excitation force Fₓ on the voltage that is applied to the piezoelectric body. When the piezoelectric excitation force V_{f} becomes a superimposition voltage for canceling the second vibration component, Vr becomes equal to or a value approximate to Fₓ, and hence the relative speed of the vibration type actuator can be estimated based on superimposition voltage=(equals) piezoelectric excitation force V_{f}.

A method of generating the superimposition voltage component V_{f} from the drive voltages V_{A} and V_{B} will be described with reference to FIG. 5E. The push-up vibration displacement δ_{z} has a vibration speed proportional to current signal I_{A}+current signal I_{B}. Thus, the phase φ_{z} can be detected by detecting the time point of zero crossing at which current signal I_{A}+current signal I_{B} is inverted from the sign of the direction in which the vibrating body comes into contact with the contact body, with reference to the voltage signal. Next, as illustrated in FIG. 5F, in order to obtain a vector of the superimposition voltage whose phase meets φ_{z}, a coefficient β is calculated based on the voltage command and the phase difference command so that a voltage vector expressed by (V_{A}−βV_{B}) meets the phase φ_{z}. Next, using a coefficient α expressing the magnitude of the superimposition voltage, by setting the superimposition voltage of the voltage V_{A} to αV_{A} and the superimposition voltage of the voltage V_{B} to αβV_{B}, a voltage vector α(V_{A}−βV_{B}) of the feed vibration excitation component that meets the phase φ_{z} can be obtained. The speed is estimated based on the coefficient α obtained by performing the control of minimizing and canceling the detection value of the second vibration component.

In the present embodiment, the superimposition voltage coefficient α is obtained as a value corresponding to the friction excitation force by using the inclination angle of the vibration ellipse described above as the detection value of the second vibration component and performing the control of decreasing the second vibration component while the superimposition voltage coefficient α is a variable.

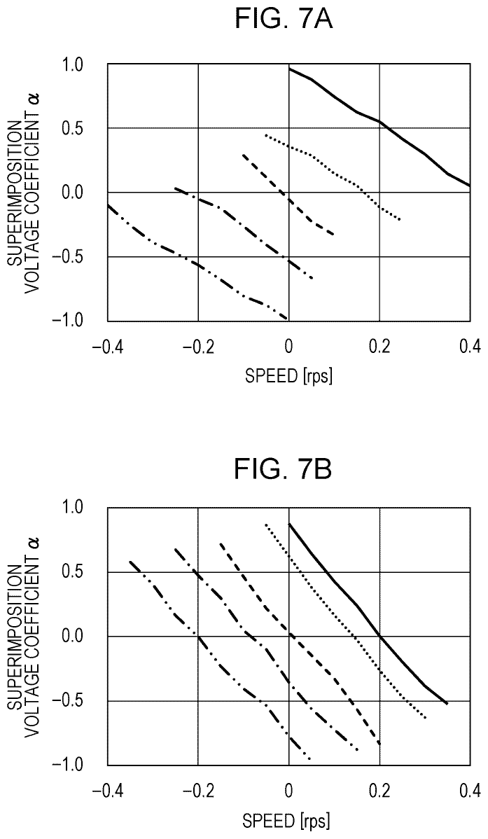

FIGS. 7A and 7B are graphs presenting the relationship of the superimposition voltage coefficient α with respect to the speed. FIG. 7A presents an example of a case where the push-up vibration amplitude is small. FIG. 7B presents an example of a case where the push-up vibration amplitude is relatively large. The line types in FIGS. 7A and 7B indicate the difference in phase difference between the alternating signal V_{A} and the alternating signal V_{B}, and present a solid line (90°), a dotted line (45°), a broken line (0°), a one-dot chain line (−45°), and a two-dot chain line (−90°).

The relationship between the relative speed between the contact body 6 and the protruding portion 80, and the superimposition voltage for canceling the friction excitation force is substantially linear. Thus, as long as the offset and the slope of each straight line of the graph are obtained in advance for each push-up vibration amplitude and each phase difference between the alternating signal V_{A} and the alternating signal V_{B}, the speed can be estimated by performing the inverse operation from the superimposition voltage coefficient α. The larger the push-up vibration amplitude is, the higher the sensitivity to the phase difference between the alternating signal V_{A} and the alternating signal V_{B} is. Hence the estimation accuracy of the speed can be increased.

In the present embodiment, the inclination angle of the ellipse is used as the second vibration component, but the value of S in Equation 4 obtained by extracting the input value of the arctangent of Equation 3 may be used as the second vibration component.

The width (the length of the minor axis) of the vibration ellipse also changes by the superimposition of the second vibration component. Thus, a value obtained by adding both the inclination angle φ₁ of the vibration ellipse and an angle φ₂ formed by the diagonal line of the circumscribing rectangle of the vibration ellipse and the center line of the vibration ellipse illustrated in FIG. 4A at a predetermined ratio may be the second vibration component.

Equation 4 obtained by extracting only a changing portion of Equation 3 may be the second vibration component S, or the result obtained by further substituting Equation 4 into any function may be the second vibration component S.

$$S = \frac{{σ}^{2} - {ρ}^{2}}{2 ρσ cos ( {δ}_{1} - {δ}_{2} )} \qquad Equation 4$$

In the above example, the vertical axis of the Lissajous waveform (vibration ellipse) is (current signal I_{A}+current signal I_{B}), and the horizontal axis is (current signal I_{A}−current signal I_{B}). However, the slope of the vibration ellipse may be obtained with the vertical axis set as the current signal I_{A} and the horizontal axis set as the current signal I_{B}. FIG. 4B illustrates a Lissajous waveform (vibration ellipse) drawn with the vertical axis as the current signal I_{A} and the horizontal axis as the current signal I_{B}.

In this case, an inclination angle φ₃ of the vibration ellipse is expressed by Equation 5, and the angle φ₃ can be the second vibration component.

$${φ}_{3} = \frac{1}{2} {tan}^{- 1} ( \frac{2 ρσ cos ( {δ}_{1} - {δ}_{2} )}{{σ}^{2} - {ρ}^{2}} ) \qquad Equation 5$$

Alternatively, an angle φ₄ may be obtained as in the above example, and a value obtained by adding both the inclination angle φ₃ and the angle φ₄ at a predetermined ratio may be the second vibration component. Equation 6 obtained by extracting only a changing portion of Equation 5 may be the second vibration component S, or the result obtained by further substituting Equation 6 into any function may be the second vibration component S.

$$S = \frac{2 ρσ cos ( {δ}_{1} - {δ}_{2} )}{{σ}^{2} - {ρ}^{2}} \qquad Equation 6$$

Next, a second example of the superimposition voltage component according to the first embodiment will be described.

In the first example of the superimposition voltage component according to the first embodiment, the superimposition voltage component is generated so as to meet the time phase of the response displacement of the push-up vibration. However, here, without being synchronized with the push-up vibration, a feed vibration component having a different time phase from the applied voltage with reference to the phase of the applied voltage is excited.

In the present embodiment, the relationship among the applied voltages, the excitation forces, and the vibration responses of the vibration type actuator is similar to that illustrated in FIGS. 5A to 5F, and hence description thereof is omitted.

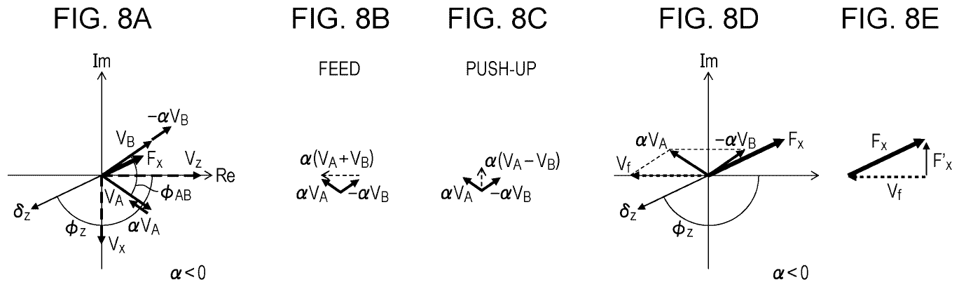

FIGS. 8A to 8E are complex plane diagrams expressing a method of generating a superimposition voltage component in the second example of the superimposition voltage component according to the first embodiment. As illustrated in FIG. 8A, superimposition voltages are set to αV_{A} and −αV_{B} by using the equivalent coefficient α for the voltages V_{A} and V_{B}. Each of the superimposition voltages is obtained by changing only the amplitude of the voltage V_{A} or the voltage V_{B} with reference to the time phase of the voltage V_{A} or the voltage V_{B}. At this time, the excitation voltage of the feed vibration is a (V_{A}+V_{B}) as illustrated in FIG. 8B, and is a superimposition voltage component for exciting a feed vibration having a phase different by π/2 from that of the excitation voltage component Vₓ of the feed vibration caused by the applied voltage. Similarly, the excitation voltage of the push-up vibration is α(V_{A}−V_{B}) as illustrated in FIG. 8C, and is also a superimposition voltage component for exciting a push-up vibration having a phase different by π/2 from that of the excitation voltage V_{z} of the push-up vibration caused by the applied voltage.

FIGS. 8D and 8E illustrate the cancellation effect for the friction excitation force using the superimposition voltage components αV_{A} and −αV_{B}. The piezoelectric excitation force V_{f} for canceling the friction excitation force Fₓ is α(V_{A}+V_{B}), and when the control of minimizing the second vibration component is performed by using the coefficient α, the same phase component included in the friction excitation force Fₓ can be canceled. Here, a component F′ₓ orthogonal to the piezoelectric excitation force V_{f} cannot be decreased and remains, but the piezoelectric excitation force V_{f} and the friction excitation force Fₓ are in a proportional relationship at a ratio determined by the phase difference therebetween, and hence the component F′ₓ does not affect the correspondence with the friction excitation force. Since the component F′ₓ of the friction excitation force is a component having the same phase as that of the feed vibration excitation component Vₓ of the drive voltage, the change in the characteristics can be compensated by the phase difference command and the frequency command of the control device.

As described above, in the second example of the superimposition voltage component of the present embodiment, the speed can be estimated by a simple method by providing the difference obtained by multiplying the voltage command by the equivalent coefficient to minimize the second vibration component.

Next, a second example of the second vibration component detection according to the first embodiment will be described below.

In the first example of the second vibration component detection according to the first embodiment, the inclination angle of the vibration ellipse is obtained by Equation 3. However, the inclination angle may be obtained by using another parameter of the vibration ellipse that changes in accordance with the inclination angle of the vibration ellipse. FIGS. 4C and 4D are diagrams explaining the second example of detecting the second vibration component according to the first embodiment. FIG. 4C is a diagram explaining an example of detecting the second vibration component by using an angle φ₅ that changes in accordance with the inclination angle of the vibration ellipse.

In the first example of the second vibration component detection according to the first embodiment, the slope of the axis of the vibration ellipse is used. However, a complicated calculation as in Equation 3 is necessary to obtain the slope. The angle φ₅ that is detected in this example can be directly detected from the sum signal and the difference signal of the current signal I_{A} and the current signal I_{B}. The angle φ₅ is an angle between the line connecting the positive and negative peaks of (current signal I_{A}+current signal I_{B}) and the vertical axis. FIG. 4D is a diagram of time axis waveforms for explaining a method of detecting the angle φ₅. In FIG. 4D, the solid line indicates (current signal I_{A}+current signal I_{B}), the dotted line indicates a differential waveform of the waveform of the solid line, and the broken line indicates a waveform of (current signal I_{A}−current signal I_{B}). The angle φ₅ is obtained by sampling the signal indicated by the broken line at the time points of the peaks (maximum and minimum) of (current signal I_{A}+current signal I_{B}) to detect the values of P_{T} and P_{B}, and by using Equation 7. Alternatively, the time points of detecting P_{T} and P_{B} may be the time points of zero crossing of the differential waveform of (current signal I_{A}+current signal I_{B}).

$${φ}_{5} = {tan}^{- 1} ( \frac{amplitude of {I}_{A} + {I}_{B} \times 2}{{P}_{T} - {P}_{B}} ) \qquad Equation 7$$

The second vibration component detection unit 16 obtains the second vibration component (angle φ₅) as described above.

Alternatively, Equation 8 or Equation 9 may be the second vibration component S.

$$S = \frac{{P}_{T} - {P}_{B}}{amplitude of {I}_{A} + {I}_{B}} \qquad Equation 8$$

$$S = {P}_{T} - {P}_{B} \qquad Equation 9$$

As in the first example of the second vibration component detection according to the first embodiment, not only the inclination angle but also the width (the length of the minor axis) of the vibration ellipse changes by the superimposition of the second vibration component. Thus, a value obtained by adding both an angle φ₆, which is formed by the diagonal line of the circumscribing rectangle of the vibration ellipse illustrated in FIG. 4C and the straight line indicating the angle φ₅, and the angle φ₅ at a predetermined ratio may be the second vibration component S.

As the parameters expressing the Lissajous waveform (vibration ellipse), various parameters such as a length of the minor axis, a height, and a width can be defined in addition to the inclination angle, the length of the minor axis, and the like used in the above description. Thus, the second vibration component S may be detected by using another parameter as long as the parameter changes in accordance with the inclination angle of the Lissajous waveform (vibration ellipse).

Next, a third example of the second vibration component detection according to the first embodiment will be described.

In the first and second examples of the second vibration component detection according to the first embodiment, the second vibration component is extracted from the shape of the vibration ellipse. However, in this example, the second vibration component is obtained from the amplitudes of the currents. The second vibration component detection unit 16 of this example receives the current signal I_{A} and the current signal I_{B}, obtains the amplitude of the current signal I_{A} and the amplitude of the current signal I_{B}, calculates (amplitude of current signal I_{A}-amplitude of current signal I_{B}), and outputs the result as the second vibration component S.

Alternatively, the second vibration component S may be a value obtained by dividing (amplitude of current signal I_{A}−amplitude of current signal I_{B}) by the amplitude of (current signal I_{A}+current signal I_{B}).

Next, a fourth example of the second vibration component detection according to the first embodiment will be described.

This example is an example of detection in a case where the current signals are represented as vectors.

Specifically, in this example, a vector based on the amplitude and the phase of the first detection signal is a first signal vector, and a vector based on the amplitude and the phase of the second detection signal is a second signal vector. Further, one of the sum and the difference of the first signal vector and the second signal vector may be a first vibration vector, and the other one of the sum and the difference may be a second vibration vector. A vector component in the same direction as the first vibration vector may be a same-direction component, and a vector component in the normal direction of the first vibration vector may be a normal-direction component. The second vibration component may be calculated from a ratio based on the difference between the same-direction components of the first signal vector and the second signal vector and the difference between the normal-direction components of the first signal vector and the second signal vector.

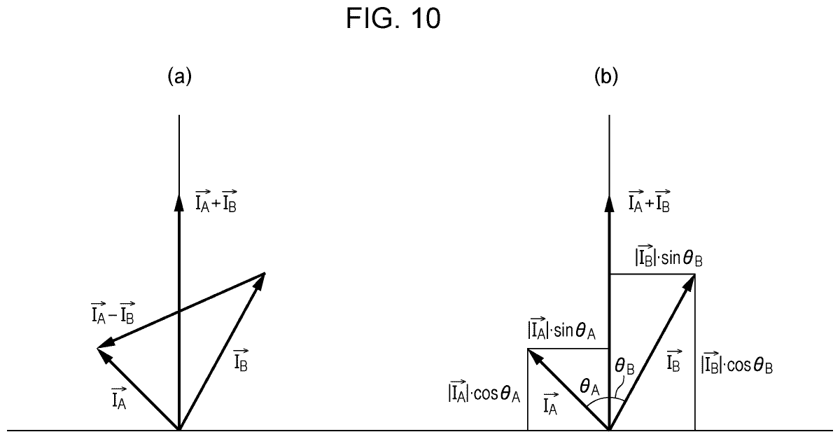

FIG. 10 provides vector diagrams of the current signals. FIG. 10(a) is a diagram illustrating the current signal I_{A}, the current signal I_{B}, and the sum and difference signals of the current signals I_{A} and I_{B} in the form of vectors. The second vibration component S presented in the third example of the second vibration component according to the first embodiment can be expressed by Equation 10 and Equation 11 by using vectors.

$$S = \vert \vec{{I}_{A}} \vert - \vert \vec{{I}_{B}} \vert \qquad Equation 10$$

$$S = \frac{\vert \vec{{I}_{A}} \vert - \vert \vec{{I}_{B}} \vert}{\vert \vec{{I}_{A}} + \vec{{I}_{B}} \vert} \qquad Equation 11$$

FIG. 10(b) is a vector diagram illustrating the current signal I_{A} and the current signal I_{B}. The diagram illustrates two vectors each divided into two vibration components orthogonal to each other, where the current signal I_{A} is the first signal vector and the current signal I_{B} is the second signal vector. The two orthogonal vibration components are the same-direction vibration component and the normal-direction vibration component with respect to (first signal vector+second signal vector) that is the push-up vibration component (first vibration vector). The difference between the same-direction components with respect to the push-up vibration component (first vibration vector) of the first signal vector and the second signal vector has a high correlation with the slope of the vibration ellipse. Thus, as in Equation 12, the same-direction components with respect to the push-up vibration component (first vibration vector) are obtained for the first signal vector and the second signal vector, and the difference between these can be the second vibration component S. Alternatively, as in Equation 13, a value obtained by dividing the value of Equation 12 by the magnitude of the push-up vibration component (first vibration vector) may be the second vibration component S.

$$S = \vert \vec{{I}_{A}} \vert \cdot cos {θ}_{A} - \vert \vec{{I}_{B}} \vert \cdot cos {θ}_{B} \qquad Equation 12$$

$$S = \frac{\vert \vec{{I}_{A}} \vert \cdot cos {θ}_{A} - \vert \vec{{I}_{B}} \vert \cdot cos {θ}_{B}}{\vert \vec{{I}_{A}} + \vec{{I}_{B}} \vert} \qquad Equation 13$$

The normal-direction components with respect to the push-up vibration component (first vibration vector) of the first signal vector (current signal I_{A}) and the second signal vector (current signal I_{B}) may be used. As in Equation 14, the sum of the difference between the same-direction components and the difference between the normal-direction components with respect to the push-up vibration component (first vibration vector) of the first signal vector (current signal I_{A}) and the second signal vector (current signal I_{B}) at a predetermined ratio (x:y) can be the second vibration component S.

Alternatively, as in Equation 15, a value obtained by dividing the value of Equation 14 by the magnitude of the push-up vibration component (first vibration vector) may be the second vibration component S.

$$S = x ( \vert \vec{{I}_{A}} \vert \cdot cos {θ}_{A} - \vert \vec{{I}_{B}} \vert \cdot cos {θ}_{B} ) + y ( \vert \vec{{I}_{A}} \vert \cdot sin {θ}_{A} - \vert \vec{{I}_{B}} \vert \cdot sin {θ}_{B} ) \qquad Equation 14$$

$$S = \frac{x ( \vert \vec{{I}_{A}} \vert \cdot cos {θ}_{A} - \vert \vec{{I}_{B}} \vert \cdot cos {θ}_{B} ) + y ( \vert \vec{{I}_{A}} \vert \cdot sin {θ}_{A} - \vert \vec{{I}_{B}} \vert \cdot sin {θ}_{B} )}{\vert \vec{{I}_{A}} + \vec{{I}_{B}} \vert} \qquad Equation 15$$

Here, a method of obtaining the second vibration component S of Equation 12 to Equation 15 will be described. The equations from Equation 12 to Equation 15 are calculations including trigonometric functions, and detection of a phase difference is also necessary. Accordingly, the structure of the second vibration component detection unit 16 becomes complicated. Thus, an example of detection using synchronous detection instead of this calculation will be described. A method of detecting the second vibration component S using synchronous detection will be described below.

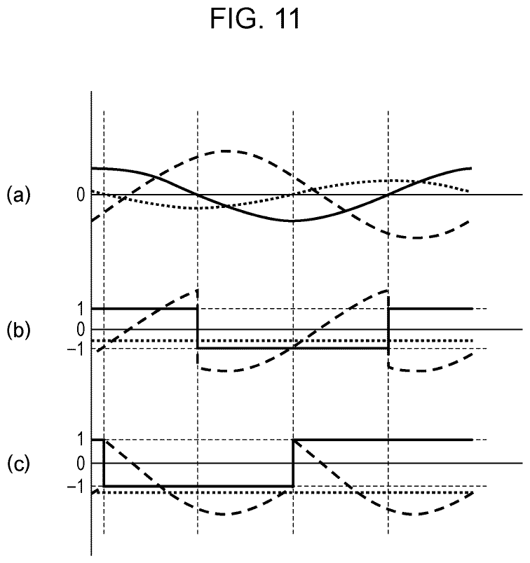

FIG. 11 provides diagrams explaining a method of obtaining the magnitude of each direction component by synchronous detection. FIG. 11(a) illustrates a waveform (solid line) of (current signal I_{A}+current signal I_{B}) as a reference, a signal waveform (broken line) whose component is to be decomposed, and a differential waveform (dotted line) of (current signal I_{A}+current signal I_{B}). FIG. 11(b) illustrates a state in which a component in the same direction as the vector of (current signal I_{A}+current signal I_{B}) is detected. FIG. 11(c) illustrates a state in which a component in the normal direction of the vector of (current signal I_{A}+current signal I_{B}) is detected.

The solid line in FIG. 11(b) indicates a referential signal that becomes 1 when the sign of the solid line in FIG. 11(a) is positive and becomes −1 when the sign is negative. The broken line in FIG. 11(b) indicates the multiplication result of the signal of the broken line in FIG. 11(a) and the referential signal. The dotted line in FIG. 11(b) indicates the average value of the multiplication results, and indicates the magnitude of the vibration component in the same direction as the vector of (current signal I_{A}+current signal I_{B}).

Next, the solid line in FIG. 11(c) indicates a referential signal that becomes 1 when the sign of the dotted line in FIG. 11(a) is positive and becomes −1 when the sign is negative. The broken line in FIG. 11(c) indicates the multiplication result of the signal of the broken line in FIG. 11(a) and the referential signal. The dotted line in FIG. 11(c) indicates the average value of the multiplication results, and indicates the magnitude of the vibration component in the normal direction with respect to the vector of (current signal I_{A}+current signal I_{B}).

In this way, as long as the synchronous detection is used to omit the calculations including the trigonometric functions, the second vibration component detection unit 16 can be easily implemented by a field-programmable gate array (FPGA) or the like.

Next, a fifth example of the second vibration component detection according to the first embodiment will be described.

In the fourth example of the second vibration component according to the first embodiment, the second vibration component is detected by obtaining the respective vectors of the current signal I_{A} and the current signal I_{B}. However, in the fifth example, the second vibration component S is detected by using the vector of (current signal I_{A}−current signal I_{B}).

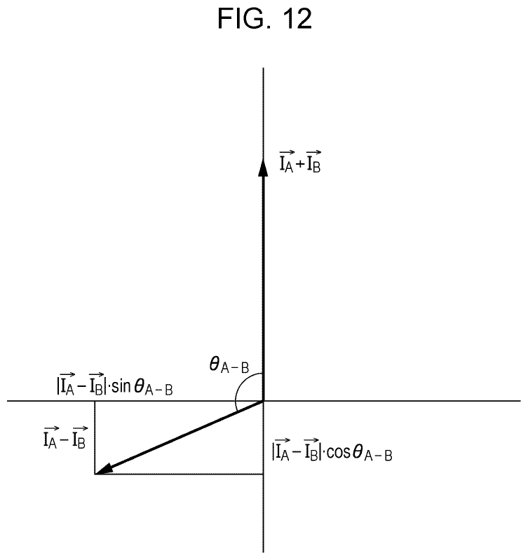

FIG. 12 is a diagram illustrating the relationship between the first vibration vector, which is the sum of the first signal vector (current signal I_{A}) and the second signal vector (current signal I_{B}), and the second vibration vector, which is the difference between the first and second signal vectors. The same-direction component with respect to the push-up vibration component (first vibration vector) of the second vibration vector has a high correlation with the slope of the vibration ellipse. The second vibration component S is obtained by using the same-direction component with respect to the push-up vibration component (first vibration vector) of the second vibration vector, as expressed by Equation 16 and Equation 17.

$$S = \vert \vec{{I}_{A}} - \vec{{I}_{B}} \vert \cdot cos {θ}_{A - B} \qquad Equation 16$$

$$S = \frac{\vert \vec{{I}_{A}} - \vec{{I}_{B}} \vert \cdot cos {θ}_{A - B}}{\vert \vec{{I}_{A}} + \vec{{I}_{B}} \vert} \qquad Equation 17$$

The normal-direction component with respect to the push-up vibration component (first vibration vector) of the second vibration vector may be used. As in Equation 18 and Equation 19, the second vibration component S may be obtained by adding the same-direction component and the normal-direction component with respect to the push-up vibration component (first vibration vector) of the second vibration vector at a predetermined ratio (x:y).

$$S = x ( \vert \vec{{I}_{A}} - \vec{{I}_{B}} \vert \cdot cos {θ}_{A - B} ) + y ( \vert \vec{{I}_{A}} - \vec{{I}_{B}} \vert \cdot sin {θ}_{A - B} ) \qquad Equation 18$$

$$S = \frac{x ( \vert \vec{{I}_{A}} - \vec{{I}_{B}} \vert \cdot cos {θ}_{A - B} ) + y ( \vert \vec{{I}_{A}} - \vec{{I}_{B}} \vert \cdot sin {θ}_{A - B} )}{\vert \vec{{I}_{A}} + \vec{{I}_{B}} \vert} \qquad Equation 19$$

As in the fourth example of the second vibration component according to the first embodiment, the second vibration component S can be obtained by using synchronous detection in this example.

Next, a sixth example of the second vibration component detection according to the first embodiment will be described.

In the above example, the detection method of the second vibration component S corresponding to the Lissajous diagram or the vector indication has been described. In this example, an example of detecting the second vibration component S by synchronous detection from a waveform on a time axis will be described. While the same-direction vibration component with respect to the push-up direction is obtained by using synchronous detection also in the above example, the second vibration component S is directly obtained by synchronous detection in this example.

The second vibration component is a vibration component that is excited by the contact between the vibrating body 5 and the contact body 6 (slider), is generated in the vibrating body 5 as a response to the excitation, and is superimposed on the first vibration component. Thus, the second vibration component is generated on the vibrating body 5 with a constant phase delay from the time point of the contact as a starting point. The time point serving as the starting point is the time point of the peak of the vibration in the vibration mode (push-up vibration mode) illustrated in FIG. 1C. The generated vibration is superimposed on the first vibration component with a phase delay that differs for each vibration mode in accordance with the excitation frequency. The vibration caused by the friction force acting in the relative movement direction between the vibrating body 5 and the contact body 6 (slider) is mainly generated in the vibration mode (feed vibration mode) illustrated in FIG. 1D, and is superimposed on the vibration of the feed vibration mode of the first vibration component with a phase delay θₛ corresponding to the response characteristics of the feed vibration mode.

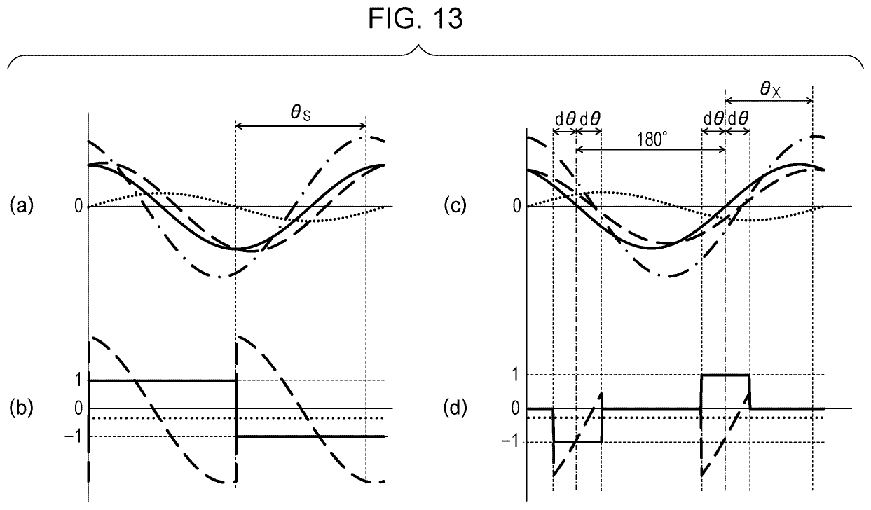

FIGS. 13(a) and 13(b) are diagrams explaining the sixth example of the second vibration component detection according to the first embodiment, and are diagrams for explaining an operation of synchronous detection. FIG. 13(a) illustrates a waveform (solid line) of (current signal I_{A}−current signal I_{B}) at the time of no load, and a superimposition vibration waveform (dotted line) that is superimposed on the waveform at the time of no load. In addition, FIG. 13(a) illustrates a waveform (broken line) of (current signal I_{A}−current signal I_{B}) on which the superimposition vibration waveform (dotted line) has been superimposed, and a waveform (one-dot chain line) of (current signal I_{A}+current signal I_{B}). FIG. 13(b) is a diagram illustrating a state in which a superimposition vibration waveform component is detected by synchronous detection.

The solid line in FIG. 13(b) indicates a referential signal that becomes 1 when the sign of the superimposition vibration waveform (dotted line) in FIG. 13(a) is positive and becomes −1 when the sign is negative. The broken line in FIG. 13(b) indicates the multiplication result of the signal of the broken line in FIG. 13(a) and the referential signal. The dotted line in FIG. 13(b) indicates the average value of the multiplication results. This value changes in accordance with the amplitude of the superimposition vibration waveform (dotted line) in FIG. 13(a).

Here, the superimposition vibration waveform (dotted line) in FIG. 13(a) is a vibration component generated in the vibrating body 5 when the vibrating body 5 receives excitation from the contact body 6 (slider), and cannot be directly detected because it is superimposed on the vibration at the time of no load. Thus, the second vibration component detection unit 16 detects the vibration component including the vibration component of the superimposition vibration waveform by a large amount by using synchronous detection. First, since the phase of the superimposition vibration waveform is a phase that is delayed by the phase of θₛ from the phase of the peak of the waveform (one-dot chain line) of (current signal I_{A}+current signal I_{B}) in FIG. 13(a), the referential signal (solid line) illustrated in FIG. 13(b) is generated in order to extract this phase component. The phase delay amount θₛ varies depending on the drive state, and is therefore set in accordance with the drive state. Next, the waveform (broken line) of (current signal I_{A}−current signal I_{B}) on which the superimposition vibration waveform (dotted line) in FIG. 13(a) has been superimposed, and the referential signal (solid line) in FIG. 13(b) are multiplied and averaged to obtain the second vibration component S by synchronous detection. Alternatively, a value obtained by dividing the value obtained by synchronous detection by the amplitude of (current signal I_{A}+current signal I_{B}) may be the second vibration component S.

The value of θₛ can be obtained in advance by measurement according to the state such as the amplitude of (current signal I_{A}+current signal I_{B}) or the phase difference between the alternating signal V_{A} and the alternating signal V_{B}, and can be prepared as a data table or a function.

In this example, the referential signal is a pulse signal, but may have another waveform such as a sine wave.

Next, a seventh example of the second vibration component detection according to the first embodiment will be described.

FIGS. 13(c) and 13(d) are diagrams illustrating the seventh example of the second vibration component detection according to the first embodiment. FIG. 13(c) illustrates a waveform (solid line) of (current signal I_{A}−current signal I_{B}) at the time of no load, and a superimposition vibration waveform (dotted line) that is superimposed on the waveform at the time of no load. Further, FIG. 13(c) illustrates a waveform (broken line) of (current signal I_{A}−current signal I_{B}) on which the superimposition vibration waveform (dotted line) has been superimposed, and a waveform (one-dot chain line) of (current signal I_{A}+current signal I_{B}).

FIG. 13(d) is a diagram illustrating a state in which the superimposition vibration waveform component is detected by integrating the waveform (broken line) of (current signal I_{A}−current signal I_{B}), on which the actually detected superimposition vibration waveform (dotted line) has been superimposed, in a predetermined phase interval.

The solid line in FIG. 13(d) indicates a gate signal in which a phase interval (0°±dθ) centered on the phase 0° of the waveform (solid line) of (current signal I_{A}−current signal I_{B}) at the time of no load in FIG. 13(c) is −1, a phase interval (180°±dθ) centered on the phase 180° is 1, and the other phase intervals are 0. The broken line in FIG. 13(d) is the multiplication result of the signal of the broken line in FIG. 13(c) and this gate signal. The dotted line in FIG. 13(d) indicates the average value of the multiplication results. This value changes in accordance with the amplitude of the superimposition vibration waveform (dotted line) in FIG. 13(c).

Here, the waveform (solid line) of (current signal I_{A}−current signal I_{B}) at the time of no load in FIG. 13(c) can be detected only at the time of no load. Thus, a phase difference θx between the waveform (solid line) of (current signal I_{A}−current signal I_{B}) at the time of no load and the waveform (one-dot chain line) of (current signal I_{A}+current signal I_{B}) in FIG. 13(c) is set in advance as a value that changes in accordance with various vibration states as a data table or a function. For example, the phase difference θ_{X} can be set in accordance with the state such as the amplitude of (current signal I_{A}+current signal I_{B}) or the phase difference between the alternating signal V_{A} and the alternating signal V_{B}.

The second vibration component detection unit 16 outputs the value of the dotted line in FIG. 13(d) as the second vibration component S without change. Alternatively, a value obtained by division by the amplitude of (current signal I_{A}+current signal I_{B}) may be the second vibration component S.

Next, an eighth example of the second vibration component detection according to the first embodiment will be described.

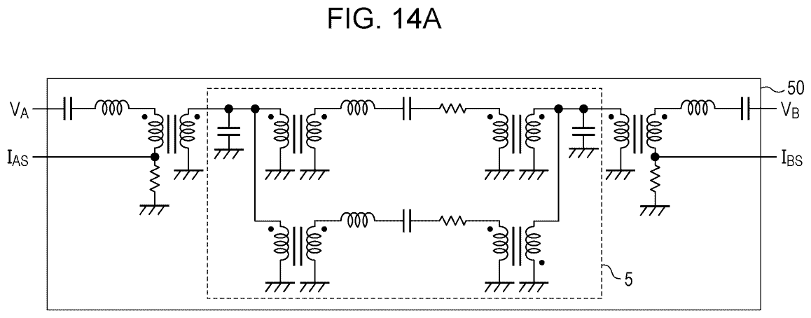

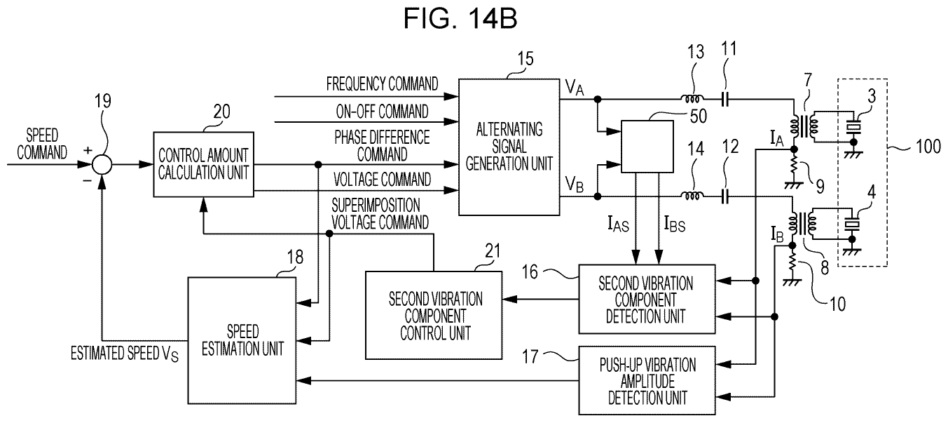

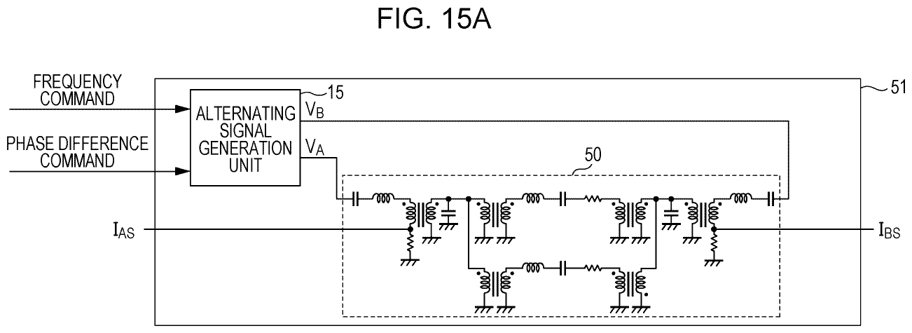

In this example, (current signal I_{A}−current signal I_{B}) (second comparison signal) at the time of no load for the alternating signal V_{A} (first signal) and the alternating signal V_{B} (second signal) is generated by using an equivalent circuit model of a vibrating body 5 and a driving circuit. Then, the difference between the actually measured current signal I_{A} (first detection signal) and current signal I_{B} (second detection signal) is obtained. A superimposition vibration waveform is extracted by subtracting the second comparison signal from the difference. FIG. 14A illustrates a circuit example of the equivalent circuit model. A filter 50 simulates an operation of the equivalent circuit of the vibrating body 5 and the driving circuit at the time of no load. The circuit diagram in the block includes series resonance circuits composed of inductors 13 and 14 and capacitors 11 and 12, transformers 7 and 8, the equivalent circuit of the vibrating body 5 including a piezoelectric body 3 and a piezoelectric body 4, and resistors 9 and 10 for current detection, and the operations of these components are simulated by calculations. When the waveforms of the alternating signal V_{A} and the alternating signal V_{B} are input to the filter 50, the filter 50 outputs the current signal I_{AS} simulating the current signal I_{A} and the current signal I_{BS} simulating the current signal I_{B} in real time.

FIG. 14B is a diagram illustrating a second configuration example of the driving device for the vibration type actuator 100 according to the first embodiment of the present disclosure. FIG. 14B illustrates an example of detecting the second vibration component by using the filter 50. The same reference signs are given to components similar to those illustrated in FIG. 2, and the detailed description thereof will be omitted. The alternating signal V_{A} and the alternating signal V_{B} output from an alternating signal generation unit 15 are input to the filter 50. The filter 50 outputs the current signal I_{AS} simulating the current signal I_{A} at the time of no load and the current signal I_{BS} simulating the current signal I_{B} at the time of no load. A second vibration component detection unit 16 receives the current signals I_{A} and I_{B} and the current signals I_{AS} and I_{BS}, and obtains the difference between the current signal I_{A} (first detection signal) and the current signal I_{B} (second detection signal). An amplitude SF of a superimposition vibration waveform is detected by subtracting (current signal I_{AS}−current signal I_{BS}) (second comparison signal) from the difference. Then, as expressed by Equation 20, the sign of a phase difference θ_{SAB} between the superimposition vibration waveform and (current signal I_{A}+current signal I_{B}) is defined as the sign of the amplitude SF of the superimposition vibration waveform, and the result is output as the second vibration component S.

In the above example, (current signal I_{AS}−current signal I_{BS}) is defined as the second comparison signal, and the second vibration component S is obtained from a signal obtained by subtracting the second comparison signal from the difference between the current signal I_{A} (first detection signal) and the current signal I_{B} (second detection signal). However, (current signal I_{AS}+current signal I_{BS}) may be (first comparison signal) depending on the configuration of the vibrating body 5 or the polarization directions of the piezoelectric bodies 3 and 4. In this case, the second vibration component S may be obtained from a signal obtained by subtracting the first comparison signal from the sum of the current signal I_{A} (first detection signal) and the current signal I_{B} (second detection signal).

$$S = Sign ( {θ}_{SAB} ) \cdot SF \qquad Equation 20$$

Alternatively, the current signal I_{AS} may be the first comparison signal, and the current signal I_{BS} may be the second comparison signal.

The difference between the current signal I_{A} (first detection signal) and the current signal I_{AS} (first comparison signal) and the difference between the current signal I_{B} (second detection signal) and the current signal I_{BS} (second comparison signal) may be obtained, and the difference between the amplitudes of these differences may be the second vibration component S. This is expressed with a vector as expressed by Equation 21.

$$S = \vert \vec{{I}_{A}} - \vec{{I}_{AS}} \vert - \vert \vec{{I}_{B}} - \vec{{I}_{BS}} \vert \qquad Equation 21$$

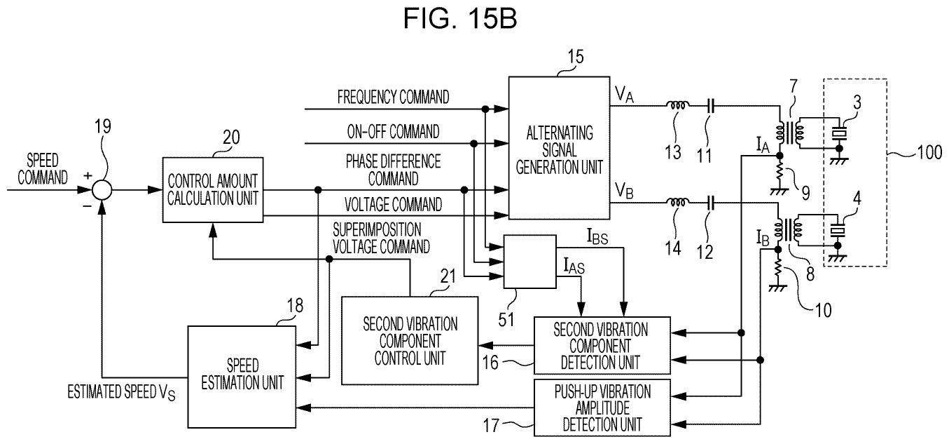

FIG. 15A is a diagram explaining a configuration of a current signal generation unit 51 in which the alternating signal generation unit 15 is added to the filter 50. The current signal generation unit 51 outputs the current signal I_{AS} and the current signal I_{BS} that simulate the current signal I_{A} and the current signal I_{B} at the time of no load, based on the frequency command from the command unit (not illustrated) and the phase difference command from the control amount calculation unit 20.

FIG. 15B is a diagram illustrating a third configuration example of the driving device for the vibration type actuator 100 according to the first embodiment of the present disclosure. FIG. 15B illustrates an example of detecting the second vibration component by using the current signal generation unit 51. The same reference signs are given to components similar to those illustrated in FIG. 2 and FIG. 14B, and the detailed description thereof will be omitted.

The outputs of the filter 50 and the current signal generation unit 51 do not have to be analog signals. For example, digital waveform information or waveform information of such as an amplitude and a phase may be used.

Next, an operation of a speed estimation unit 18 will be described. As presented in FIGS. 7A and 7B, the superimposition voltage component has different sensitivities and different offset values to the speed depending on the phase difference between the alternating signal V_{A} and the alternating signal V_{B} and the push-up vibration amplitude. Thus, in order to estimate the speed from the second vibration component, it is necessary to correct the sensitivity and the offset value of the output of the second vibration component detection unit 16 in accordance with the phase difference between the alternating signal V_{A} and the alternating signal V_{B} and the push-up vibration amplitude.

A sensitivity correction coefficient γ and an offset correction coefficient ¿ are obtained as correction coefficients for obtaining the speed from the superimposition voltage coefficient α for each push-up amplitude and each phase difference between the alternating signal V_{A} and the alternating signal V_{B}. Equation 22 is an equation for estimating a speed V_{S} from the value of the superimposition voltage coefficient α by using these correction coefficients.

$${V}_{S} = \frac{α - ε}{γ} \qquad Equation 22$$

In the case of the characteristics in which the value of the superimposition voltage coefficient α changes linearly with respect to the speed as presented in FIGS. 7A and 7B, the speed can be estimated by using the correction coefficients of the offset and the sensitivity for each push-up amplitude and each phase difference between the alternating signal V_{A} and the alternating signal V_{B} obtained in advance. The characteristics of the sensitivity correction coefficient γ and the offset correction coefficient ε may be stored in a data table, or may be stored as functions T₁ and T₂ of the push-up vibration amplitude and the phase difference between the alternating signal V_{A} and the alternating signal V_{B}. Equation 23 expresses the function T₁ of the offset correction coefficient ε, and Equation 24 expresses the function T₂ of the sensitivity correction coefficient γ.

$$ε = {T}_{1} ( phase difference between alternating signals {V}_{A} and {V}_{B} , push - up vibration amplitude ) \qquad Equation 23$$

$$γ = {T}_{2} ( phase difference between alternating signals {V}_{A} and {V}_{B} , push - up vibration amplitude ) \qquad Equation 24$$

Alternatively, for the sensitivity correction coefficient γ and the offset correction coefficient ε, the frequency of the alternating signal V_{A} and the alternating signal V_{B} may be used instead of the push-up vibration amplitude. In this case, the sensitivity correction coefficient γ and the offset correction coefficient & are obtained from the frequency and the phase difference of the alternating signal V_{A} and the alternating signal V_{B} during driving using a data table or functions T₃ and T₄. Equation 25 expresses the function T₃ of the offset correction coefficient ε, and Equation 26 expresses the function T₄ of the sensitivity correction coefficient γ.

$$ε = {T}_{3} ( phase difference between alternating signals {V}_{A} and {V}_{B} , frequency ) \qquad Equation 25$$

$$γ = {T}_{4} ( phase difference between alternating signals {V}_{A} and {V}_{B} , frequency ) \qquad Equation 26$$

Alternatively, the amplitude of the alternating signal V_{A} and the alternating signal V_{B} and other parameters may be added to the input arguments of the function T₃ and the function T₄.

In the above description, the speed is defined as the linear expression of the superimposition voltage coefficient α, and the speed is estimated by using the offset correction coefficient ε and the sensitivity correction coefficient γ, for example. However, the relationship with the speed may be defined by using polynomial approximation, trigonometric functions, or the like. In this case, a number of coefficients corresponding to the number of terms of the approximation are functions having a plurality of arguments such as T₁ to T₄ described above.

Next, a vibration detector used for detecting the second vibration component will be described. In the above description, the vibration of the vibrating body 5 is detected using the current flowing through the primary winding of the transformer, for example. The method is based on the assumption that the piezoelectric body is connected to the secondary winding of the transformer. That is, the method uses the relationship that the vibration speed of the piezoelectric body is substantially proportional to the fundamental wave component of the current of the primary winding of the transformer when the damping capacity of the piezoelectric body, and the parallel resonance frequency and the driving frequency of the inductor of the secondary winding of the transformer are set close to each other. Although not illustrated in FIG. 2, FIG. 14B, and FIG. 15B, a capacitor or an inductor for adjusting the relationship between the parallel resonance frequency and the driving frequency may be connected in parallel to the piezoelectric body. Otherwise, there is a method of detecting a vibration by a known method of detecting a mechanical arm current. In this method, a referential capacitor having the same electrostatic capacity as the damping capacity of the piezoelectric body is connected in parallel to the piezoelectric body, and a vibration is detected from the difference between the current flowing through the piezoelectric body and the current flowing through the referential capacitor. The fundamental wave component of the current of the primary winding of the transformer can obtain a current signal substantially equivalent to the known mechanical arm current.

When the vibration waveform is detected using the current, and particularly when the waveforms of the alternating signals V_{A} and V_{B} are square waves, the current signal may include harmonic components by a large amount. In this case, the waveform of the current signal may be converted by using a low-pass filter or a band-pass filter after detection, and the waveform after extraction of the fundamental wave component may be the vibration waveform.

The vibrating body may be provided with a piezoelectric body for vibration detection in addition to the piezoelectric body for driving.

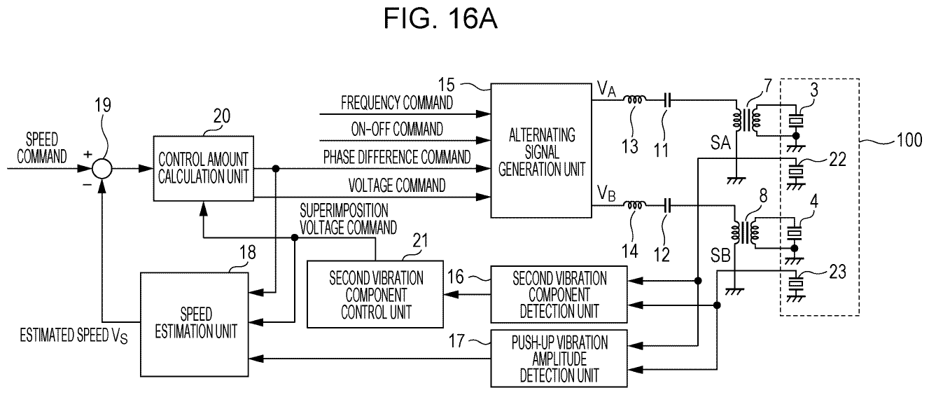

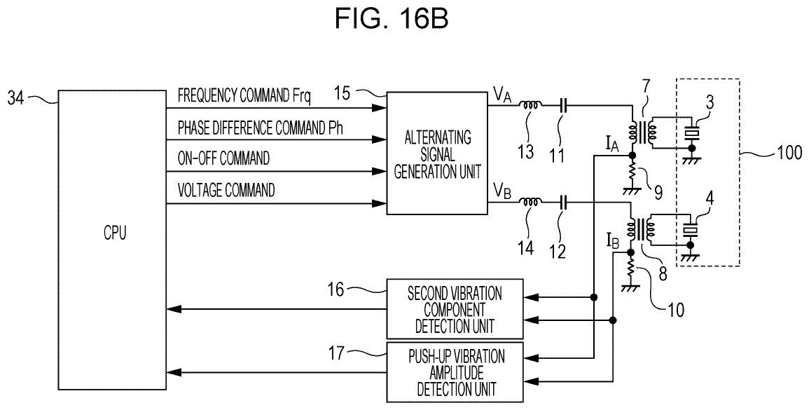

FIG. 16A is a diagram illustrating a fourth configuration example of the driving device for the vibration type actuator 100 according to the first embodiment of the present disclosure. FIG. 16A is a diagram illustrating an example in which a vibrating body 5 is provided with a piezoelectric element for vibration detection in addition to the piezoelectric element for driving. The same reference signs are given to components similar to those illustrated in FIG. 2, and the detailed description thereof will be omitted. A piezoelectric body 22 and a piezoelectric body 23 are piezoelectric elements for vibration detection. The piezoelectric body 22 outputs a vibration detection signal SA, and the piezoelectric body 23 outputs a vibration detection signal SB. The piezoelectric body 22 is provided to overlap the piezoelectric body 3, and the piezoelectric body 23 is provided to overlap the piezoelectric body 4. The piezoelectric body 22 and the piezoelectric body 23 are provided in an overlapping manner, and hence receive substantially the same strains as those of the overlapped piezoelectric bodies. Thus, it is possible to accurately detect the vibrations of the piezoelectric body 3 and the piezoelectric body 4 for driving. The piezoelectric body for vibration detection may be provided in addition to the piezoelectric element for driving as described above. Otherwise, by providing an electrode region for detection independent of the electrode for driving on the piezoelectric element for driving to form a piezoelectric body region for vibration detection, the piezoelectric body region for vibration detection may be used as the piezoelectric body for vibration detection.

FIG. 16B is a diagram illustrating a fifth configuration example of the driving device for the vibration type actuator 100 according to the first embodiment of the present disclosure. In the configuration in FIG. 16B, the portion for performing the speed control including the speed estimation unit and the second vibration control unit in FIG. 2 is performed by a known CPU 34. The same reference signs are given to components similar to those illustrated in FIG. 2, and the detailed description thereof will be omitted.

The CPU 34 receives the second vibration component S output from the second vibration component detection unit 16 and the push-up vibration amplitude output from the push-up vibration amplitude detection unit 17, and performs estimation and control of the speed and control of the push-up vibration amplitude.

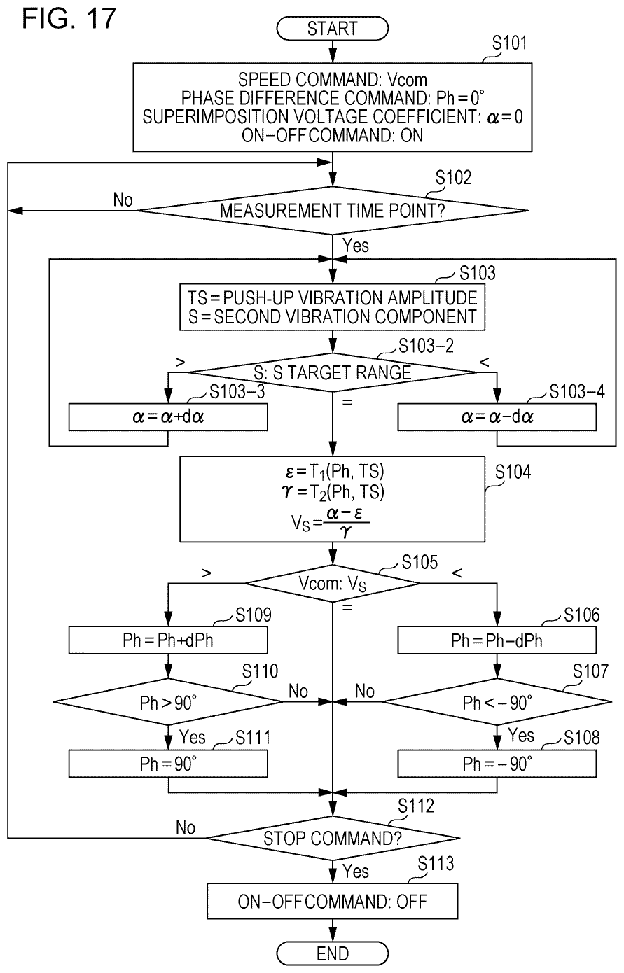

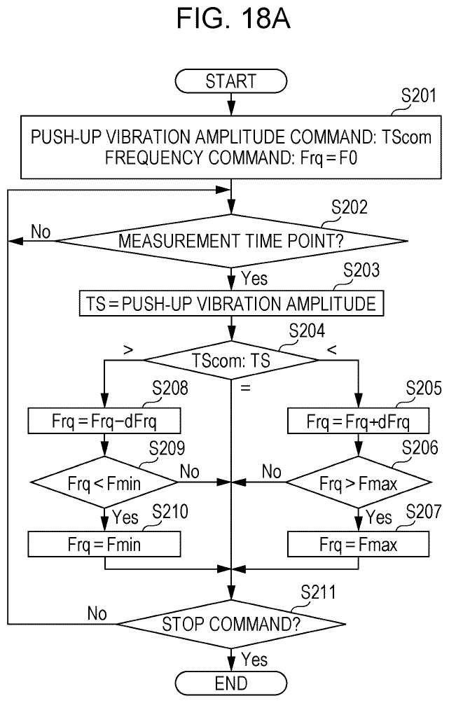

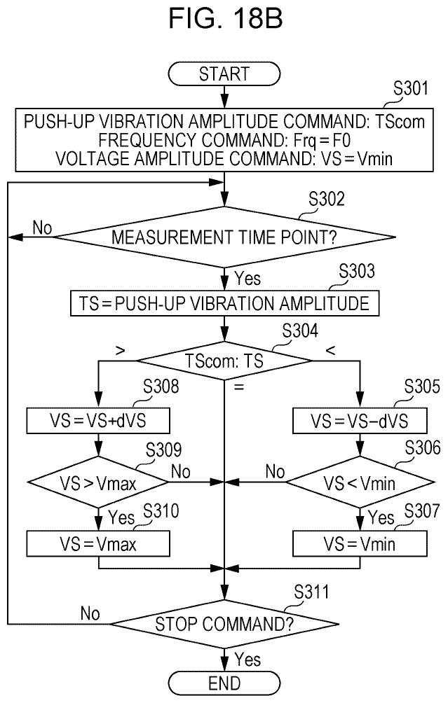

FIG. 17 and FIGS. 18A and 18B are flowcharts presenting an operation of the CPU 34. FIG. 17 presents control steps for controlling the speed. FIGS. 18A and 18B present control steps for controlling the push-up vibration amplitude. First, FIG. 17 will be described. In step S101, the CPU 34 sets a predetermined speed command Vcom, sets a phase difference command Ph to an initial phase difference of 0°, and sets an ON-OFF command to ON. An initial value 0 is set to the superimposition voltage coefficient α for canceling the second vibration component.

Then, in step S102, the CPU 34 determines whether the measurement time point has come. As the result of the determination, when the measurement time point has not come (S102/No), the process waits in step S102.

In contrast, as the result of the determination in step S102, when the measurement time point has come (S102/Yes), the process proceeds to step S103.

When the process proceeds to step S103, the CPU 34 acquires a second vibration component S output from the second vibration component detection unit 16, and a push-up vibration amplitude TS output from the push-up vibration amplitude detection unit 17.

Then, in step S104, the CPU 34 performs a calculation from the values of the push-up vibration amplitude TS acquired in step S103 and the phase difference command Ph. That is, a sensitivity correction coefficient γ and an offset correction coefficient ε are calculated using these values and functions T₁ and T₂ defined by a data table, expressions, and the like. The second vibration component S acquired in step S103 is compared with a target range for decreasing S in step S103-2, and it is determined whether S is above the range, below the range, or within the range. When the second vibration component S is above the range, the superimposition voltage coefficient α is set to α+dα in step S103-3, and when the second vibration component S is below the range, the superimposition voltage coefficient α is set to α−dα in step S103-4, and the second vibration component S is acquired again in step S103. When the second vibration component S is decreased to be within the target range, the process proceeds to step S104, and a speed V_{S} is calculated by using the superimposition voltage coefficient α, the sensitivity correction coefficient γ, and the offset correction coefficient ε. In the subsequent step, the speed command Vcom and the speed V_{S} calculated in step S104 are compared with each other to control the phase difference command Ph.

Next, the control of the phase difference command Ph will be described in steps S105 to S111.

In step S105, the CPU 34 compares the speed command Vcom set in step S101 with the speed V_{S} calculated in step S104.

As the result of the comparison in step S105, when the speed command Vcom is smaller than (<) the speed V_{S}, the process proceeds to step S106.

When the process proceeds to step S106, the CPU 34 subtracts a predetermined phase dPh from the phase difference command Ph.

Then, in step S107, the CPU 34 determines whether the phase difference command Ph is smaller than −90°.

As the result of the determination in step S107, when the phase difference command Ph is smaller than −90° (S107/Yes), the process proceeds to step S108.

When the process proceeds to step S108, the CPU 34 sets the phase difference command Ph to −90°.

As the result of the comparison in step S105, when the speed command Vcom is larger than (>) the speed V_{S}, the process proceeds to step S109.

When the process proceeds to step S109, the CPU 34 adds the predetermined phase dPh to the phase difference command Ph.

Then, in step S110, the CPU 34 determines whether the phase difference command Ph is larger than +90°.

As the result of the determination in step S110, when the phase difference command Ph is larger than +90° (S110/Yes), the process proceeds to step S111.

When the process proceeds to step S111, the CPU 34 sets the phase difference command Ph to +90°.

When the process of step S108 is completed, when the process of step S111 is completed, or when the speed command Vcom is the same as (=) the speed V_{S} in the comparison of step S105, the process proceeds to step S112. By repeating the operation of steps S105 to S111, the phase difference command Ph is controlled so that the speed V_{S} approaches the speed command Vcom.

Then, in step S112, the CPU 34 determines whether a stop command has been input. As the result of the determination, when the stop command has not been input (S112/No), the process returns to step S102, and the process of step S102 and later is performed.

In contrast, as the result of the determination in step S112, when it is determined that the stop command has been input (S112/Yes), the process proceeds to step S113.

When the process proceeds to step S113, the CPU 34 sets the ON-OFF command to OFF. Accordingly, the outputs of the alternating signal V_{A} and the alternating signal V_{B} output from the alternating signal generation unit 15 become 0 V, and the contact body 6 (slider) of the vibration type actuator 100 stops.

When the process of step S113 is completed, the process of the flowchart presented in FIG. 17 is completed.

Next, FIG. 18A will be described. First, in step S201, the CPU 34 sets a predetermined push-up vibration amplitude command TScom, and sets a frequency command Frq to an initial frequency F0.

Then, in step S202, the CPU 34 determines whether the measurement time point has come. As the result of the determination, when the measurement time point has not come (S202/No), the process waits in step S202.

In contrast, as the result of the determination in step S202, when the measurement time point has come (S202/Yes), the process proceeds to step S203.

When the process proceeds to step S203, the CPU 34 acquires a push-up vibration amplitude TS output from the push-up vibration amplitude detection unit 17.

In the subsequent step, the push-up vibration amplitude command TScom is compared with the push-up vibration amplitude TS detected in step S203, and the frequency command Frq is controlled.

Next, the control of the frequency command Frq will be described in steps S204 to S210.

In step S204, the CPU 34 compares the push-up vibration amplitude command TScom set in step S201 with the push-up vibration amplitude TS detected in step S203.

As the result of the comparison in step S204, when the push-up vibration amplitude command TScom is smaller than (<) the push-up vibration amplitude TS, the process proceeds to step S205.

When the process proceeds to step S205, the CPU 34 adds a predetermined frequency dFrq to the frequency command Frq.

Then, in step S206, the CPU 34 determines whether the frequency command Frq is larger than Fmax.

As the result of the determination in step S206, when the frequency command Frq is larger than Fmax (S206/Yes), the process proceeds to step S207.

When the process proceeds to step S207, the CPU 34 sets the frequency command Frq to Fmax.

As the result of the comparison in step S204, when the push-up vibration amplitude command TScom is larger than (>) the push-up vibration amplitude TS, the process proceeds to step S208.

When the process proceeds to step S208, the CPU 34 subtracts the predetermined frequency dFrq from the frequency command Frq.

Then, in step S209, the CPU 34 determines whether the frequency command Frq is smaller than Fmin.

As the result of the determination in step S209, when the frequency command Frq is smaller than Fmin (S209/Yes), the process proceeds to step S210.

When the process proceeds to step S210, the CPU 34 sets the frequency command Frq to Fmin.

When the process of step S207 is completed, when the process of step S210 is completed, or when the push-up vibration amplitude command TScom is the same as (=) the push-up vibration amplitude TS in the comparison of step S204, the process proceeds to step S211. By repeating the operation of steps S204 to S210, the frequency command Frq is controlled so that the push-up vibration amplitude TS approaches the push-up vibration amplitude command TScom.

Then, in step S211, the CPU 34 determines whether the stop command has been input. As the result of the determination, when the stop command has not been input (S211/No), the process returns to step S202, and the process of step S202 and later is performed.

In contrast, as the result of the determination in step S211, when the stop command has been input (S211/Yes), the process of the flowchart presented in FIG. 18A is completed.

In the description with FIG. 17, the sensitivity correction coefficient γ and the offset correction coefficient & are calculated by substituting the values of the push-up vibration amplitude TS and the phase difference command Ph into the functions T₁ and T₂. However, the functions T₃ and T₄ using the frequency command Frq instead of the push-up vibration amplitude TS may be used.

In the above example, the push-up vibration amplitude is controlled using the frequency command Frq to the alternating signal generation unit 15. However, the amplitudes of the alternating signal V_{A} and the alternating signal V_{B} output from the alternating signal generation unit 15 may be controlled. FIG. 18B is a flowchart presenting the control operation for the push-up vibration amplitude in the case where the alternating signal generation unit 15 controls the amplitudes of the alternating signal V_{A} and the alternating signal V_{B} by a voltage amplitude command (not illustrated). The steps in FIG. 18B will be described below.

First, in step S301, the CPU 34 sets a predetermined push-up vibration amplitude command TScom, sets a frequency command Frq to an initial frequency F0, and sets a voltage amplitude command VS to a minimum voltage amplitude Vmin.

Then, in step S302, the CPU 34 determines whether the measurement time point has come. As the result of the determination, when the measurement time point has not come (S302/No), the process waits in step S302.

In contrast, as the result of the determination in step S302, when the measurement time point has come (S302/Yes), the process proceeds to step S303.

When the process proceeds to step S303, the CPU 34 acquires a push-up vibration amplitude TS output from the push-up vibration amplitude detection unit 17.

In the subsequent step, the push-up vibration amplitude command TScom is compared with the push-up vibration amplitude TS detected in step S303, and the voltage amplitude command VS is controlled.

Next, the control of the voltage amplitude command VS will be described in steps S304 to S310.

In step S304, the CPU 34 compares the push-up vibration amplitude command TScom set in step S301 with the push-up vibration amplitude TS detected in step S303.

As the result of the comparison in step S304, when the push-up vibration amplitude command TScom is smaller than (<) the push-up vibration amplitude TS, the process proceeds to step S305.

When the process proceeds to step S305, the CPU 34 subtracts a predetermined voltage dVS from the voltage amplitude command VS.

Then, in step S306, the CPU 34 determines whether the voltage amplitude command VS is smaller than Vmin.

As the result of the determination in step S306, when the voltage amplitude command VS is smaller than Vmin (S306/Yes), the process proceeds to step S307.

When the process proceeds to step S307, the CPU 34 sets the voltage amplitude command VS to Vmin.

As the result of the comparison in step S304, when the push-up vibration amplitude command TScom is larger than (>) the push-up vibration amplitude TS, the process proceeds to step S308.

When the process proceeds to step S308, the CPU 34 adds the predetermined voltage dVS to the voltage amplitude command VS.

Then, in step S309, the CPU 34 determines whether the voltage amplitude command VS is larger than Vmax.

As the result of the determination in step S309, when the voltage amplitude command VS is larger than Vmax (S309/Yes), the process proceeds to step S310.

When the process proceeds to step S310, the CPU 34 sets the voltage amplitude command VS to Vmax.

When the process of step S307 is completed, when the process of step S310 is completed, or when the push-up vibration amplitude command TScom is the same as (=) the push-up vibration amplitude TS in the comparison of step S304, the process proceeds to step S311. By repeating the operation of steps S304 to S310, the voltage amplitude command VS is controlled so that the push-up vibration amplitude TS approaches the push-up vibration amplitude command TScom.

Then, in step S311, the CPU 34 determines whether the stop command has been input. As the result of the determination, when the stop command has not been input (S311/No), the process returns to step S302, and the process of step S302 and later is performed.

In contrast, as the result of the determination in step S311, when the stop command has been input (S311/Yes), the process of the flowchart presented in FIG. 18B is completed.

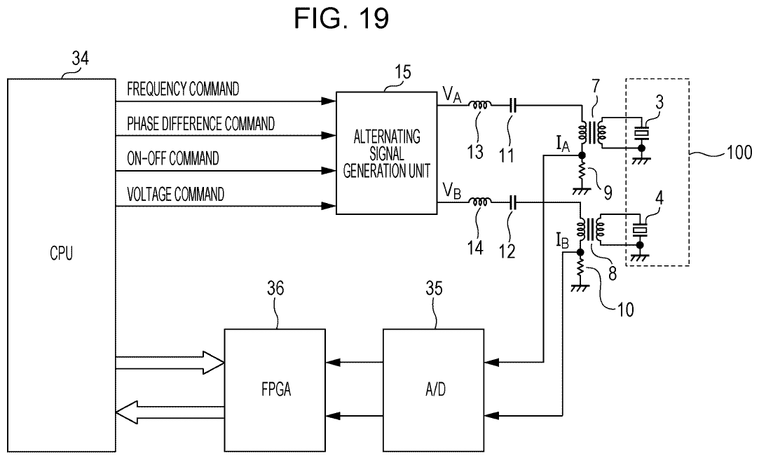

FIG. 19 is a diagram illustrating a sixth configuration example of the driving device for the vibration type actuator 100 according to the first embodiment of the present disclosure. FIG. 19 illustrates a configuration in which the functions of the second vibration component detection unit 16 and the push-up vibration amplitude detection unit 17 are implemented by an analog-to-digital (A/D) convertor 35 and a FPGA 36. The same reference signs are given to components similar to those illustrated in FIG. 2, and the detailed description thereof will be omitted. The waveform information on the current signal I_{A} and the current signal I_{B} is converted into digital data by the A/D converter 35 and is acquired in the FPGA 36. The second vibration component and the push-up vibration amplitude are detected in the FPGA 36. In the FPGA 36, various methods of detecting the second vibration component described above can be selected in accordance with the situation, and the second vibration component S is detected by a composite calculation of the results detected by a plurality of detection methods.

The CPU 34 reads out the second vibration component S and the push-up vibration amplitude from the FPGA 36, and performs processes according to the flowcharts in FIGS. 17 and 18A.

Next, another example of the vibration type actuator will be described.

In the above description, the technique of estimating the speed has been described by taking the vibration type actuator using the plate-shaped vibrating body 5 having the two different natural vibration modes illustrated in FIGS. 1A to 1E as an example. However, the speed can be estimated by a similar method also in a vibration type actuator of another type.

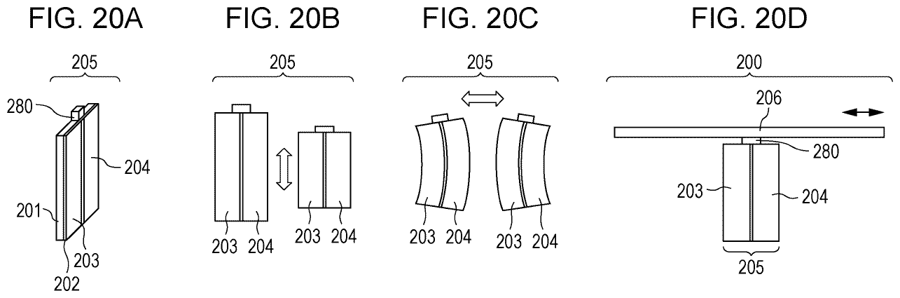

FIGS. 20A to 20D are views illustrating an example of a general configuration and vibration shapes of a vibration type actuator 200. The general configuration and an operation principle of the vibration type actuator 200 according to the first embodiment will be described with reference to FIGS. 20A to 20D.

As illustrated in FIG. 20D, the vibration type actuator 200 according to the first embodiment includes a vibrating body 205 and a contact body 206. The vibrating body 205 is a plate-shaped vibrating body made of a conductive material, and as illustrated in FIG. 20A and FIG. 20D, includes a piezoelectric element 202 and an elastic body 201 including a protruding portion 280 that comes into contact with the contact body 206, on a surface of the plate shape. The piezoelectric element 202 is a component that forms a portion of the vibrating body 205 and excites the vibrating body 205.

As illustrated in FIG. 20A, two electrodes 203 and 204 are formed on the front surface of the piezoelectric element 202. The two electrodes 203 and 204 are electrodes electrically insulated from each other. Two alternating voltages whose phases independently change are applied to the two electrodes. The entire back surface of the piezoelectric element 202 is an electrode and is configured to be connected at a ground potential from the front surface of the piezoelectric element 202 through a via (not illustrated) provided in a portion of the piezoelectric element 202. In the following description, the electrodes 203 and 204 are referred to as a piezoelectric body 203 and a piezoelectric body 204, respectively.

The contact body 206 illustrated in FIG. 20D is a slider that comes into pressure contact with the protruding portion 280 of the vibrating body 205 with a constant pressure by a pressure mechanism (not illustrated). The contact body 206 (slider) is configured to relatively move in the left-right direction of the paper surface by the vibration excited in the vibrating body 205.

FIG. 20B and FIG. 20C are views illustrating examples of vibration modes of the vibrating body 205. FIG. 20B illustrates a vibration shape (stretching vibration) of a vibration mode (push-up vibration mode) excited in the vibrating body 205 when alternating voltages having the same amplitude and the same phase are applied to the piezoelectric body 203 and the piezoelectric body 204. FIG. 20C illustrates a vibration shape (bending vibration) of a vibration mode (feed vibration mode) excited in the vibrating body 205 when alternating voltages having the same amplitude and opposite phases are applied to the piezoelectric body 203 and the piezoelectric body 204. That is, when the phase difference between the alternating voltages that are applied to the piezoelectric body 203 and the piezoelectric body 204 of the vibrating body 205 is 0°, the vibrating body 205 is excited in the vibration mode (push-up vibration mode) illustrated in FIG. 20B. When the phase difference between the alternating voltages that are applied to the piezoelectric body 203 and the piezoelectric body 204 of the vibrating body 205 is 180°, the vibrating body 205 is excited in the vibration mode (feed vibration mode) illustrated in FIG. 20C. When the phase difference between the alternating voltages that are applied to the piezoelectric body 203 and the piezoelectric body 204 of the vibrating body 205 is a phase difference other than 0° and 180° (actually, a range of about 0° to about +120° is used), the vibrating body 205 is excited in both the vibration modes illustrated in FIG. 20B and FIG. 20C simultaneously. In this case, the contact body 206 (slider) brought into pressure contact with the protruding portion 280 provided on the vibrating body 205 moves in the traversal direction of the rectangle of the vibrating body 205.

As the phase difference is away from 0°, the amplitude of the vibration mode (feed vibration mode) illustrated in FIG. 20C increases, and the relative speed between the contact body 206 (slider) and the vibrating body 205 increases.

The driving device for the vibration type actuator 100 according to the first embodiment can be applied by replacing the piezoelectric bodies 203 and 204 with the piezoelectric bodies 3 and 4.

In the above example, the amplitude of the sum signal of the current signal I_{A} and the current signal I_{B} is the push-up vibration amplitude. However, the amplitude of the difference signal between the current signal I_{A} and the current signal I_{B} may be the push-up vibration amplitude depending on the structure of the vibration type actuator.

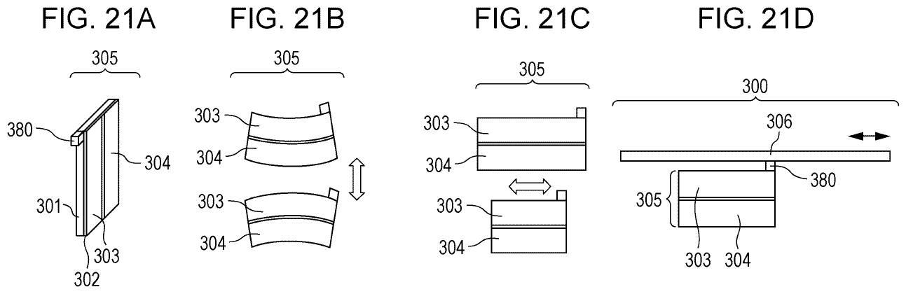

FIGS. 21A to 21D are views illustrating a general configuration of a vibration type actuator 300. As illustrated in FIG. 21D, the vibration type actuator 300 includes a vibrating body 305 and a contact body 306. As illustrated in FIG. 21A and FIG. 21D, the vibrating body 305 includes a piezoelectric element 302 and an elastic body 301 including a protruding portion 380 that comes into contact with the contact body 306, on a surface of the plate shape. The vibration type actuator 300 uses the same vibration modes as those of the vibration type actuator 200, but the position of the protruding portion 380 that comes into contact with the contact body 306 is different, and the amplitude of (current signal I_{A}−current signal I_{B}) corresponds to the push-up vibration amplitude.

FIG. 21B and FIG. 21C are views illustrating examples of the vibration modes of the vibrating body 305. FIG. 21B illustrates a vibration shape (bending vibration) of a vibration mode (push-up vibration mode) excited in the vibrating body 305 when alternating voltages having the same amplitude and opposite phases are applied to a piezoelectric body 303 and a piezoelectric body 304. FIG. 21C illustrates a vibration shape (stretching vibration) of a vibration mode (feed vibration mode) excited in the vibrating body 305 when alternating voltages having the same amplitude and the same phase are applied to the piezoelectric body 303 and the piezoelectric body 304.

In the above example, the second vibration component is detected by using (current signal I_{A}−current signal I_{B}), and the push-up vibration amplitude is detected by using (current signal I_{A}+current signal I_{B}). However, the detection is performed in the opposite manner in the case of the vibration type actuator 300. That is, in the case of the vibration type actuator 300, the second vibration component is detected by using (current signal I_{A}+current signal I_{B}), and the push-up vibration amplitude is detected by using (current signal I_{A}−current signal I_{B}).

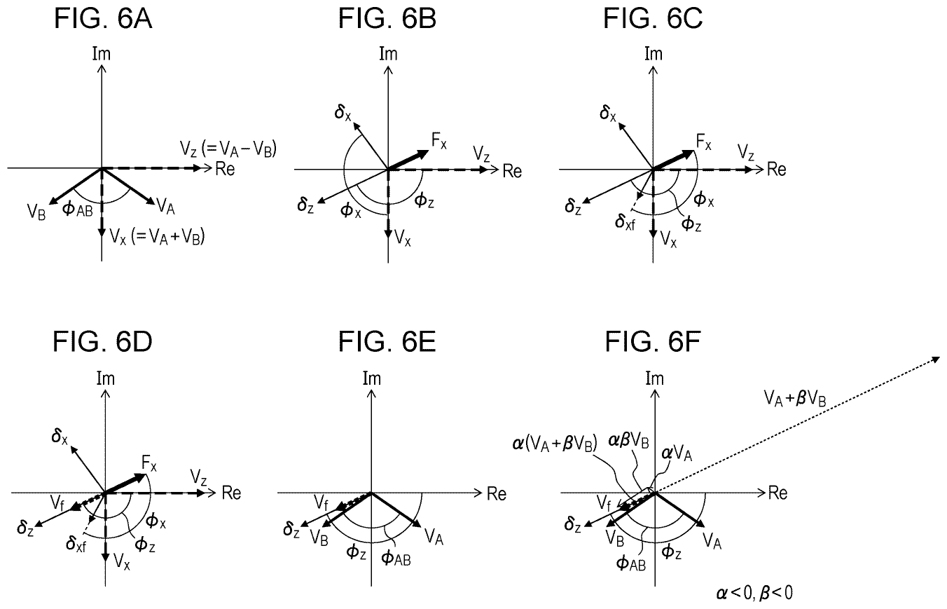

In the first example of the superimposition voltage component according to the vibration type actuator 100, the superimposition voltage component is generated by the generation method illustrated in FIGS. 5A to 5F, and the voltage components that are superimposed on the two alternating signals V_{A} and V_{B} are αV_{A} and αβV_{B}, respectively. FIGS. 6A to 6F are complex plane diagrams explaining applied voltages, excitation forces, and vibration responses in the case of the vibration type actuator 300, and a method of generating a superimposition voltage component V_{f}. When a push-up vibration excitation voltage V_{z} and a feed direction excitation voltage Vₓ are set to a phase similar to that in FIGS. 5A to 5F to meet the phase of the drive vibration, the voltage V_{B} becomes an inverted voltage vector as illustrated in FIG. 6A. The vibration responses δₓ and δ_{z} and the friction excitation force Fₓ are similar to those in FIGS. 5A to 5F. When α and β have the same signs as those in the case of the vibration type actuator 100, in order to obtain a vector of the superimposition voltage whose phase meets φ_{z}, the coefficient β is calculated based on the voltage command and the phase difference command so that the voltage vector expressed by (V_{A}+βV_{B}) meets the phase φ_{z}. As illustrated in FIG. 6F, the superimposition voltage components of the two alternating signals V_{A} and V_{B} are αV_{A} and αβV_{B}, respectively, and the superimposition excitation force in the feed direction is α(V_{A}+βV_{B}).

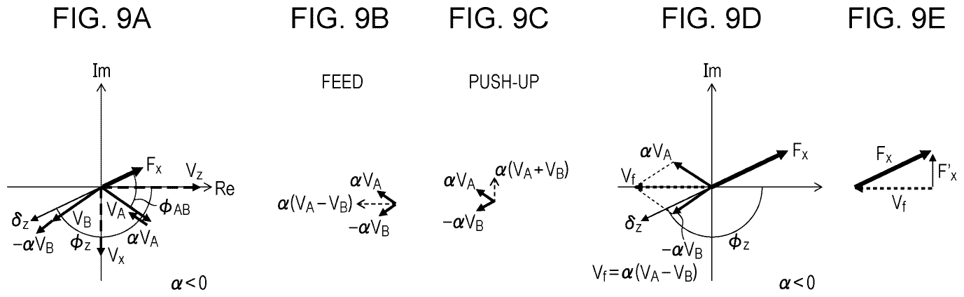

In the second example of the superimposition voltage component according to the vibration type actuator 100, the superimposition voltage components are set to αV_{A} and −αV_{B} by using the superimposition voltage coefficient α. In the example of the vibration type actuator 300, the sum of both signals is the feed vibration component, but the superimposition voltage component can be generated by setting αV_{A} and −αV_{B} likewise. FIGS. 9A to 9E are complex plane diagrams illustrating a method of generating a superimposition voltage component according to the embodiment of the vibration type actuator 300. When the push-up vibration excitation voltage V_{z} and the feed direction excitation voltage Vₓ are set to a phase similar to that in FIGS. 8A to 8E to meet the phase of the drive vibration, the voltage V_{B} becomes an inverted voltage vector as illustrated in FIG. 9A. The vibration responses 8x and &z and the friction excitation force Fₓ are similar to those in FIGS. 8A to 8E. Here, when the superimposition voltage components are set to αV_{A} and −αV_{B} by using the equivalent coefficient α, the sum signal V_{f} of the feed vibration excitation force is V_{f}=a (V_{A}−V_{B}) as illustrated in FIG. 9B.

As in FIGS. 8A to 8E, the phase of the feed vibration excitation voltage is different by 90°, and meets the inverted phase of the push-up vibration excitation voltage component. The second vibration component is decreased by the sum signal V_{f}, and the superimposition voltage coefficient α corresponding to the friction excitation force can be obtained. In view of this, the driving device for the vibration type actuator 100 according to the first embodiment can be applied by changing the correspondence between the push-up vibration and the feed vibration and replacing the piezoelectric bodies 303 and 304 with the piezoelectric bodies 3 and 4.

In the above example, the phase difference command is input to the speed estimation unit 18, but the actual phase difference between the alternating signal V_{A} and the alternating signal V_{B} or the drive voltages generated in accordance with the alternating signal V_{A} and the alternating signal V_{B} may be measured and input.

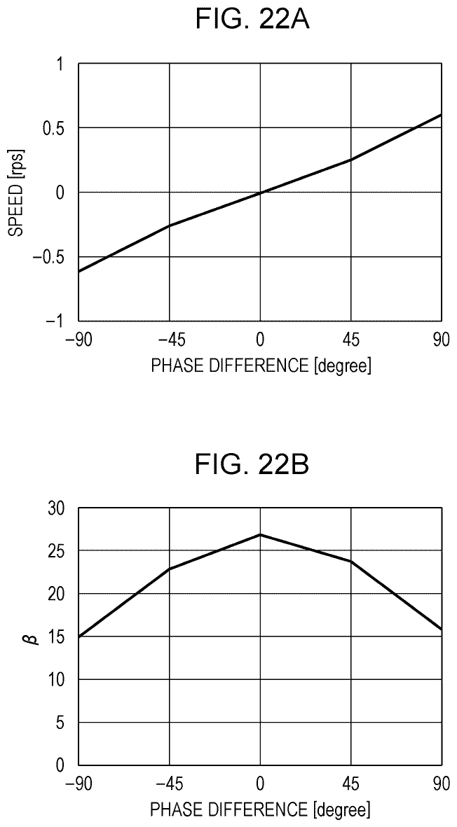

Alternatively, a thrust can be estimated from the speed V_{S} estimated in the above embodiment. The method will be described below. The speed at the time of the generation of a predetermined thrust F₀ and the slope of a change in thrust to a change in speed are obtained in advance for the phase difference between the alternating signal V_{A} and the alternating signal V_{B}. FIG. 22A is a graph presenting the phase difference between the alternating signal V_{A} and the alternating signal V_{B}, and the speed (reference speed: V₀) when the thrust is a predetermined value F₀. FIG. 22B is a graph presenting the ratio (β) of a change in thrust to a change in speed. Then, a thrust F_{S} can be obtained by Equation 27.

$${F}_{S} = {F}_{0} + {β}_{( phase difference )} \cdot ( {V}_{S} - {V}_{0 ( F 0 , phase diference )} ) \qquad Equation 27$$

### Second Embodiment

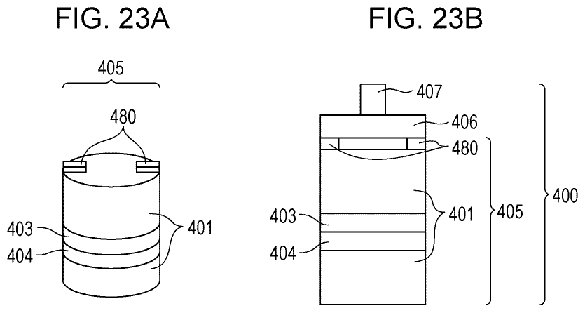

FIGS. 23A and 23B are views illustrating an example of a general configuration of a vibration type actuator 400 according to a second embodiment of the present disclosure. The general configuration and an operation principle of the vibration type actuator 400 according to the second embodiment will be described with reference to FIGS. 23A and 23B.

As illustrated in FIG. 23B, the vibration type actuator 400 according to the second embodiment includes a vibrating body 405, a contact body 406, and a rotational shaft 407 connected to the contact body 406. As illustrated in FIG. 23A, the vibrating body 405 is a columnar vibrating body made of a conductive material, and includes a piezoelectric body 403 and a piezoelectric body 404, and elastic bodies 401 that sandwich these piezoelectric bodies from above and below and include a protruding portion 480 at an upper portion of the column. The piezoelectric body 403 is a component for exciting a vibration to expand and contract the vibrating body 405 in the height direction of the column. The piezoelectric body 404 is a component for exciting a torsional vibration of the vibrating body 405 with respect to the center axis of the column. The piezoelectric body 403 and the piezoelectric body 404 are sandwiched between and fixed by the elastic bodies 401 with a fastening member (not illustrated).

The contact body 406 illustrated in FIG. 23B is a rotor that comes into pressure contact with the protruding portion 480 of the vibrating body 405 with a constant pressure by a pressure mechanism (not illustrated). The rotational shaft 407 and the contact body 406 (rotor) are rotated by the vibration excited in the vibrating body 405.

A driving operation of the vibration type actuator 400 will be described below. The vibration type actuator 400 is an actuator that rotationally drives the contact body 406 (rotor) by a composite vibration of a stretching vibration (push-up vibration) and a torsional vibration (feed vibration) excited in the vibrating body 405. When an alternating voltage of a predetermined frequency is applied to the piezoelectric body 403, the stretching vibration (push-up vibration) is excited in the vibrating body 405. When the alternating voltage is applied to the piezoelectric body 404, the torsional vibration (feed vibration) is excited in the vibrating body 405. Thus, when the stretching vibration (push-up vibration) and the torsional vibration (feed vibration) are excited while the phase is temporally shifted, the contact body 406 (rotor) rotates.

The difference between the vibration type actuator 400 and the vibration type actuator 100 will be described below. These actuators have a great difference in driving in addition to the difference in shape. That is, the vibration type actuator 100 excites the push-up vibration with the same-phase components and the feed vibration with the opposite phase components of the applied two-phase alternating voltages, whereas the respective phases of the two-phase alternating voltages individually correspond to the push-up vibration and the feed vibration. Accordingly, the vibration type actuator 100 controls the amplitude balance between the push-up vibration and the feed vibration using the phase difference between the applied two-phase alternating voltages, whereas the vibration type actuator 400 does not change the amplitude balance between the push-up vibration and the feed vibration even when the phase difference is operated. Thus, in the vibration type actuator 400, the balance between the push-up vibration and the feed vibration is controlled by operating the amplitude balance between the two-phase alternating voltages or the voltage amplitude of one phase.

Next, vibration excitation to the vibrating body 405 caused by an external force of the vibration type actuator 400 will be described. An example of driving under a condition that the frequency of the two-phase alternating voltages is higher than the natural frequency of the push-up vibration mode of the vibrating body 405 will be described. In the vibration type actuator 400, the locus of the vibration ellipse at the contact portion between the protruding portion 480 and the contact body 406 (rotor) has a tendency similar to that in FIG. 3.

As in FIG. 3, the vibration locus of the tip of the protruding portion 480 when the vibration type actuator 400 is driven is also elliptical, and the vibration ellipse is inclined in the direction opposite to the direction of the force acting on the tip of the protruding portion 480 in accordance with the magnitude of the force. This phenomenon occurs when the vibration caused by the excitation received by the vibrating body 405 at the time of the contact between the protruding portion 480 and the contact body 406 (rotor) is superimposed on the vibrating body 405. Then, the speed is estimated by detecting the superimposed vibration component (second vibration component), and performing the control of minimization with the superimposition voltage component that is superimposed on the alternating voltages that are applied to the piezoelectric bodies. Since a change occurs in accordance with the relationship between the natural frequencies of the vibration modes of the vibrating body 405 and the frequency of the alternating voltages that are applied to the piezoelectric bodies, it is necessary to detect the second vibration component and estimate the speed in accordance with the driving condition.

An example of driving under a condition that the frequency of the two-phase alternating voltages is higher than the natural frequencies of the vibration modes of the vibrating body 405 will be described.

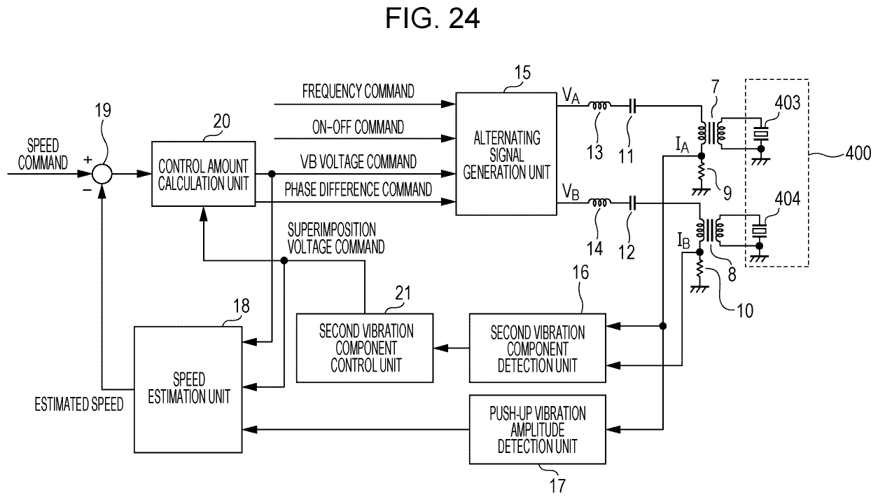

FIG. 24 is a diagram illustrating a first configuration example of a driving device for the vibration type actuator 400 according to the second embodiment of the present disclosure.

First, a generation unit of alternating voltages will be described. An alternating signal generation unit 15 generates two-phase alternating signal V_{A} (first signal) and alternating signal V_{B} (second signal) having a phase difference of 90° based on a frequency command from a command unit (not illustrated) and a V_{B} voltage amplitude command output from a control amount calculation unit 20. The alternating signal V_{A} has a predetermined amplitude. The alternating signal V_{B} has an amplitude corresponding to the V_{B} voltage amplitude command, and the alternating signal V_{B} is inverted in polarity and output when the V_{B} voltage amplitude command has a negative value.

The alternating signal V_{A} and the alternating signal V_{B} are connected to the primary windings of a transformer 7 and a transformer 8 via series resonance circuits composed of inductors 13 and 14 and capacitors 11 and 12, respectively. The voltages input to the primary windings of the transformer 7 and the transformer 8 are boosted and applied as a first drive voltage and a second drive voltage to the piezoelectric body 403 and the piezoelectric body 404 of the vibration type actuator 400 connected to the secondary windings of the transformer 7 and the transformer 8. Here, the inductor values of the secondary windings of the transformer 7 and the transformer 8 are frequency-matched with the damping capacities of the piezoelectric body 403 and the piezoelectric body 404. Accordingly, currents substantially proportional to the vibration speeds of the piezoelectric body 403 and the piezoelectric body 404 flow through the primary windings of the transformer 7 and the transformer 8.

In contrast, resistors 9 and 10 are connected in series to the primary windings of the transformer 7 and the transformer 8. The resistors 9 and 10 convert the currents flowing through the primary windings of the transformers connected thereto into voltages to generate a current signal I_{A} and a current signal I_{B}. The current signal I_{A} (first detection signal) is a signal corresponding to the vibration of the stretching vibration mode (push-up vibration mode) of the vibrating body 405, and the current signal I_{B} (second detection signal) is a signal corresponding to the vibration of the torsional vibration mode (feed vibration mode) of the vibrating body 405.

Next, a configuration related to estimation and control of the speed will be described. A second vibration component detection unit 16 and a push-up vibration amplitude detection unit 17 receive the current signal I_{A} and the current signal I_{B}, and detect a second vibration component and a push-up vibration amplitude. The detected second vibration component is input to a second vibration component control unit 21. The second vibration component control unit 21 calculates a command value of a superimposition voltage that is superimposed on the voltage of the alternating signal V_{B} so that an excitation force having a sign opposite to that of the excitation force of the second vibration component is generated in accordance with the magnitude and the time phase of the second vibration component to decrease the second vibration component. The superimposition voltage command is input to the control amount calculation unit 20, and a phase difference command and a V_{B} voltage command updated by the control amount calculation unit 20 based on the superimposition voltage command are output to the alternating signal generation unit 15, thereby forming a control loop for decreasing the second vibration component to a predetermined range.

The superimposition voltage command in the state in which the control of minimizing the second vibration component is performed by the control loop for decreasing the second vibration component described above corresponds to the excitation force for canceling the excitation force of the second vibration component, that is, the friction excitation force. A speed estimation unit 18 detects the speed by using the superimposition voltage command, the vibration amplitude of the stretching vibration mode (push-up vibration mode) of the vibrating body 405, and the value of the V_{B} voltage amplitude command.

Then, a comparator 19 compares the detected speed with a speed command from a command unit (not illustrated). The control amount calculation unit 20 generates the V_{B} voltage amplitude command signal in accordance with the comparison result. The voltage amplitude of the alternating signal V_{B} is set, and the speed is controlled in accordance with the magnitude of the amplitude of the feed vibration mode excited in the vibrating body 405.

Details of the speed estimation method and the vibration detection will be described later.

A first example of second vibration component detection according to the second embodiment will be described below.

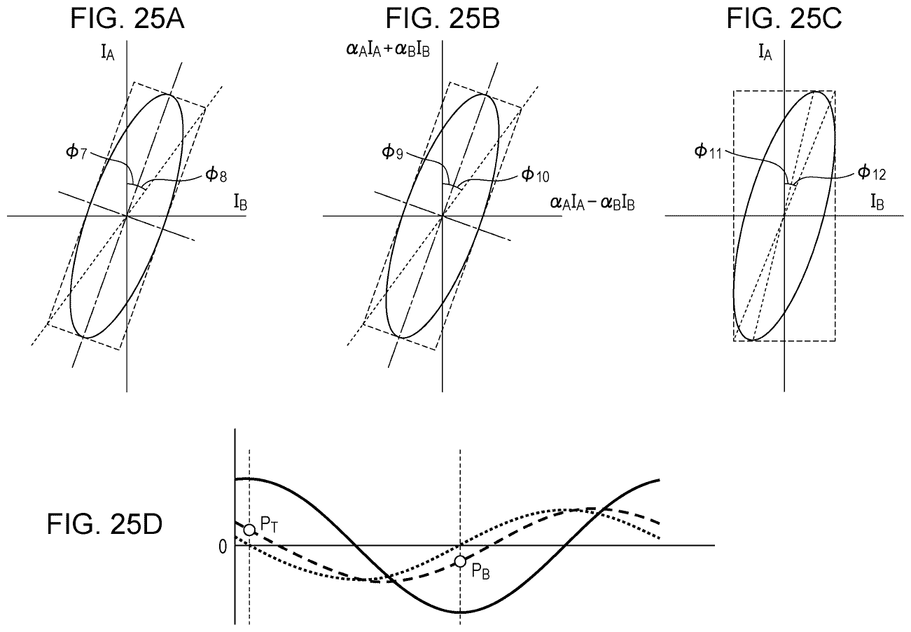

FIGS. 25A and 25B are diagrams explaining the first example of the second vibration component detection according to the second embodiment, and are diagrams illustrating an example of a Lissajous waveform (vibration ellipse) used for the second vibration component detection. FIG. 25A illustrates a Lissajous waveform (vibration ellipse) drawn with the vertical axis as a current signal I_{A} and the horizontal axis as a current signal I_{B}. The current signal I_{A} has a vibration waveform of the stretching vibration mode (push-up vibration mode) of the vibrating body 405, the current signal I_{B} has a vibration waveform of the torsional vibration mode (feed vibration mode) of the vibrating body 405, and φ₇ indicates an inclination angle of the vibration ellipse.

Here, when the current signal I_{A} is expressed by Equation 28 and the current signal I_{B} is expressed by Equation 29,

$${I}_{A} = ρ sin ( ω t + {δ}_{1} ) \qquad Equation 28$$

$${I}_{B} = σ sin ( ω t + {δ}_{2} ) \qquad Equation 29$$

the inclination angle φ₇ of the vibration ellipse is expressed by Equation 30.

$${φ}_{7} = \frac{1}{2} {tan}^{- 1} ( \frac{2 ρσ cos ( {δ}_{1} - {δ}_{2} )}{{ρ}^{2} - {σ}^{2}} ) \qquad Equation 30$$

The second vibration component detection unit 16 detects an amplitude p of the current signal I_{A}, an amplitude σ of the current signal I_{B}, and a phase difference (δ₁−δ₂) between the current signal I_{A} and the current signal I_{B}, and substitutes the detected values into Equation 30 to obtain the second vibration component (the inclination angle of the vibration ellipse).

Next, generation of a superimposition voltage in the second embodiment will be described.

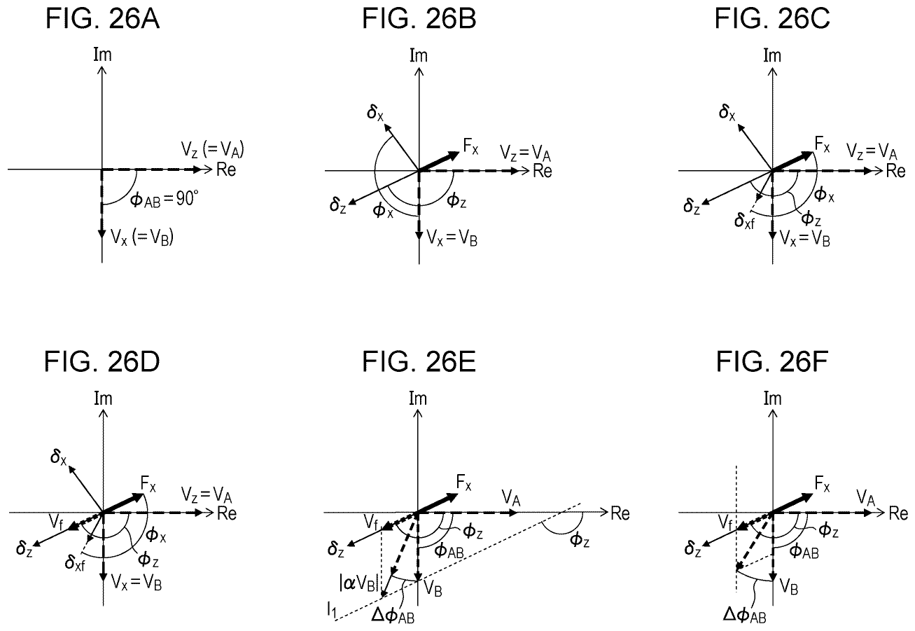

FIGS. 26A to 26F are complex plane diagrams expressing applied voltages, excitation forces, and vibration responses of the vibration type actuator of the second embodiment of the present disclosure, and a superimposition voltage for canceling a friction excitation force and a method of generating the superimposition voltage.

FIG. 26A is a diagram illustrating voltages that are applied to the piezoelectric bodies. Voltages V_{A} and V_{B} are applied voltages to the piezoelectric body 403 and the piezoelectric body 404, respectively, and act as a push-up vibration excitation voltage V_{z} and a feed vibration excitation voltage Vₓ in the present embodiment. FIG. 26B is a diagram illustrating mechanical response displacements δ_{z} and δₓ to the voltages V_{A} and V_{B}. The response displacement δ_{z} of the push-up vibration is generated with a delay of a phase φ_{z} using the push-up vibration excitation voltage V_{z} as an excitation force. Similarly, a response displacement δₓ of the feed vibration is generated with a phase delay of a phase φₓ using the feed vibration excitation voltage Vₓ as an excitation force. Here, the phase φ_{z} and the phase φₓ are values different from each other and each are 90° or more. This is because the vibrating body has the different natural frequencies for the push-up vibration and the feed vibration, and the responses are obtained when the alternating voltages having the frequency higher than the natural frequencies are applied. The values of these phases change in accordance with the magnitude relationship between the two natural frequencies and the frequency of the alternating voltages to be applied, and hence the values of these phases are not limited thereto. In the present embodiment, the response displacements δ_{z} and δₓ have a time phase of about 90°, and form the vibration that draws the above-described elliptical vibration locus.

When the contact body is brought into contact with the vibrating body, the feed vibration displacement relatively drives the contact body in the positive direction. At this time, the contact pressure with the contact body becomes the maximum in the time domain where the response displacement δ_{z} of the push-up vibration becomes the maximum, that is, in the phase φ_{z}. Further, when an external force acts in the direction in which the relative driving of the contact body is suppressed, and a thrust is exerted in the direction of the relative driving, a friction excitation force Fₓ, which becomes the maximum force in the time domain centered on the time phase φ_{z} where the contact pressure becomes the maximum, acts. This friction force is synchronized with the time phase φ_{z} and becomes a harmonic excitation force of the feed direction vibration in the phase opposite to that of the feed direction excitation force caused by the voltage, so that it is expressed as a vector Fₓ in the opposite direction in the phase oz of the response displacement δ_{z} as illustrated in FIG. 26C. A friction response displacement δ_{xf}, which is a response displacement of the vibrating body caused by the friction excitation force Fₓ, is generated as a feed vibration displacement having the phase delay φₓ (the phase is inverted because the sign is opposite). The friction response displacement δ_{xf} is a main element of the second vibration component, and the friction response displacement δ_{xf} having a different time phase is added to the feed vibration displacement δₓ generated as a response to the applied voltage, which causes the inclination of the vibration ellipse or the like. The friction excitation force Fₓ is a parameter directly corresponding to the speed of the vibration type actuator, but cannot be directly detected.

As illustrated in FIG. 26D, control of decreasing the second vibration component δ_{xf} is performed by superimposing a piezoelectric excitation force V_{f} having the same phase as that of the friction excitation force Fₓ and the sign opposite to that of the friction excitation force Fₓ on the voltages that are applied to the piezoelectric bodies. When the piezoelectric excitation force V_{f} becomes a superimposition voltage for canceling the second vibration component, V_{f} becomes equal to or a value approximate to Fₓ, and hence the speed of the vibration type actuator can be estimated based on superimposition voltage=piezoelectric excitation force V_{f}.

A method of generating the superimposition voltage component V_{f} from the drive voltages V_{A} and V_{B} will be described with reference to FIG. 26E. Since the push-up vibration displacement δ_{z} has a vibration speed proportional to the current signal I_{A}, the phase φ_{z} can be detected by detecting the time point of zero crossing at which the current signal I_{A} is inverted from the sign of the direction in which the vibrating body comes into contact with the contact body, with reference to the voltage signal. It is assumed that α denotes a rate of the amount of extension to the intersecting point of a straight line 11 passing through the tip of the vector V_{B} on the complex plane and forming the phase difference φ_{z} with the real axis, and the voltage vector V_{B} delayed by a phase difference Δφ_{AB}. Then, the voltage V_{B} is multiplied by (1+α) and delayed by Δφ_{AB}, whereby the superimposition piezoelectric excitation force V_{f} for canceling the friction excitation force can be generated. Here, α may be used as a superimposition voltage coefficient, or the delay phase Δφ_{AB} may be used. The speed is estimated based on the coefficient α or the delay phase Δφ_{AB} obtained by performing the control of minimizing and canceling the detection value of the second vibration component.

Alternatively, the friction excitation force Fₓ may be canceled by giving only the delay phase Δφ_{AB} without operating the magnitude of the voltage V_{B}. In this case, as illustrated in FIG. 26F, the φ_{z} direction component obtained by delaying the voltage vector V_{B} by the phase Δφ_{AB} is the superimposition voltage component. The feed vibration excitation component having a phase of 90° with respect to V_{A} decreases, but the decrease in the feed speed or the thrust due to this decrease is compensated for by additionally performing speed control or thrust control using the magnitude of the voltage V_{B} as a variable, and the state in FIG. 26F is obtained.

As described above, in the present embodiment, the inclination angle of the vibration ellipse is used as the detection value of the second vibration component, and the control of decreasing the second vibration component is performed with the superimposition voltage component generated by operating the phase and the amplitude of the voltage V_{B}. The superimposition voltage coefficient α or the phase Δφ_{AB} obtained thereby is used as a numerical value corresponding to the friction excitation force to obtain a detection value. In the following description, the phase Δφ_{AB} is also expressed as the superimposition voltage coefficient α.

The width (the length of the minor axis) of the vibration ellipse also changes by the superimposition of the second vibration component. Thus, with regard to the influence of this, a value obtained by adding both the inclination angle φ₇ of the vibration ellipse and an angle φ₈ formed by the diagonal line of the circumscribing rectangle of the vibration ellipse and the center line of the vibration ellipse at a predetermined ratio may be the second vibration component S.

Alternatively, Equation 31 obtained by extracting only a changing portion of Equation 30 may be the second vibration component S, or the result obtained by further substituting Equation 31 into any function may be the second vibration component S.

$$S = \frac{2 ρσ cos ( {δ}_{1} - {δ}_{2} )}{{ρ}^{2} - {σ}^{2}} \qquad Equation 31$$

In the above example, the vertical axis of the Lissajous waveform (vibration ellipse) is the current signal I_{A}, and the horizontal axis is the current signal I_{B}. However, the slope of the vibration ellipse may be obtained with the vertical axis as (current signal I_{A}+current signal I_{B}) and the horizontal axis as (current signal I_{A}−current signal I_{B}). FIG. 25B illustrates a Lissajous waveform (vibration ellipse) using signals obtained by multiplying the current signal I_{A} and the current signal I_{B} by coefficients α_{A} and α_{B}, respectively, and drawn with the vertical axis as the sum signal of these signals and the horizontal axis as the difference signal of these signals.

In this case, an inclination angle φ₉ of the vibration ellipse is expressed by Equation 32, and the angle φ₉ can be the second vibration component S.

$${φ}_{9} = \frac{1}{2} {tan}^{- 1} ( \frac{{σ}^{2} - {ρ}^{2}}{2 ρσ cos ( {δ}_{1} - {δ}_{2} )} ) \qquad Equation 32$$

An angle φ₁₀ may be obtained as in the above example, and a value obtained by adding both the inclination angle φ₉ and the angle φ₁₀ at a predetermined ratio may be the second vibration component S. Alternatively, Equation 33 obtained by extracting only a changing portion of the equation may be the second vibration component S, or the result obtained by further substituting Equation 33 into any function may be the second vibration component S.

$$S = \frac{{σ}^{2} - {ρ}^{2}}{2 ρσ cos ( {δ}_{1} - {δ}_{2} )} \qquad Equation 33$$

Next, a second example of the second vibration component detection according to the second embodiment will be described.

In the first example of the second vibration component detection according to the second embodiment, the inclination angle of the vibration ellipse is obtained by Equation 30. However, the inclination angle may be obtained by using another parameter of the vibration ellipse that changes in accordance with the inclination angle of the vibration ellipse. FIGS. 25C and 25D are diagrams explaining the second example of the second vibration component detection according to the second embodiment. FIG. 25C is a diagram explaining an example of detecting the second vibration component by using an angle φ₁₁ that changes in accordance with the inclination angle of the vibration ellipse. In the first example of the second vibration component detection according to the second embodiment, the slope of the axis of the vibration ellipse is used. However, a complicated calculation as in Equation 30 is necessary to obtain the slope. The angle Qui that is detected in this example can be directly detected from the current signal I_{A} and the current signal I_{B}. The angle on is an angle between the line connecting the positive and negative peaks of the current signal I_{A} and the vertical axis. FIG. 25D is a diagram for explaining a method of detecting the angle φ₁₁. In FIG. 25D, the solid line indicates the current signal I_{A}, the dotted line indicates a differential waveform of the solid line, and the broken line indicates a waveform of the current signal I_{B}. The angle φ₁₁ is obtained by sampling the signal indicated by the broken line at the time point of the peak of the current signal I_{B} to detect the values of P_{T} and P_{B}, and by using Equation 34. The time points of detecting P_{T} and P_{B} may be the time points of zero crossing of the differential waveform of the current signal I_{A}.

$${φ}_{11} = {tan}^{- 1} ( \frac{ampl itude of {I}_{B} \times 2}{{P}_{T} - {P}_{B}} ) \qquad Equation 34$$

The second vibration component detection unit 16 obtains the second vibration component (angle φ₁₁) as described above.

Alternatively, Equation 35 or Equation 36 may be the second vibration component S.

$$S = \frac{{P}_{T} - {P}_{B}}{amplitude of {I}_{B}} \qquad Equation 35$$

$$S = {P}_{T} - {P}_{B} \qquad Equation 36$$

As in the first example of the second vibration component detection according to the second embodiment, not only the inclination angle but also the width (the length of the minor axis) of the vibration ellipse change by the superimposition of the second vibration component. Thus, a value obtained by adding both an angle φ₁₂, which is formed by the diagonal line of the circumscribing rectangle of the vibration ellipse illustrated in FIG. 25C and the straight line indicating the angle φ₁₁, and the angle φ₁₁ at a predetermined ratio may be the second vibration component S.

Next, a third example of the second vibration component detection according to the second embodiment will be described below.

In the first and second examples of the second vibration component detection according to the second embodiment, the second vibration component is extracted from the shape of the vibration ellipse. However, the second vibration component can be obtained directly from the amplitudes of the currents. The second vibration component detection unit 16 of this example receives the current signal I_{A} and the current signal I_{B} and obtains the amplitudes of (current signal I_{A}+current signal I_{B}) and (current signal I_{A}−current signal I_{B}). Then, (amplitude of (current signal I_{A}+current signal I_{B})−(amplitude of (current signal I_{A}−current signal I_{B})) is calculated and used as the second vibration component S. In the above calculation, the current signal I_{A} and the current signal I_{B} are directly added and subtracted, but may be multiplied by different coefficients α_{A} and α_{B} and then added and subtracted. This is because the stretching vibration, which is the push-up vibration, and the torsional vibration, which is the feed vibration, are vibrations excited using completely different phenomena. That is, the stretching vibration is a vibration using the longitudinal effect or the transversal effect of the piezoelectric bodies, whereas the torsional vibration is a vibration using the thickness shear effect of the piezoelectric bodies. Thus, the current signal I_{A} and the current signal I_{B} are multiplied by the coefficients α_{A} and α_{B}, respectively, to adjust the sensitivities of the currents to the vibrations. Alternatively, a value obtained by dividing the above calculation result by the amplitude of the current signal I_{A} may be the second vibration component S.

In the following description, the description will be made based on that a signal obtained by multiplying the current signal I_{A} by the coefficient α_{A} is a current signal CAIA and a signal obtained by multiplying the current signal I_{B} by the coefficient ap is a current signal αBIB.

Next, a fourth example of the second vibration component detection according to the second embodiment will be described below.

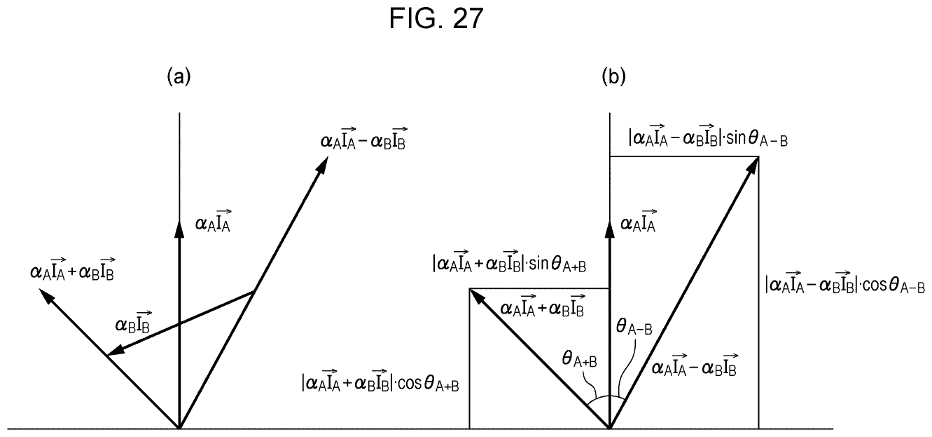

This example is an example of detection in a case where the current signals are represented as vectors. FIG. 27 provides vector diagrams of the current signals. FIG. 27(a) is a diagram illustrating the current signal GAIA, the current signal α_{B}I_{B}, and the sum and difference signals of the current signals α_{A}I_{A} and α_{B}I_{B} in the form of vectors. The second vibration component S presented in the third example of the second vibration component according to the second embodiment can be expressed by Equation 37 and Equation 38.

$$S = \vert {a}_{A} \vec{{I}_{A}} + {a}_{B} \vec{{I}_{B}} \vert - \vert {a}_{A} \vec{{I}_{A}} - {a}_{B} \vec{{I}_{B}} \vert \qquad Equation 37$$

$$S = \frac{\vert {a}_{A} \vec{{I}_{A}} + {a}_{B} \vec{{I}_{B}} \vert - \vert {a}_{A} \vec{{I}_{A}} - {a}_{B} \vec{{I}_{B}} \vert}{\vert {a}_{A} \vec{{I}_{A}} \vert} \qquad Equation 38$$

FIG. 27(b) is a diagram illustrating vectors of (current signal α_{A}I_{A}+current signal BIB) and (current signal α_{A}I_{A}−current signal α_{B}I_{B}) that are decomposed into components in the same direction and the normal direction of the vector of the current signal αAIA, which is the push-up vibration component. The difference between the components in the same direction as the vector of the current signal αAIA of the vectors of (current signal α_{A}I_{A}+current signal α_{B}I_{B}) and (current signal α_{A}I_{A}−current signal α_{B}I_{B}) has a high correlation with the slope of the vibration ellipse, and the values expressed by Equation 39 and Equation 40 can be the second vibration component S.

$$S = \vert {a}_{A} \vec{{I}_{A}} + {a}_{B} \vec{{I}_{B}} \vert \cdot cos {θ}_{A + B} - \vert {a}_{A} \vec{{I}_{A}} - {a}_{B} \vec{{I}_{B}} \vert \cdot cos {θ}_{A - B} \qquad Equation 39$$

$$S = \frac{\vert {a}_{A} \vec{{I}_{A}} + {a}_{B} \vec{{I}_{B}} \vert \cdot cos {θ}_{A + B} - \vert {a}_{A} \vec{{I}_{A}} - {a}_{B} \vec{{I}_{B}} \vert \cdot cos {θ}_{A - B}}{\vert {a}_{A} \vec{{I}_{A}} \vert} \qquad Equation 40$$

Alternatively, the components in the normal direction of the vector of the current signal α_{A}I_{A} may also be detected and added to Equation 39 or Equation 40 at a predetermined ratio (x:y) to obtain the second vibration component S. This is expressed by Equation 41 and Equation 42.

$$S = x ( \vert {a}_{A} \vec{{I}_{A}} + {a}_{B} \vec{{I}_{B}} \vert \cdot cos {θ}_{A + B} - \vert {a}_{A} \vec{{I}_{A}} - {a}_{B} \vec{{I}_{B}} \vert \cdot cos {θ}_{A - B} ) + y ( \vert {a}_{A} \vec{{I}_{A}} + {a}_{B} \vec{{I}_{B}} \vert \cdot sin {θ}_{A + B} - \vert {a}_{A} \vec{{I}_{A}} - {a}_{B} \vec{{I}_{B}} \vert \cdot sin {θ}_{A - B} ) \qquad Equation 41$$

$$S = \frac{\begin{matrix}x ( \vert {a}_{A} \vec{{I}_{A}} + {a}_{B} \vec{{I}_{B}} \vert \cdot cos {θ}_{A + B} - \vert {a}_{A} \vec{{I}_{A}} - {a}_{B} \vec{{I}_{B}} \vert \cdot cos {θ}_{A - B} ) + \\ y ( \vert {a}_{A} \vec{{I}_{A}} + {a}_{B} \vec{{I}_{B}} \vert \cdot sin {θ}_{A + B} - \vert {a}_{A} \vec{{I}_{A}} - {a}_{B} \vec{{I}_{B}} \vert \cdot sin {θ}_{A - B} )\end{matrix}}{\vert {a}_{A} \vec{{I}_{A}} \vert} \qquad Equation 42$$

Here, a method of obtaining the second vibration component S of Equation 39 to Equation 42 will be described. The equations from Equation 39 to Equation 42 are calculations including trigonometric functions, and detection of a phase difference is also necessary. Accordingly, the structure of the second vibration component detection unit 16 becomes complicated. Thus, an example of using synchronous detection instead of these calculations and the detection of the phase difference will be described.

A method of detecting the second vibration component S using synchronous detection will be described below.

That is, one of the sum signal and the difference signal of the first detection signal and the second detection signal is defined as a reference signal, the other one of the sum signal and the difference signal is defined as a measurement object signal, and the phase of the reference signal is defined as a reference phase. A signal corresponding to the second vibration component is detected by interval integration performed on the measurement object signal in a phase interval set relative to the reference phase.

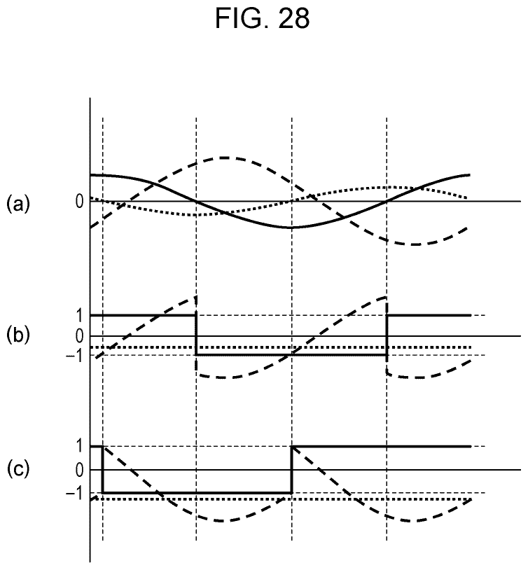

FIG. 28 provides diagrams explaining a method of obtaining the magnitude of each direction component by synchronous detection. FIG. 28(a) illustrates a waveform (solid line) of the current signal GAIA as a reference, a signal waveform (broken line) whose component is to be decomposed, and a differential waveform (dotted line) of the current signal αAIA. FIG. 28(b) illustrates a state in which a component in the same direction as the vector of the current signal αAIA is detected. FIG. 28(c) illustrates a state in which a component in the normal direction of the vector of the current signal GAIA is detected.

The solid line in FIG. 28(b) indicates a referential signal that becomes 1 when the sign of the solid line in FIG. 28(a) is positive and becomes −1 when the sign is negative. The broken line in FIG. 28(b) indicates the multiplication result of the signal of the broken line in FIG. 28(a) and the referential signal. The dotted line in FIG. 28(b) indicates the average value of the multiplication results, and indicates the magnitude of the vibration component in the same direction as the vector of the current signal α_{A}I_{A}.

The solid line in FIG. 28(c) indicates a referential signal that becomes 1 when the sign of the dotted line in FIG. 28(a) is positive and becomes −1 when the sign is negative. The broken line in FIG. 28(c) indicates the multiplication result of the signal of the broken line in FIG. 28(a) and the referential signal. The dotted line in FIG. 28(c) indicates the average value of the multiplication results, and indicates the magnitude of the vibration component in the normal direction of the vector of the current signal αAIA.

Next, a fifth example of the second vibration component detection according to the second embodiment will be described below.

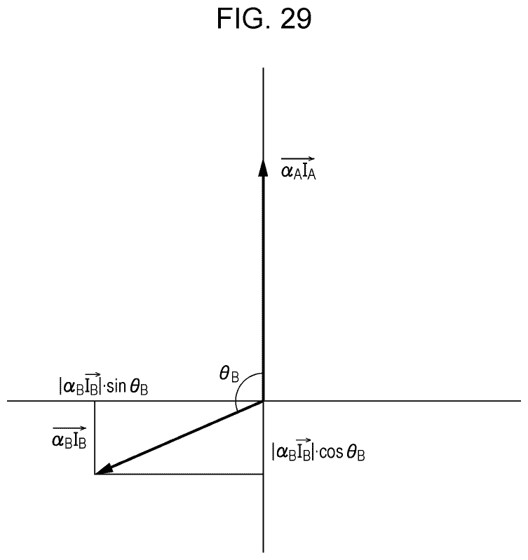

In the fifth example of the second vibration component according to the second embodiment, the second vibration component is detected by using the vector of the current signal α_{B}I_{B}. FIG. 29 is a diagram illustrating the relationship between the vector of the current signal α_{A}I_{A} and the vector of the current signal α_{B}I_{B}. As in the fourth example of the second vibration component according to the second embodiment, the second vibration component is included by a large amount in the component in the same direction as the vector of the current signal α_{A}I_{A}. The second vibration component S of the present embodiment is expressed by Equation 43 and Equation 44.

$$S = \vert {a}_{B} \vec{{I}_{B}} \vert \cdot cos {θ}_{B} \qquad Equation 43$$

$$S = \frac{\vert {a}_{B} \vec{{I}_{B}} \vert \cdot cos {θ}_{B}}{\vert {a}_{A} \vec{{I}_{A}} \vert} \qquad Equation 44$$

Alternatively, the component in the normal direction of the vector of the current signal α_{A}I_{A} may also be detected and added to Equation 43 or Equation 44 at a predetermined ratio (x:y) to obtain the second vibration component S. This is expressed by Equation 45 and Equation 46.

$$S = x ( \vert {a}_{B} \vec{{I}_{B}} \vert \cdot cos {θ}_{B} ) + y ( \vert {a}_{B} \vec{{I}_{B}} \vert \cdot sin {θ}_{B} ) \qquad Equation 45$$

$$S = \frac{x ( \vert {a}_{B} \vec{{I}_{B}} \vert \cdot cos {θ}_{B} ) + y ( \vert {a}_{B} \vec{{I}_{B}} \vert \cdot sin {θ}_{B} )}{\vert {a}_{A} \vec{{I}_{A}} \vert} \qquad Equation 46$$

Here, a method of obtaining the second vibration component S of Equation 43 to Equation 46 will be described. As in the fourth example of the second vibration component according to the second embodiment, the calculations may be performed by using Equation 43 to Equation 46, but the second vibration component S can also be obtained by using synchronous detection.

Next, a sixth example of the second vibration component detection according to the second embodiment will be described.

In the above example, the detection method of the second vibration component S corresponding to the Lissajous diagram or the vector indication has been described. In this example, a method of detecting the second vibration component S by synchronous detection from a waveform on a time axis will be described. In the above example, the vibration component in the same direction as the push-up direction is obtained by using synchronous detection. However, in this example, the output of synchronous detection is directly output as the second vibration component S.

The second vibration component is a vibration component that is excited by the contact between the vibrating body 405 and the contact body 406 (rotor), is generated in the vibrating body 405 as a response to the excitation, and is superimposed on the first vibration component. Thus, the second vibration component is generated on the vibrating body 405 with a constant phase delay from the time point of the contact as a starting point. The time point serving as the starting point is a time point at which the displacement has reached the peak of the vibration in the stretching vibration mode (push-up vibration mode) of the vibrating body 405. The generated vibration is superimposed on the first vibration component with a phase delay that differs for each vibration mode in accordance with the excitation frequency. The vibration caused by the friction force acting in the relative movement direction between the vibrating body 405 and the contact body 406 (rotor) is mainly generated in the torsional vibration mode (feed vibration mode) of the vibrating body 405. Then, the vibration is superimposed on the vibration of the torsional vibration mode (feed vibration mode) of the first vibration component with a phase delay θₛ corresponding to the response characteristics of the feed vibration mode.

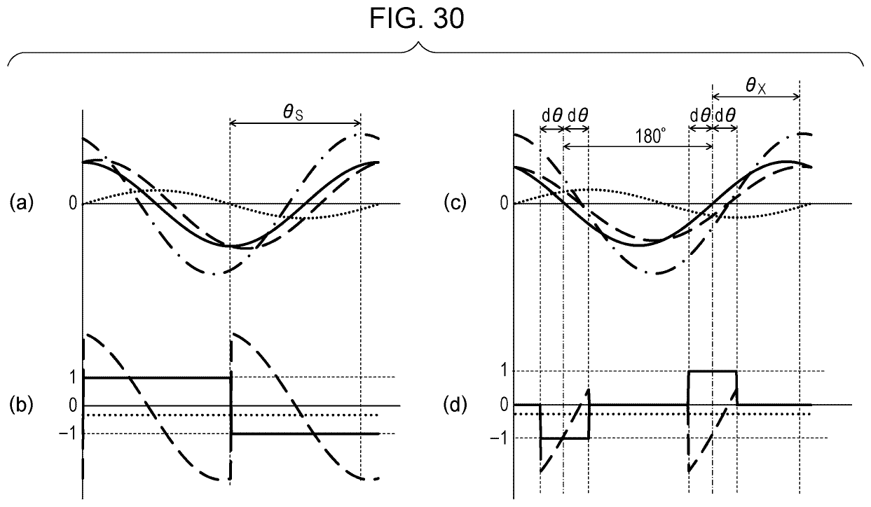

FIGS. 30(a) and 30(b) are diagrams explaining the sixth example of the second vibration component detection according to the second embodiment, and are diagrams for explaining an operation of synchronous detection. FIG. 30(a) illustrates a waveform (solid line) of the current signal I_{B} at the time of no load, a superimposition vibration waveform (dotted line) that is superimposed on the waveform at the time of no load, a waveform (broken line) of the current signal I_{B} on which the superimposition vibration waveform (dotted line) has been superimposed, and a waveform (one-dot chain line) of the current signal I_{A}. FIG. 30(b) is a diagram illustrating a state in which a superimposition vibration waveform component is detected by synchronous detection.

The solid line in FIG. 30(b) indicates a referential signal that becomes 1 when the sign of the superimposition vibration waveform (dotted line) in FIG. 30(a) is positive and becomes −1 when the sign is negative. The broken line in FIG. 30(b) indicates the multiplication result of the signal of the broken line in FIG. 30(a) and the referential signal. The dotted line in FIG. 30(b) indicates the average value of the multiplication results. This value changes in accordance with the amplitude of the superimposition vibration waveform (dotted line) in FIG. 30(a).

Here, the superimposition vibration waveform (dotted line) in FIG. 30(a) is a vibration component generated in the vibrating body 405 when the vibrating body 405 receives excitation from the contact body 406 (rotor), and is superimposed on the vibration at the time of no load. Hence it is difficult to directly detect the superimposed vibration waveform. However, since the phase of the superimposition vibration waveform is delayed only by the phase θₛ from the phase of the peak of the waveform (one-dot chain line) of the current signal I_{A} in FIG. 30(a), the referential signal (solid line) in FIG. 30(b) can be generated by using this relationship as long as θₛ is figured out. The second vibration component detection unit 16 selects θₛ in correspondence with the drive state, performs synchronous detection, and outputs the obtained average value. Alternatively, a value obtained by dividing the value obtained by synchronous detection by the amplitude of the current signal I_{A} may be the second vibration component S.

The value of θₛ can be obtained in advance by measurement according to the state of the amplitude of the current signal I_{A}, the voltage amplitude of the alternating signal V_{B}, or the like, and can be prepared as a data table or a function.

In this example, the referential signal is a pulse signal, but may have another waveform such as a sine wave.

Next, a seventh example of the second vibration component detection according to the second embodiment will be described.

FIGS. 30(c) and 30(d) are diagrams explaining the seventh example of the second vibration component detection according to the second embodiment. FIG. 30(c) illustrates a waveform (solid line) of the current signal I_{B} at the time of no load, a superimposition vibration waveform (dotted line) that is superimposed on this waveform, a waveform (broken line) of the current signal I_{B} on which the superimposition vibration waveform (dotted line) has been superimposed, and a waveform (one-dot chain line) of the current signal I_{A}. FIG. 30(d) is a diagram illustrating a state in which the superimposition vibration waveform component is detected by integrating the waveform (broken line) of the current signal I_{B} on which the superimposition vibration waveform (dotted line) has been superimposed in a predetermined phase interval.

The solid line in FIG. 30(d) indicates a gate signal in which a phase interval (0°±dθ) centered on the phase 0° of the waveform (solid line) of the current signal I_{B} at the time of no load in FIG. 30(c) is −1, a phase interval (180°±dθ) centered on the phase 180° is 1, and the other phase intervals are 0. The broken line in FIG. 30(d) is the multiplication result of the signal of the broken line in FIG. 30(c) and this gate signal. The dotted line in FIG. 30(d) indicates the average value of the multiplication results. This value changes in accordance with the amplitude of the superimposition vibration waveform (dotted line) in FIG. 30(c).

Here, the waveform (solid line) of the current signal I_{B} at the time of no load in FIG. 30(c) can be detected only at the time of no load. Thus, a phase difference θ_{X} between the waveform (solid line) of the current signal I_{B} at the time of no load and the waveform (one-dot chain line) of the current signal I_{A} in FIG. 30(c) is set in advance as a data table in accordance with various vibration states. For example, the phase difference Ox can be set in accordance with the state such as the amplitude of the current signal I_{A} or the voltage amplitude of the alternating signal V_{B}.

The second vibration component detection unit 16 may output the value of the dotted line in FIG. 30(d) as the second vibration component S without change, or may divide the value by the amplitude of the current signal I_{A} to obtain the second vibration component S.

Next, an eighth example of the second vibration component detection according to the second embodiment will be described.

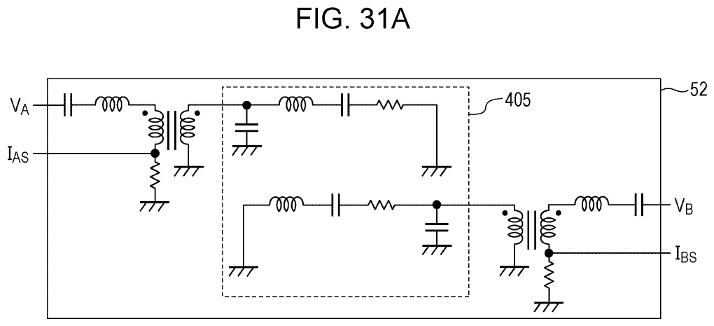

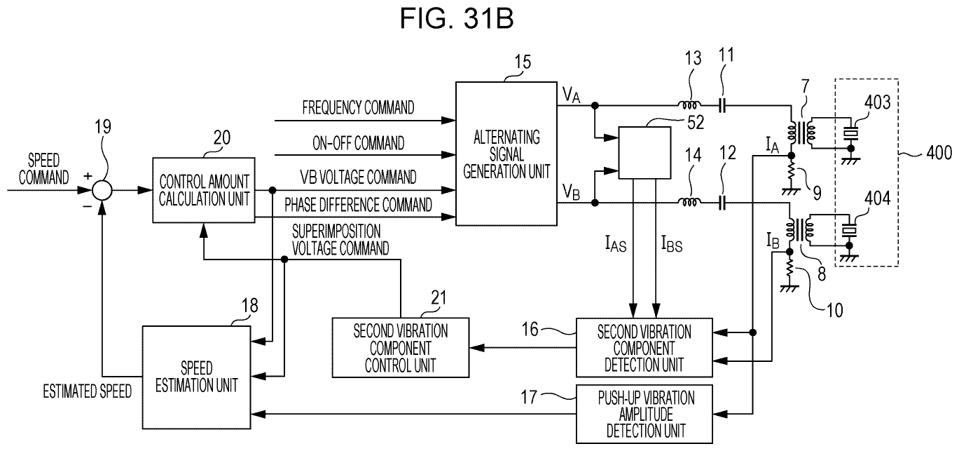

In this example, a superimposition vibration waveform is extracted by generating a current signal I_{B} at the time of no load for an alternating signal V_{A} and an alternating signal V_{B} using an equivalent circuit model of a vibrating body 405 and the driving circuit, and by subtracting the generated current signal I_{B} from an actually measured current signal I_{B}. FIG. 31A illustrates a circuit example of the equivalent circuit model. A filter 52 simulates an operation of the equivalent circuit of the vibrating body 405 and the driving circuit at the time of no load. The circuit diagram in the block illustrates series resonance circuits composed of inductors 13 and 14 and capacitors 11 and 12. The circuit diagram in the block includes transformers 7 and 8, an equivalent circuit of the vibrating body 405 including a piezoelectric body 403 and a piezoelectric body 404, and resistors 9 and 10 for current detection, and the operations of these components are simulated by calculations. When the waveforms of the alternating signal V_{A} and the alternating signal V_{B} are input to the filter 52, the filter 52 outputs a current signal I_{AS} simulating the current signal I_{A} and a current signal I_{BS} simulating the current signal I_{B} in real time.

FIG. 31B is a diagram illustrating a second configuration example of the driving device for the vibration type actuator 400 according to the second embodiment of the present disclosure, and illustrates an example in which the second vibration component is detected by using the filter 52. The same reference signs are given to components similar to those illustrated in FIG. 2, and the detailed description thereof will be omitted. The alternating signal V_{A} and the alternating signal V_{B} output from an alternating signal generation unit 15 are input to the filter 52. The filter 52 outputs the current signal I_{AS} (first comparison signal) simulating the current signal I_{A} at the time of no load and the current signal I_{BS} (second comparison signal) simulating the current signal I_{B} at the time of no load. A second vibration component detection unit 16 receives the current signals I_{A} and I_{B} and the current signals I_{AS} and I_{BS}, and detects an amplitude SF of the superimposition vibration waveform from the difference between the current signal I_{B} (second detection signal) and the current signal I_{BS} (second comparison signal).

Then, as expressed by Equation 47, the sign of a phase difference θ_{SA} between the superimposition vibration waveform and the current signal I_{A} is defined as the sign of the amplitude SF of the superimposition vibration waveform. The amplitude SF is output as the second vibration component S.

$$S = Sign ( {θ}_{SA} ) \cdot SF \qquad Equation 47$$

There is also another method of obtaining the second vibration component S. For example, signals obtained by multiplying the current signal I_{A} and the current signal I_{AS} by a coefficient α_{A} are defined as a current signal α_{A}I_{A} and a current signal α_{A}I_{AS}, and signals obtained by multiplying the current signal I_{B} and the current signal I_{BS} by a coefficient ap are defined as a current signal α_{B}I_{B} and a current signal α_{B}I_{BS}. Then, the difference in amplitude between the signal of the difference between (current signal α_{A}I_{A}+current signal α_{B}I_{B}) and (current signal α_{A}I_{AS}+current signal α_{B}I_{BS}), and the signal of the difference between (current signal α_{A}I_{A}−current signal α_{B}I_{B}) and (current signal CAIAS−current signal α_{B}I_{BS}) can also be the second vibration component S. This is expressed by vectors as expressed by Equation 48.

$$S = \vert ( {a}_{A} \vec{{I}_{A}} + {a}_{B} \vec{{I}_{B}} ) - ( {a}_{A} \vec{{I}_{AS}} + {a}_{B} \vec{{I}_{BS}} ) \vert - \vert ( {a}_{A} \vec{{I}_{A}} - {a}_{B} \vec{{I}_{B}} ) - ( {a}_{A} \vec{{I}_{AS}} - {a}_{B} \vec{{I}_{BS}} ) \vert \qquad Equation 48$$

The output of the filter 52 does not have to be an analog signal. For example, digital waveform information or waveform information of such as an amplitude and a phase may be used.

Next, an operation of a speed estimation unit 18 will be described.

Equation 49 is an equation for estimating a speed V_{S} from the value of the superimposition voltage coefficient α when the value of the superimposition voltage coefficient α changes linearly.

$${V}_{S} = \frac{α - ε}{γ} \qquad Equation 49$$

In this way, when the value of the superimposition voltage coefficient α changes linearly with respect to the speed, the speed can be estimated by a simple equation by using correction coefficients of an offset and a sensitivity for each push-up amplitude and each voltage amplitude of the alternating signal V_{B} obtained in advance. The characteristics of a sensitivity correction coefficient γ and an offset correction coefficient ε may be stored in a data table, or may be stored as functions T₅ and T₆ of the push-up vibration amplitude and the voltage amplitude of the alternating signal V_{B}. Equation 50 expresses the function T₅ of the offset correction coefficient ε, and Equation 51 expresses the function T₆ of the sensitivity correction coefficient γ.

$$ε = {T}_{5} ( VB voltage amplitude , push - up vibration amplitude ) \qquad Equation 50$$

$$γ = {T}_{6} ( VB voltage amplitude , push - up vibration amplitude ) \qquad Equation 51$$

Alternatively, for the sensitivity correction coefficient γ and the offset correction coefficient ε, the frequency of the alternating signal V_{A} and the alternating signal V_{B} may be used instead of the push-up vibration amplitude. In this case, the sensitivity correction coefficient γ and the offset correction coefficient ε are obtained from the frequency of the alternating signal V_{A} and the alternating signal V_{B} during driving and the voltage amplitude of the alternating signal V_{B} using a data table or functions T₇ and T₈. Equation 52 expresses the function T₇ of the offset correction coefficient ε, and Equation 53 expresses the function T₈ of the sensitivity correction coefficient γ.

$$ε = {T}_{7} ( VB voltage amplitude , frequency ) \qquad Equation 52$$

$$γ = {T}_{8} ( VB voltage amplitude , frequency ) \qquad Equation 53$$

In the above description, the speed is defined as the linear expression of the superimposition voltage coefficient α, and the speed is estimated by using the offset correction coefficient ε and the sensitivity correction coefficient γ, for example. However, the relationship with the speed may be defined by using polynomial approximation, trigonometric functions, or the like. In this case, the coefficient of each term is a function having a plurality of arguments such as T₅ to T₈ described above.

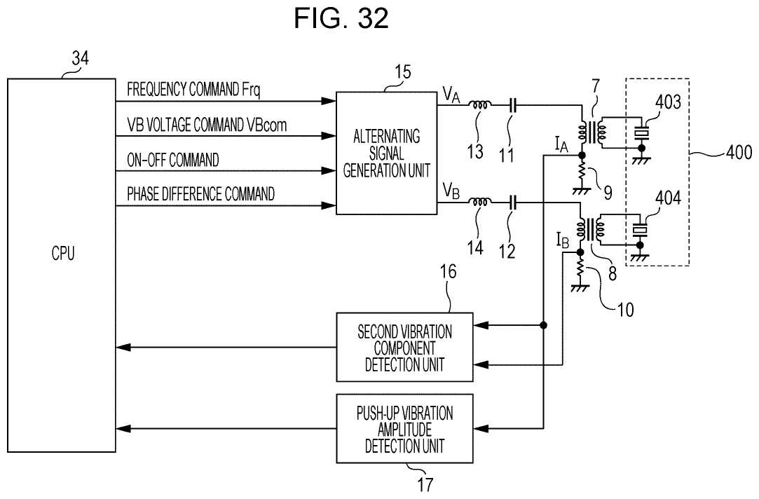

FIG. 32 is a diagram illustrating a third configuration example of the driving device for the vibration type actuator 400 according to the second embodiment of the present disclosure. FIG. 32 illustrates an example in which the speed estimation unit and the portion that performs the speed control of the driving device illustrated in FIG. 24 are implemented by a known CPU 34. The same reference signs are given to components similar to those illustrated in FIG. 24, and the detailed description thereof will be omitted.

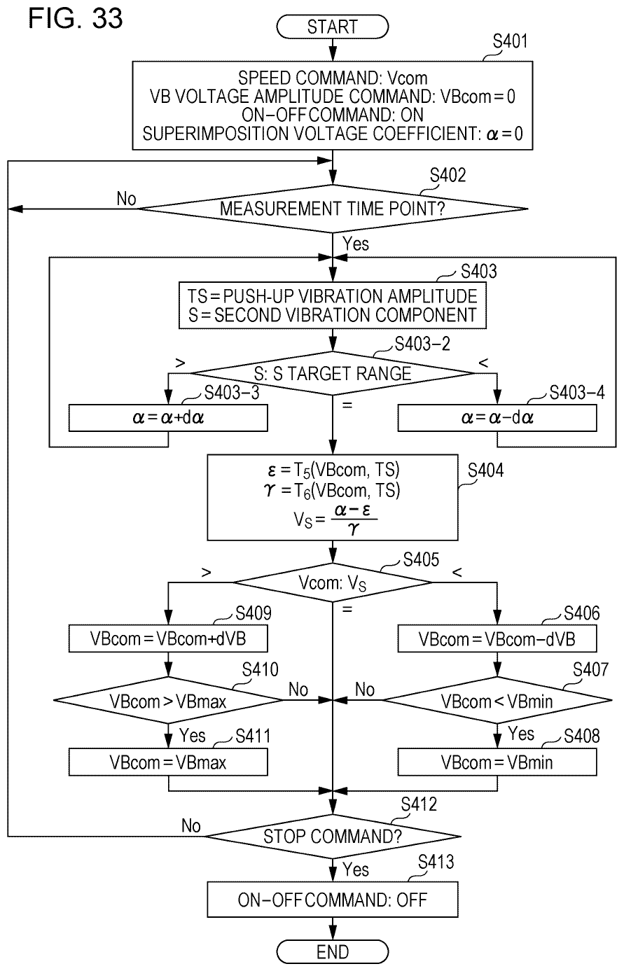

FIG. 33 is a flowchart presenting an operation of the CPU 34, and presents control steps of controlling the speed using the V_{B} voltage amplitude. The control steps of the frequency command are the same as those in the first embodiment, and hence the description thereof is omitted.

First, in step S401, the CPU 34 sets a predetermined speed command Vcom, sets a V_{B} voltage amplitude command VBcom to an initial voltage of 0, and sets an ON-OFF command to ON.

Then, in step S402, the CPU 34 determines whether the measurement time point has come. As the result of the determination, when the measurement time point has not come (S402/No), the process waits in step S402.

In contrast, as the result of the determination in step S402, when the measurement time point has come (S402/Yes), the process proceeds to step S403.

When the process proceeds to step S403, the CPU 34 acquires a second vibration component S output from the second vibration component detection unit 16, and a push-up vibration amplitude TS output from the push-up vibration amplitude detection unit 17.

Then, in step S404, the CPU 34 performs a calculation from the values of the push-up vibration amplitude TS acquired in step S403 and the V_{B} voltage amplitude command VBcom. That is, a sensitivity correction coefficient γ and an offset correction coefficient ε are calculated using these values and the functions T₅ and T₆ defined by a data table, expressions, and the like. The second vibration component S acquired in step S403 is compared with a target range for decreasing S in step S403-2, and it is determined whether S is above the range, below the range, or within the range. When the second vibration component S is above the range, a superimposition voltage coefficient α is set to α+dα in step S403-3, and when the second vibration component S is below the range, the superimposition voltage coefficient α is set to α−dα in step S403-4, and the second vibration component S is acquired again in step S403. When the second vibration component S is decreased to be within the target range, the process proceeds to step S404, and a speed V_{S} is calculated by using the superimposition voltage coefficient α, the sensitivity correction coefficient γ, and the offset correction coefficient ε. In the subsequent step, the speed command Vcom and the speed V_{S} set in step S404 are compared with each other to control the V_{B} voltage amplitude command VBcom.

Next, the control of the V_{B} voltage amplitude command VBcom will be described in steps S405 to S411.

In step S405, the CPU 34 compares the speed command Vcom set in step S401 with the speed V_{S} calculated in step S404.

As the result of the comparison in step S405, when the speed command Vcom is smaller than (<) the speed V_{S}, the process proceeds to step S406.

When the process proceeds to step S406, the CPU 34 subtracts a predetermined voltage dVB from the V_{B} voltage amplitude command VBcom.

Then, in step S407, the CPU 34 determines whether the V_{B} voltage amplitude command VBcom is smaller than VBmin.

As the result of the determination in step S407, when the V_{B} voltage amplitude command VBcom is smaller than VBmin (S407/Yes), the process proceeds to step S408.

When the process proceeds to step S408, the CPU 34 sets the V_{B} voltage amplitude command VBcom to VBmin.

As the result of the comparison in step S405, when the speed command Vcom is larger than (>) the speed V_{S}, the process proceeds to step S409.

When the process proceeds to step S409, the CPU 34 adds the predetermined voltage dVB to the V_{B} voltage amplitude command VBcom.

Then, in step S410, the CPU 34 determines whether the V_{B} voltage amplitude command VBcom is larger than VBmax.

As the result of the determination in step S410, when the V_{B} voltage amplitude command VBcom is larger than VBmax (S410/Yes), the process proceeds to step S411.

When the process proceeds to step S411, the CPU 34 sets the V_{B} voltage amplitude command VBcom to VBmax.

When the process of step S408 is completed, when the process of step S411 is completed, or when the speed command Vcom is the same as (=) the speed V_{S} in the comparison of step S405, the process proceeds to step S412. By repeating the operation of steps S405 to S411, the V_{B} voltage amplitude command VBcom is controlled so that the speed V_{S} approaches the speed command Vcom.

Then, in step S412, the CPU 34 determines whether a stop command has been input. As the result of the determination, when the stop command has not been input (S412/No), the process returns to step S402, and the process of step S402 and later is performed.

In contrast, as the result of the determination in step S412, when it is determined that the stop command has been input (S412/Yes), the process proceeds to step S413.

When the process proceeds to step S413, the CPU 34 sets the ON-OFF command to OFF. Accordingly, the outputs of the alternating signal V_{A} and the alternating signal V_{B} output from the alternating signal generation unit 15 become 0 V, and the contact body 406 (rotor) of the vibration type actuator 400 stops.

When the process of step S413 is completed, the process of the flowchart presented in FIG. 33 is completed.

In the second embodiment described above, the value of the V_{B} voltage amplitude command is used as an argument for setting the correction coefficients, for example. However, the amplitude ratio between the alternating signal V_{A} and the alternating signal V_{B}, the actually measured alternating signal V_{B}, or the amplitude of the drive voltage generated in accordance with the actually measured alternating signal V_{B} may be used.

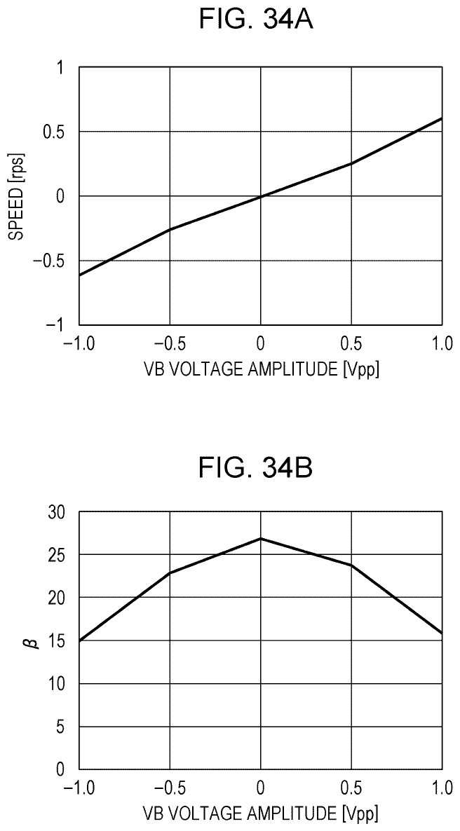

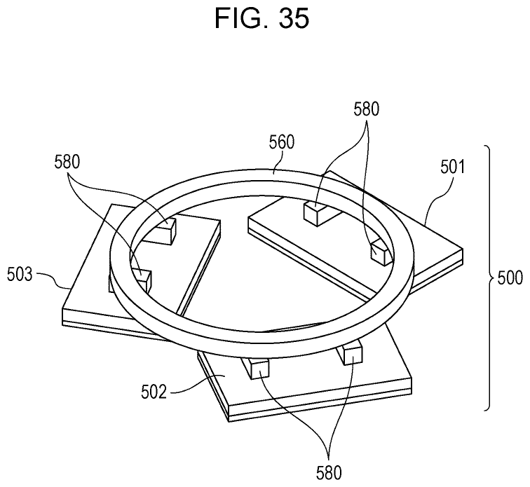

Alternatively, a torque can be estimated from the speed V_{S} estimated from the second vibration component S as in the first embodiment. The method will be described below. The speed at the time of the generation of a predetermined torque T₀ and the slope of a change in torque to a change in speed are obtained in advance for the voltage amplitude of the alternating signal V_{B}. FIG. 34A is a graph presenting the voltage amplitude of the alternating signal V_{B} and the speed (reference speed: V₀) when the torque is a predetermined value T₀. FIG. 34B is a graph presenting the ratio (β) of a change in torque to a change in speed.

Then, a torque TR can be obtained by Equation 54.

$$T R = {T}_{0} + {β}_{( VB voltage )} \cdot ( {V}_{S} - {V}_{0 ( {T}_{0} , VB voltage )} ) \qquad Equation 54$$

In the above example, the speed is controlled by fixing the phase difference between the alternating signal V_{A} and the alternating signal V_{B} to 90° and operating the voltage amplitude of the alternating signal V_{B}. However, the speed may be controlled by controlling the phase difference between the alternating signal V_{A} and the alternating signal V_{B}.

In the above example, the speed is controlled by operating the voltage amplitude of the alternating signal V_{B}, and hence the speed is estimated by using the offset correction coefficient & and the sensitivity correction coefficient γ with the V_{B} voltage amplitude as a parameter as in Equation 50 to Equation 53. Similarly, when the speed is controlled by using the phase difference between the alternating signal V_{A} and the alternating signal V_{B}, it is necessary to estimate the speed by using the offset correction coefficient ε and the sensitivity correction coefficient γ with the phase difference as a parameter instead of the V_{B} voltage amplitude.

Equation 54 provides the torque by using the reference speed V₀ with the V_{B} voltage amplitude as a parameter, and the ratio (β) of a change in torque to a change in speed. In this case, the torque can be obtained by using the reference speed V₀ with the phase difference as a parameter instead of the V_{B} voltage amplitude, and the ratio (β) of a change in torque to a change in speed, which are obtained.

In the present embodiment, the piezoelectric body 403 excites the vibration that expands and contracts the vibrating body 405, and the piezoelectric body 404 excites the torsional vibration in the vibrating body 405. In FIG. 23B, a similar effect can be obtained even when the piezoelectric body 403 is configured to excite bending in the left-right direction of the paper surface and the piezoelectric body 404 is configured to excite bending in the vertical direction of the paper surface. In this case, the bending vibration caused by the excitation of the piezoelectric body 403 becomes the push-up vibration at the protruding portion 480, and the bending vibration caused by the excitation of the piezoelectric body 404 becomes the feed vibration at the protruding portion 480.

In the above description, since the change in amplitude of the push-up vibration is small with respect to the change in speed of the contact body 6 caused by the force acting on the contact body 6, the speed is estimated by using the push-up vibration amplitude detected by the push-up vibration amplitude detection unit 17. However, the feed vibration amplitude may be used for the speed estimation. The feed vibration amplitude can be detected by measuring the amplitude of the current signal I_{B}.

### Third Embodiment

FIG. 35 is a view illustrating a general configuration of a vibration type actuator 500 according to a third embodiment.

Vibrating bodies 501, 502, and 503 are the same as the vibrating body 5 illustrated in FIGS. 1A to 1E, and are in contact at contact surfaces of respective protruding portions 580 along the circumference of an annular contact body 560. The output torque is increased by combining the thrusts of the three vibrating bodies 501, 502, and 503.

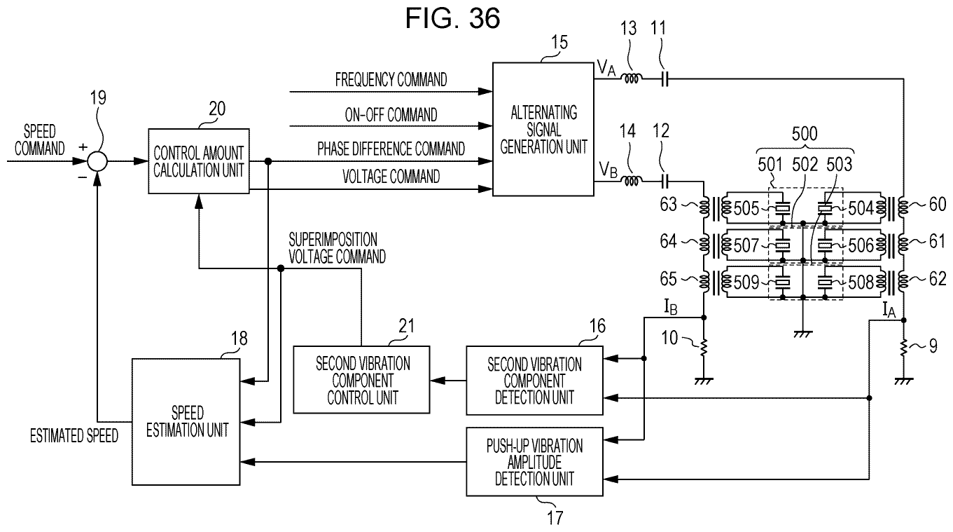

FIG. 36 is a diagram illustrating a first configuration example of a driving device for the vibration type actuator 500 according to the third embodiment of the present disclosure. The same reference signs are given to configurations similar to those illustrated in FIG. 2, and the detailed description thereof will be omitted.

The vibrating body 501 is provided with piezoelectric bodies 504 and 505, the vibrating body 502 is provided with piezoelectric bodies 506 and 507, and the vibrating body 503 is provided with piezoelectric bodies 508 and 509 as piezoelectric bodies for excitation. The piezoelectric bodies can be divided into A-phase piezoelectric bodies connected to an alternating signal V_{A} via an inductor 13, a capacitor 11, and three transformers, and B-phase piezoelectric bodies connected to an alternating signal V_{B} via an inductor 14, a capacitor 12, and three transformers.

The A-phase piezoelectric bodies are the piezoelectric bodies 504, 506, and 508, and are connected to the secondary windings of transformers 60, 61, and 62, respectively. The primary windings of the transformers 60, 61, and 62 are connected in series, and one end of the series connection is connected to the capacitor 11 and the other end of the series connection is connected to a resistor 9 for current detection.

In contrast, the B-phase piezoelectric bodies are piezoelectric bodies 505, 507, and 509, and are connected to the secondary windings of transformers 63, 64, and 65, respectively. The primary windings of the transformers 63, 64, and 65 are connected in series, and one end of the series connection is connected to the capacitor 12 and the other end of the series connection is connected to a resistor 10 for current detection.

The resistor 9 detects a current signal I_{A} corresponding to the vibration speed of the A-phase piezoelectric bodies. The resistor 10 detects a current signal I_{B} corresponding to the vibration speed of the B-phase piezoelectric bodies.

Since the vibrating bodies 501, 502, and 503 are driven in series connection, when an alternating voltage is applied to the primary sides of the transformers, well-aligned vibrations are formed. Vibrations superimposed on the respective vibrating bodies 501, 502, and 503 caused by excitation due to friction forces acting between the protruding portions 580 of the vibrating bodies 501, 502, and 503 and the contact body 560 (rotor) are also changed in a well aligned manner. Since the vibrations of the vibrating bodies are well aligned, the vibrations of the vibrating bodies can be detected as one vibration by detecting the current of the primary windings of the transformers as in the first embodiment.

That is, in this embodiment in which a plurality of vibrating bodies are connected in series and driven, the same method as the detection method of the second vibration component S described in the first embodiment can be used.

In the third embodiment, the plurality of vibrating bodies are connected to the transformers and connected in series, and voltages are applied to both ends, for example. However, the piezoelectric bodies of the plurality of vibrating bodies may be directly connected in series without the transformers. In the above example, the vibration is detected using the current of the primary windings of the transformers. However, a piezoelectric element for vibration detection may be additionally provided at the vibrating body. In this case, since the vibrations of the respective vibrating bodies are aligned by connecting them in series, the second vibration component S can be detected by detecting the vibration of one vibrating body, and the speed and the torque can be estimated and controlled as in the above embodiment.

### Fourth Embodiment

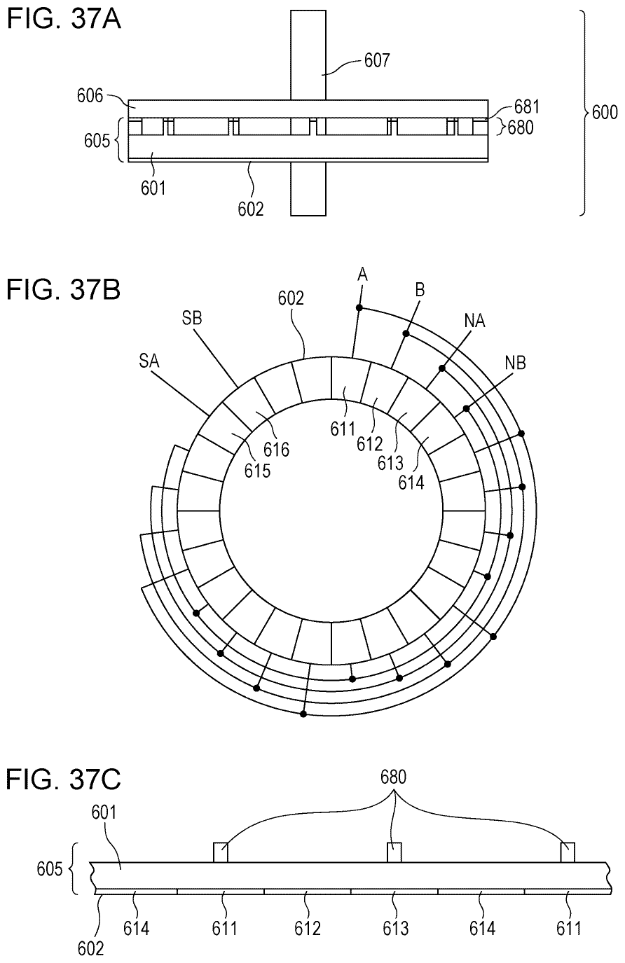

FIG. 37A is a view illustrating a general configuration of a vibration type actuator 600 according to a fourth embodiment.

The vibration type actuator 600 according to the fourth embodiment includes a vibrating body 605, a contact body 606 that is an annular rotor, and a rotational shaft 607 connected to the contact body 606 (rotor). The vibrating body 605 is an annular vibrating body made of a conductive material, and includes a piezoelectric element 602 and an elastic body 601 including protruding portions 680 that come into contact with the contact body 606 (rotor), on the upper surface of the annular shape. The protruding portions 680 include friction members 681 made of resin at contact portions with the contact body 606 (rotor). The piezoelectric element 602 is a component that forms a portion of the vibrating body 605 and excites the vibrating body 605.

FIG. 37B is a diagram illustrating an example of a plurality of electrode structures and electrical connection wiring formed on the piezoelectric element 602 illustrated in FIG. 37A.

As illustrated in FIG. 37B, the piezoelectric element 602 is provided with 24 electrodes at equal intervals on the circumference. The electrodes of the piezoelectric element 602 are electrically connected by connection wiring for every four electrodes along the circumference. Here, the regions of the piezoelectric element 602 in which the groups of electrodes connected to each other are provided are referred to as piezoelectric bodies 611, piezoelectric bodies 612, piezoelectric bodies 613, and piezoelectric bodies 614 on the connection basis.

The piezoelectric bodies 611 are disposed every 60° on the circumference. When an alternating voltage A is applied to the piezoelectric bodies 611, six-wave out-of-plane flexural vibrations are formed along the circumference of the vibrating body 605. When an alternating voltage B, an alternating voltage NA, and an alternating voltage NB, which are sequentially shifted in phase by 90° with respect to the alternating voltage A, are applied to the piezoelectric bodies 612, the piezoelectric bodies 613, and the piezoelectric bodies 614, respectively, six-wave out-of-plane progressive vibration waves are formed on the vibrating body 605. The six-wave progressive vibration waves generate a relative force between the protruding portions 680 of the vibrating body 605 and the contact body 606 (rotor) to rotate the contact body 606 (rotor).

The piezoelectric element 602 is provided with a plurality of electrodes for vibration detection. Regions of the piezoelectric element 602 where these electrodes are provided are a piezoelectric body 615 and a piezoelectric body 616. The piezoelectric body 615 detects the vibrations excited by the piezoelectric bodies 611 and the piezoelectric bodies 613 and outputs a vibration detection signal SA. The piezoelectric body 616 detects the vibrations excited by the piezoelectric bodies 612 and the piezoelectric bodies 614 and outputs a vibration detection signal SB.

FIG. 37C is a view illustrating a first example of the positional relationship between the piezoelectric bodies 611 to 614 and the protruding portions 680. The protruding portions 680 are provided at the centers of the electrode intervals of the piezoelectric bodies 611 and the piezoelectric bodies 613 to which the alternating voltage A and the alternating voltage NA are connected. When the excitation caused by the piezoelectric bodies 611 and 613 is A-phase excitation and the excitation caused by the piezoelectric bodies 612 and 614 is B-phase excitation, the A-phase excitation excites the protruding portions 680 to have a push-up vibration in which the protruding portions 680 vibrate up and down of the paper surface, and the B-phase excitation excites the protruding portions 680 to have a feed vibration in which the protruding portions 680 vibrate left and right of the paper surface.

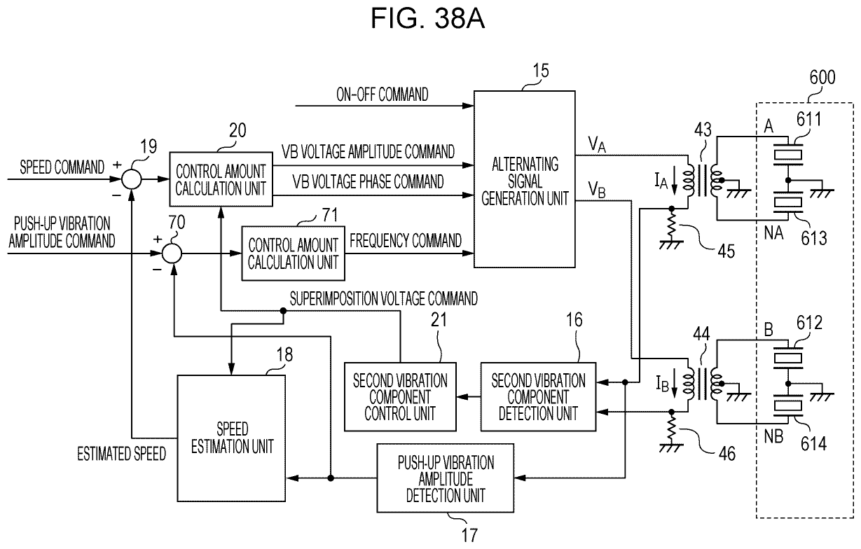

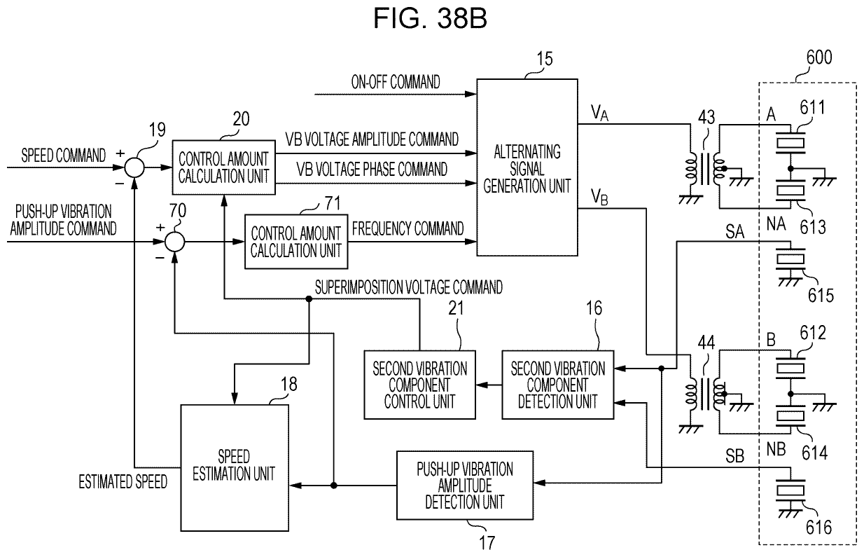

FIG. 38A is a diagram illustrating a first configuration example of a driving device for the vibration type actuator 600 according to the fourth embodiment of the present disclosure. The same reference signs are given to components similar to those illustrated in FIG. 24, and the detailed description thereof will be omitted.

The vibration type actuator 600 is an actuator driven by four-phase alternating voltages. The alternating voltage A and the alternating voltage NA, and the alternating voltage B and the alternating voltage NB are alternating voltages having opposite phases in which the phases are inverted. The paired piezoelectric bodies of the piezoelectric bodies 611 and 613, and the piezoelectric bodies 612 and 614, to which the alternating voltages of the opposite phases are applied, are connected to the secondary windings with center taps of transformers 43 and 44. An alternating signal V_{A} and an alternating signal V_{B}, which are outputs of an alternating signal generation unit 15, are applied to one ends of the primary windings of the transformer 43 and the transformer 44, and resistors 45 and 46 for current detection are connected to the other ends of the primary windings of the transformer 43 and the transformer 44.

A current signal I_{A} and a current signal I_{B}, which are signals detected by the resistor 45 and the resistor 46, are input to a second vibration component detection unit 16 and a push-up vibration amplitude detection unit 17. Then, a second vibration component S and a push-up vibration amplitude are detected by the operation described in the second embodiment described above, and the control of minimizing the second vibration component S is performed using a superimposition voltage command generated by a second vibration component control unit 21. A speed estimation unit 18 detects the rotational speed of the contact body 606 (rotor) based on the superimposition voltage command. Then, a comparator 19 compares the detected rotational speed with a speed command from a command unit (not illustrated). A control amount calculation unit 20 generates a V_{B} voltage amplitude command signal in accordance with the comparison result to control the voltage amplitude of the alternating signal V_{B}, thereby controlling the rotational speed.

In the fourth embodiment, the push-up vibration amplitude is controlled in addition to the control on the speed. A comparator 70 compares the output of the push-up vibration amplitude detection unit 17 with a push-up vibration amplitude command from a command unit (not illustrated). Next, the output of the comparator 70 is input to a control amount calculation unit 71, and a frequency command signal is generated by a proportional integral calculation. Then, an alternating signal generation unit 15 sets the frequency of the alternating signals V_{A} and V_{B} in accordance with the frequency command signal, so that the push-up vibration amplitude is controlled.

When the push-up vibration amplitude is controlled to be constant, the contact state between the contact body 606 (rotor) and the vibrating body 605 is stabilized, and hence the stability of the speed estimation can be improved.

FIG. 38B is a diagram illustrating a second configuration example of the driving device for the vibration type actuator 600 according to the fourth embodiment of the present disclosure. The same reference signs are given to components similar to those illustrated in FIG. 38A, and the detailed description thereof will be omitted.

In the first configuration example of the driving device for the vibration type actuator 600 according to the fourth embodiment, the vibrations are detected using the current signal I_{A} and the current signal I_{B}, for example. However, in the second configuration example, the vibrations are detected by the piezoelectric body 615 and the piezoelectric body 616. The piezoelectric body 615 outputs a vibration detection signal SA, and the piezoelectric body 616 outputs a vibration detection signal SB. Since the vibrations are directly detected instead of the current signals, the accuracy of the speed estimation can be improved.

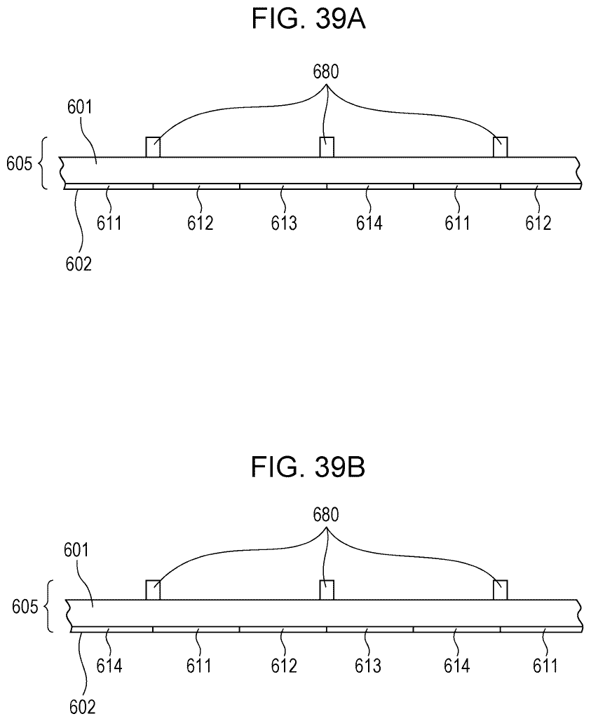

FIG. 39A is a view illustrating a second example of the positional relationship between the piezoelectric bodies 611 to 614 and the protruding portions 680. The protruding portion 680 in FIG. 39A is provided between the electrode intervals of the piezoelectric body 611 and the piezoelectric body 612 to which the alternating voltage A and the alternating voltage B are connected, and the protruding portion 680 is provided between the electrode intervals of the piezoelectric body 613 and the piezoelectric body 614 to which the alternating voltage NB and the alternating voltage NA are connected. Then, when the excitation caused by the piezoelectric bodies 611 and 613 is A-phase excitation and the excitation caused by the piezoelectric bodies 612 and 614 is B-phase excitation, the push-up vibration is excited by the sum component of the A-phase excitation and the B-phase excitation, and the feed vibration is excited by the difference component of the A-phase excitation and the B-phase excitation.

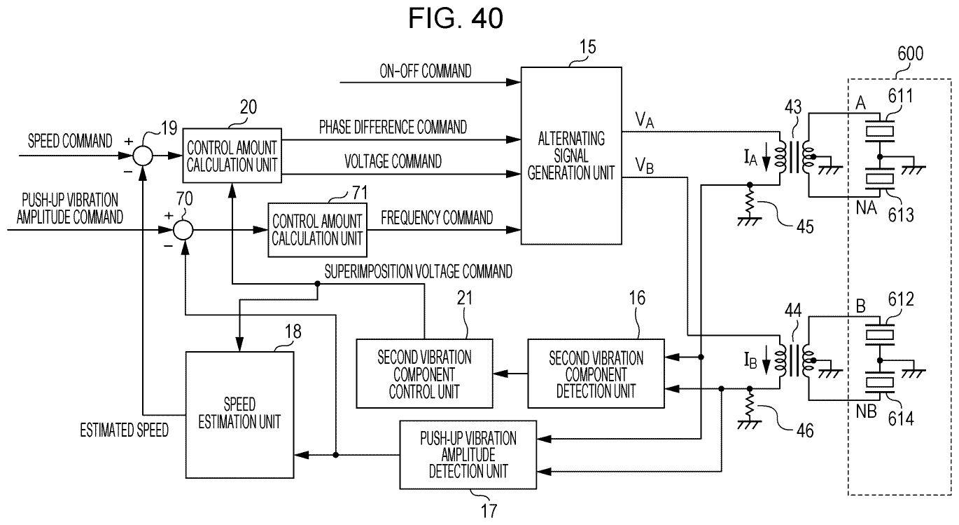

FIG. 40 is a diagram illustrating a third configuration example of the driving device for the vibration type actuator 600 according to the fourth embodiment of the present disclosure. The same reference signs are given to components similar to those illustrated in FIG. 2, and the detailed description thereof will be omitted.

The connection of the vibration type actuator 600 to the transformer 43 and the transformer 44, and to the resistor 45 and the resistor 46 are the same as that in the first configuration example of the driving device for the vibration type actuator 600 according to the fourth embodiment. In contrast, the position of the protruding portion 680 on the vibrating body 605 is different from that in the first configuration example of the driving device for the vibration type actuator 600 according to the fourth embodiment. Hence the connection of the current signal I_{A} and the current signal I_{B} to the second vibration component detection unit 16 and the push-up vibration amplitude detection unit 17 is different.

The current signal I_{A} and the current signal I_{B} are input to both the second vibration component detection unit 16 and the push-up vibration amplitude detection unit 17. (Current signal I_{A}+current signal I_{B}) represents the push-up vibration component, and (current signal I_{A}−current signal I_{B}) represents the feed vibration component. The second vibration component S and the push-up vibration amplitude are detected by the operation described in the first embodiment described above. Then, the second vibration component is minimized with the superimposition voltage command generated by the second vibration component control unit 21, and the rotational speed of the contact body 606 (rotor) is detected by the speed estimation unit 18 based on the superimposition voltage command.

FIG. 39B is a view illustrating a third example of the positional relationship between the piezoelectric bodies 611 to 614 and the protruding portions 680.

The protruding portion 680 is provided between the electrode intervals of the piezoelectric body 611 and the piezoelectric body 614 to which the alternating voltage A and the alternating voltage NB are connected, and the protruding portion 680 is provided between the electrode intervals of the piezoelectric body 612 and the piezoelectric body 613 to which the alternating voltage B and the alternating voltage NA are connected. Then, when the excitation caused by the piezoelectric bodies 611 and 613 is A-phase excitation and the excitation caused by the piezoelectric bodies 612 and 614 is B-phase excitation, the push-up vibration is excited by the difference component of the A-phase excitation and the B-phase excitation, and the feed vibration is excited by the sum component of the A-phase excitation and the B-phase excitation.

A case where the protruding portions 680 of the vibration type actuator 600 are located as illustrated in FIG. 39B will be described below. When this is driven by the driving device in FIG. 40, (current signal I_{A}−current signal I_{B}) represents the push-up vibration component and (current signal I_{A}+current signal I_{B}) represents the feed vibration component, contrary to the above description. Accordingly, the operations of the second vibration component detection unit 16 and the push-up vibration amplitude detection unit 17 also use the reverse signals.

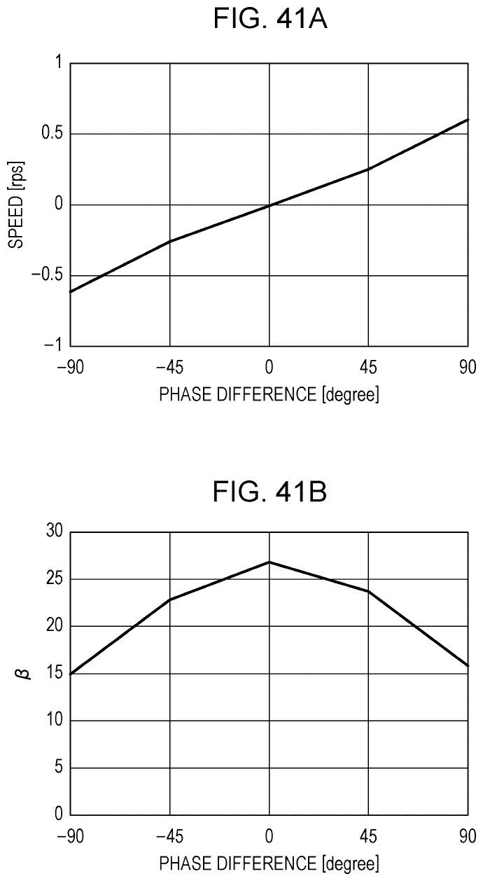

In this embodiment, the torque can be estimated based on the estimated speed as in the above embodiment. The speed at the time of the generation of a predetermined torque T₀ and the slope of a change in torque to a change in speed are obtained in advance for the phase difference between the alternating signal V_{A} and the alternating signal V_{B}. FIG. 41A is a graph presenting the phase difference between the alternating signal V_{A} and the alternating signal V_{B}, and the speed (reference speed: V₀) when the torque is a predetermined torque T₀. FIG. 41B is a graph presenting the ratio (β) of a change in torque to a change in speed. Then, a torque TR can be obtained by Equation 55.

$$T R = {T}_{0} + {β}_{( phase difference )} \cdot ( {V}_{S} - {V}_{0 ( {T}_{0} , phase difference )} ) \qquad Equation 55$$

### Fifth Embodiment

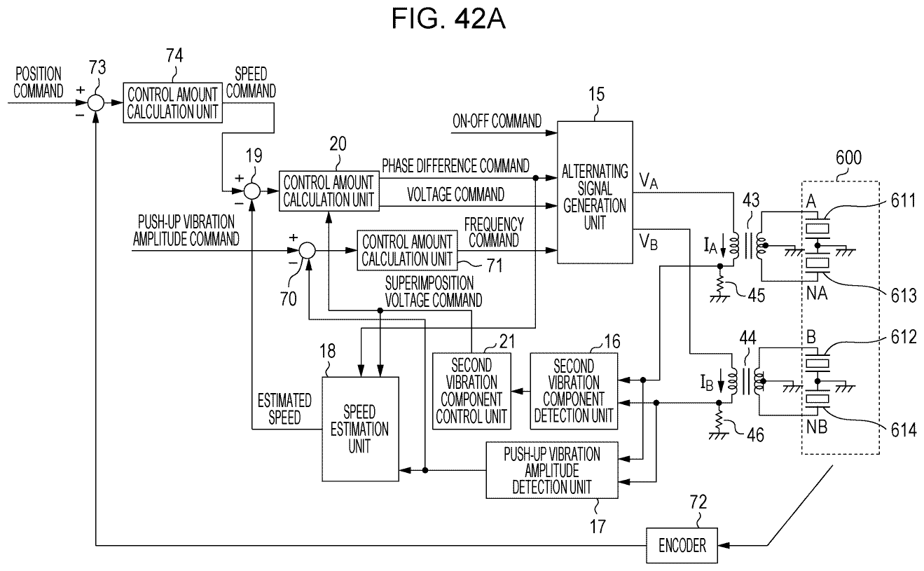

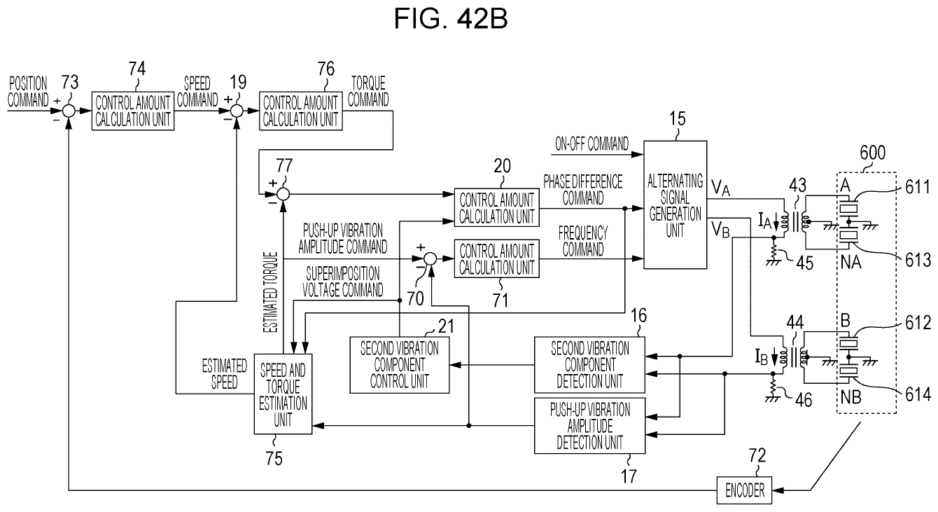

In the above embodiment, the control device that estimates the speed or the torque and controls the speed or the torque in accordance with the command value of the speed or the torque has been described. In this embodiment, an example in which the position is controlled by using an estimated value of the speed, or estimated values of the speed and the torque will be described. FIG. 42A is a diagram illustrating a first configuration example of a driving device for a vibration type actuator 600 according to the fifth embodiment of the present disclosure. FIG. 42A illustrates an example in which minor loop control of the speed is applied to the position control. Speed control using an estimated value of the speed according to the present disclosure is performed instead of detecting the rotational speed from differential information on the detected position.

The same reference signs are given to components similar to those illustrated in FIG. 40, and the detailed description thereof will be omitted. A rotary encoder 72 detects the rotational position of the vibration type actuator 600. The position detected by the rotary encoder 72 is compared with a position command from a command unit (not illustrated) by a comparator 73. The position deviation thereof is input to a control amount calculation unit 74, and a speed command signal is generated.

Next, the speed command signal is compared with an estimated speed from a speed estimation unit 18 by a comparator 19. A control amount calculation unit 20 generates a phase difference command signal by performing a proportional integral (PI) calculation on the comparison result. In this way, the phase difference between alternating signals V_{A} and V_{B} output from an alternating signal generation unit 15 is controlled, and the rotational speed and the position are controlled.

The speed estimated by the speed estimation unit 18 is detected from the vibration amplitude of the vibrating body 605 as in the above embodiment, and hence the speed can be detected at high speed even in the stop state. Thus, the speed can be estimated in a short time after the alternating signal generation unit 15 is commanded to be turned on by an ON-OFF signal from a command unit (not illustrated). Here, in order to describe this effect, an operation in a case where the vibration type actuator 600 starts driving from a state in which the ON-OFF signal is OFF, the torque is applied to the rotational shaft 607 of the vibration type actuator 600, and the vibration type actuator 600 is stopped by a holding torque caused by the friction force between the vibrating body 605 and the contact body 606 will be described.

First, it is assumed that the ON-OFF signal is switched from the OFF state to the ON state in a state in which a position command and the current position are the same. Then, since the position deviation is 0 with respect to the position command, the alternating signal generation unit 15 generates a signal in a state in which the phase difference between the alternating signal V_{A} and the alternating signal V_{B} is 0°. Next, the frequency of the alternating signals V_{A} and V_{B} approaches the resonance frequency of the vibrating body 605 in accordance with a push-up vibration amplitude command, and the push-up vibration amplitude approaches a predetermined amplitude. When the vibration amplitude of the vibrating body 605 reaches a certain level, the decreased friction force between the vibrating body 605 and the contact body 606 becomes smaller than the torque applied to the rotational shaft 607, and the rotational shaft 607 starts rotating. Here, the position is controlled in accordance with the position deviation and the speed estimation value, and returns to the position at the drive start time.

When this operation is performed by proportional integral differential (PID) control of the position, there is a time delay until the detection of the position deviation due to the influence of the rigidities of the rotary encoder 72 and the contact body 606 and the resolution of the rotary encoder 72, and hence the amount of deviation from the initial position increases. In contrast, when the speed estimation value is used, the speed can be detected without being affected by the rigidities of the rotary encoder 72 and the contact body 606 and the resolution of the rotary encoder 72, and hence the amount of deviation from the initial position can be decreased.

FIG. 42B is a diagram illustrating a second configuration example of the driving device for the vibration type actuator 600 according to the fifth embodiment of the present disclosure. The same reference signs are given to components similar to those illustrated in FIG. 42A, and the detailed description thereof will be omitted. A speed and torque estimation unit 75 receives a detected second vibration component superimposed on the vibrating body 605 and a component corresponding to the vibration amplitude in the direction in which the vibrating body 605 pushes up the contact body 606, and estimates a rotational speed of the contact body 606 and a torque between the vibrating body 605 and the contact body 606. A control amount calculation unit 76 receives the comparison result between an estimated speed from the speed and torque estimation unit 75 and a speed command signal from a control amount calculation unit 74, performs a proportional integral (PI) calculation, and generates a torque command signal. A comparator 77 compares the torque command signal with an estimated torque from the speed and torque estimation unit 75. The comparison result is input to a control amount calculation unit 20, and a proportional integral (PI) calculation is performed to generate a phase difference command signal.

Since the number of torque control loops is increased in the configuration in FIG. 42B as compared with the configuration in FIG. 42A, the control can be performed at a higher speed than that in the configuration in FIG. 42A. That is, considering the state at the drive start time described above, the magnitude of the torque applied to the outside can be detected in a state in which the rotational speed has slightly changed, and hence control at a higher speed than that in the case of only the speed control loop can be performed.

### Sixth Embodiment

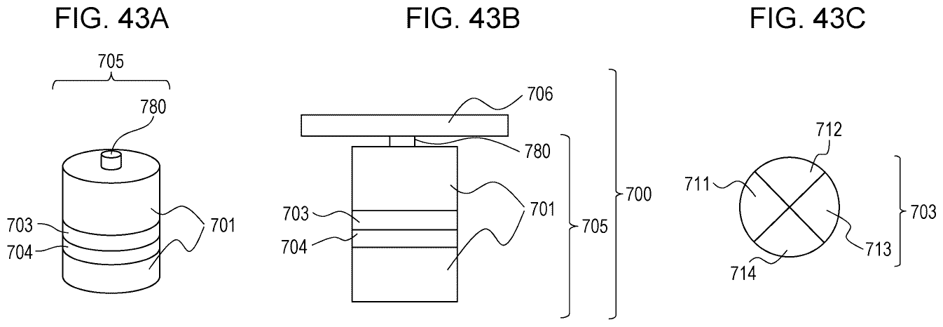

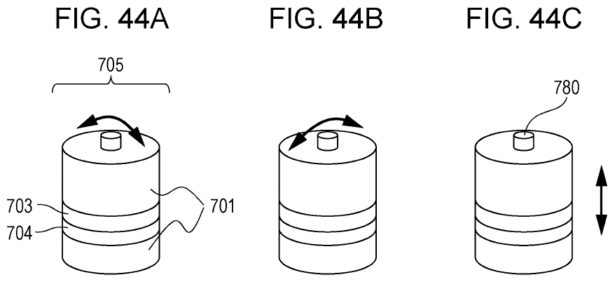

FIGS. 43A to 43C are views illustrating a general configuration of a vibration type actuator 700. FIGS. 44A to 44C are views illustrating vibration modes of the vibration type actuator 700. The general configuration and an operation principle of the vibration type actuator 700 according to a sixth embodiment will be described with reference to FIGS. 43A to 44C.

As illustrated in FIG. 43B, the vibration type actuator 700 according to the sixth embodiment includes a vibrating body 705 and a contact body 706. As illustrated in FIG. 43A, the vibrating body 705 is a columnar vibrating body made of a conductive material, and includes a piezoelectric body 703 and a piezoelectric body 704, and elastic bodies 701 that sandwich these piezoelectric bodies from above and below and include a protruding portion 780 at an upper portion of the column. The piezoelectric body 704 excites a vibration (stretching vibration mode) for expanding and contracting the vibrating body 705 in the height direction of the column as illustrated in FIG. 44C. The piezoelectric body 703 is configured to excite two bending vibrations in which the vibrating body 705 bends in two orthogonal directions as illustrated in FIGS. 44A and 44B. The piezoelectric body 703 and the piezoelectric body 704 are sandwiched between and fixed to the elastic bodies 701 by a fastening member (not illustrated).

The contact body 706 illustrated in FIG. 43B is a plate-shaped moving body that comes into pressure contact with the protruding portion 780 of the vibrating body 705 with a constant pressure by a pressure mechanism (not illustrated) and is supported so as to be movable in the left-right direction (X direction) and the depth direction (Y direction) of the paper surface. The contact body 706 can be moved in any direction of the XY plane by the vibration excited in the vibrating body 705. FIG. 43C illustrates the arrangement of electrodes provided at the piezoelectric body 703. The electrodes are insulated from each other. The electrodes are divided into four portions. Electrodes 711 and 713 are electrodes for exciting a bending vibration in the X direction in the vibrating body 705. Electrodes 712 and 714 are electrodes for exciting a bending vibration in the Y direction. In the following description, the electrodes 711, 712, 713, and 714 are described as piezoelectric bodies 711, 712, 713, and 714.

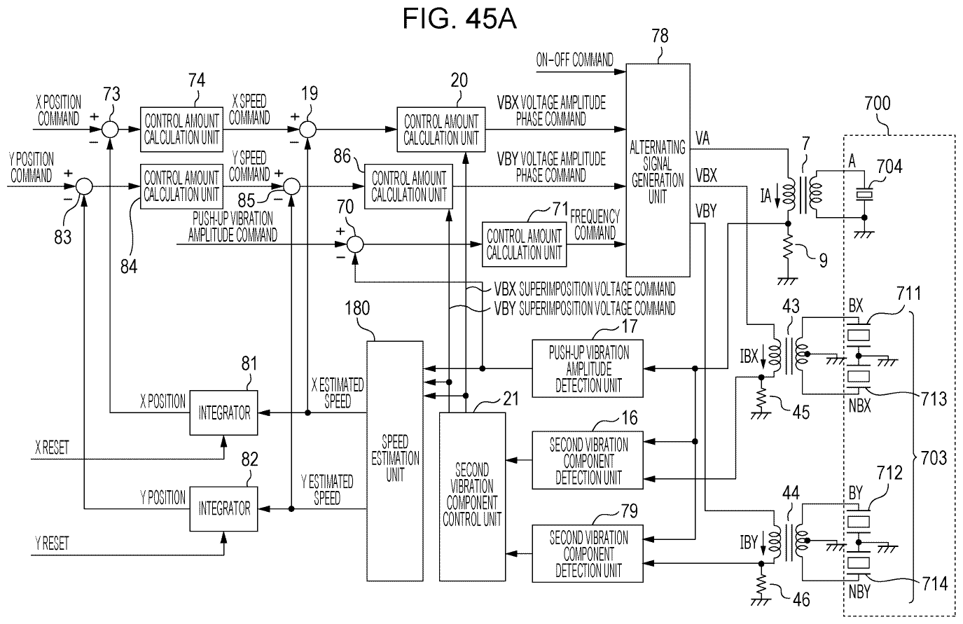

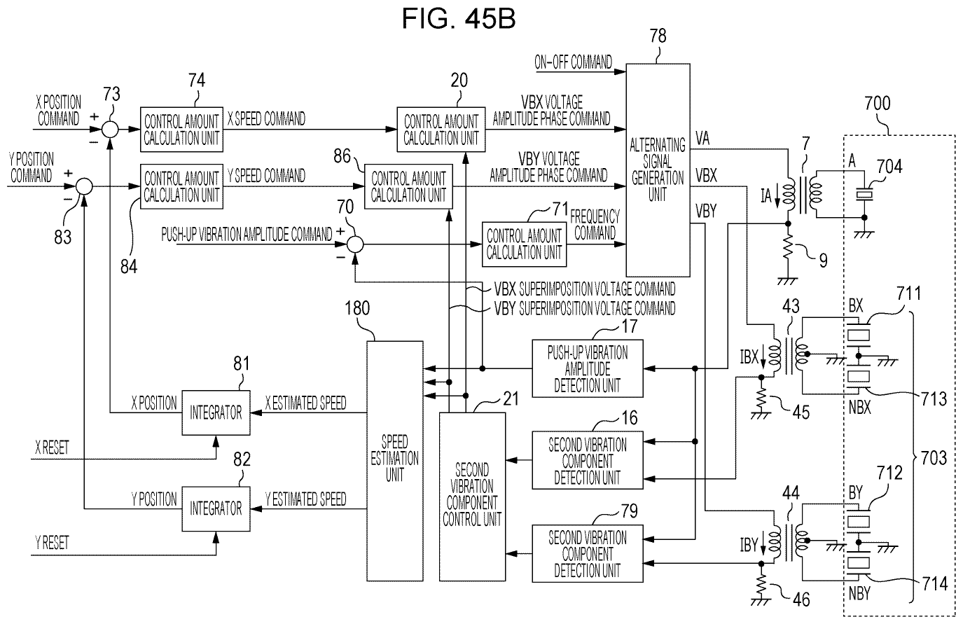

FIG. 45A is a diagram illustrating a first configuration example of a driving device for the vibration type actuator 700 according to the sixth embodiment, and illustrates a configuration of a control device that controls the position of the contact body 706 in the XY plane.

An alternating voltage generation unit 78 outputs alternating signals V_{A}, VBX, and VBY based on a frequency command from a control amount calculation unit 71, a VBX voltage amplitude command output from a control amount calculation unit 20, and a VBY voltage amplitude command from a control amount calculation unit 86. The alternating signal V_{A} and the alternating signal VBX, and the alternating signal V_{A} and the alternating signal VBY are signals having a phase difference of 90°. The alternating signal V_{A} is set to a predetermined amplitude, and the alternating signals VBX and VBY are set to amplitudes based on the VBX voltage amplitude command and the VBY voltage amplitude command, respectively. When the VBX voltage amplitude command and the VBY voltage amplitude command are negative values, the alternating signal VBX and the alternating signal VBY are inverted in polarity and output.

The alternating signal V_{A} is connected to one end of the primary winding of a transformer 7, and a resistor 9 for current detection is connected to the other end of the primary winding of the transformer 7. A boosted alternating voltage A is applied to the piezoelectric body 704 of the vibration type actuator 700 connected to the secondary winding of the transformer 7. The alternating signal VBX and the alternating signal VBY are connected to one ends of the primary windings of a transformer 43 and a transformer 44, and a resistor 45 and a resistor 46 for current detection are connected to the other ends of the primary windings of the transformer 43 and the transformer 44, respectively. Boosted alternating voltage BX and alternating voltage NBX having the inverted phases are applied to the piezoelectric body 711 and the piezoelectric body 713 connected to the secondary winding of the transformer 43. Similarly, boosted alternating voltage BY and alternating voltage NBY having the inverted phases are applied to the piezoelectric body 712 and the piezoelectric body 714 connected to the secondary winding of the transformer 44.

Here, the inductor values of the secondary windings of the transformer 7, and the transformer 43 and the transformer 44 are frequency-matched with the damping capacities of the piezoelectric body 704 and the piezoelectric bodies 711 to 714. Accordingly, currents substantially proportional to the vibration strain speeds of the piezoelectric body 704 and the piezoelectric bodies 711 to 714 flow through the primary windings of the transformer 7, and the transformer 43 and the transformer 44. The resistor 9, and the resistor 45 and the resistor 46 convert the currents flowing through the primary windings of the transformers connected thereto into voltages to generate a current signal I_{A}, a current signal IBX, and a current signal IBY.

The current signals indicate different vibration states. The current signal I_{A} (first detection signal) represents a stretching vibration mode (push-up vibration mode) of the piezoelectric body 704. The current signal IBX (second detection signal (X)) represents a bending vibration mode in the X direction of the vibrating body 705 (X-direction feed vibration mode). The current signal IBY (second detection signal (Y)) represents a bending vibration mode in the Y direction of the vibrating body 705 (Y-direction feed vibration mode).

Next, a configuration related to estimation and control of the speed will be described. A push-up vibration amplitude detection unit 17 receives the current signal I_{A} and detects a push-up vibration amplitude. A second vibration component detection unit 16 and a second vibration component detection unit 79 receive the current signal IBX and the current signal IBY, and detect an X-direction component and a Y-direction component of a second vibration component, respectively. The X-direction component and the Y-direction component of the second vibration component are input to a second vibration component control unit 21, and the second vibration components in the X direction and the Y direction are minimized with generated superimposition voltage components in the X direction and the Y direction, respectively. A speed estimation unit 180 estimates a thrust in the X direction and a thrust in the Y direction acting between the contact body 706 and the protruding portion 780, from the superimposition voltage component of the X-direction component and the superimposition voltage component of the Y-direction component, and further detects the speed in the X direction (X estimated speed) and the speed in the Y direction (Y estimated speed).

The detected X estimated speed and Y estimated speed are integrated by an integrator 81 and an integrator 82, and converted into an X position and a Y position, respectively. The X position and the Y position indicate amounts of change (displacements) from the initial values of the integrator 82 and the integrator 83. Then, the X position and the Y position are compared with an X position command and a Y position command from command units (not illustrated) by a comparator 73 and a comparator 83, respectively. An X speed command and a Y speed command are generated by a control amount calculation unit 74 and a control amount calculation unit 84, respectively, in accordance with the comparison results. Next, the X speed command and the Y speed command are compared with the X estimated speed and the Y estimated speed by a comparator 19 and a comparator 85, respectively, and the VBX voltage amplitude command and the VBY voltage amplitude command are generated by the control amount calculation unit 20 and the control amount calculation unit 86, respectively, in accordance with the comparison results. The control device operating in this manner controls the position in the X direction and the position in the Y direction of the contact body 706.

The integrator 81 and the integrator 82 can reset errors accumulated due to integration errors, by an X reset signal and a Y reset signal from the outside, respectively.

FIG. 45B is a diagram illustrating a second configuration example of the driving device for the vibration type actuator 700 according to the sixth embodiment, and has a configuration in which the minor loop control system for the speed is removed from the configuration in FIG. 45A.

The control amount calculation unit 74 and the control amount calculation unit 84 perform a PID control calculation to generate the VBX voltage amplitude command and the VBY voltage amplitude command.

The control device, and the vibration type driving device including the vibration type actuator and the control device described above can be suitably used for an optical device such as a lens barrel including an optical element such as a lens, and an image pickup device including an image pickup element such as an image sensor. In addition to the above-described application examples, the application is available to various electronic devices as a vibration type driving device for driving a member to be driven.

According to the present disclosure, it is possible to estimate the speed with sufficient accuracy by a simple configuration regardless of the generation of a force (or a torque). Further, since the speed including the direction can be detected, the stop state can be detected at a high speed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-057459, filed Mar. 29, 2024, which is hereby incorporated by reference herein in its entirety.

What is claimed is:

1. A driving device for a vibration type actuator including a vibrating body including an elastic body and an electro-mechanical energy conversion element, and a contact body that comes into contact with the elastic body, the vibrating body and the contact body relatively moving by a vibration generated in the vibrating body,
wherein the vibration includes a first vibration component generated in the vibrating body by a voltage applied to the electro-mechanical energy conversion element, and a second vibration component generated in the vibrating body by contact between the contact body and the elastic body, and
wherein the driving device detects a signal corresponding to the second vibration component, cancels the second vibration component by superimposing a superimposition voltage component on the voltage, and detects a speed between the vibrating body and the contact body based on the superimposition voltage component.

2. The driving device according to claim 1, wherein the superimposition voltage component is an alternating voltage that is superimposed with a predetermined time phase with respect to a displacement of a push-up vibration component in a direction perpendicular to contact surfaces of the vibrating body and the contact body, the push-up vibration component being included in the first vibration component, or the first vibration component and the second vibration component.

3. The driving device according to claim 1, wherein the superimposition voltage component includes a feed vibration excitation voltage component that is superimposed with a predetermined time phase with respect to a component of the voltage that excites a feed vibration component in a direction parallel to contact surfaces of the vibrating body and the contact body, the feed vibration component being included in the first vibration component.

4. The driving device according to claim 1, wherein the superimposition voltage component is generated with reference to any signal of the voltage that is applied to the electro-mechanical energy conversion element.

5. The driving device according to claim 1,
wherein the electro-mechanical energy conversion element is configured to be applied with a first drive voltage and a second drive voltage based on a first signal and a second signal that are independent of each other,
wherein the first vibration component includes a drive vibration in a first direction and a drive vibration in a second direction, the drive vibration in the first direction being generated based on one of a sum or a difference of a third vibration component generated by the first drive voltage and a fourth vibration component generated by the second drive voltage, and the drive vibration in the second direction being generated based on the other one of the sum or the difference,
wherein the second vibration component includes at least one vibration component of the drive vibration in the first direction or the drive vibration in the second direction, and
wherein the signal corresponding to the second vibration component is detected based on a first detection signal for detecting a vibration in a same direction as a direction of the third vibration component and a second detection signal for detecting a vibration in a same direction as a direction of the fourth vibration component.

6. The driving device according to claim 5, wherein the signal corresponding to the second vibration component is detected from a difference between an amplitude of the first detection signal and an amplitude of the second detection signal.

7. The driving device according to claim 5, wherein the signal corresponding to the second vibration component is detected from at least one of a parameter that changes due to an inclination, or parameters of an inclination angle, a length of a minor axis, a length of a major axis, a height, and a width in a Lissajous diagram drawn by using the first detection signal and the second detection signal.

8. The driving device according to claim 7, wherein the Lissajous diagram is drawn with a first axis as the first detection signal and a second axis as the second detection signal.

9. The driving device according to claim 7, wherein the Lissajous diagram is drawn with a first axis as a sum signal of the first detection signal and the second detection signal, and a second axis as a difference signal of the first detection signal and the second detection signal.

10. The driving device according to claim 5,
wherein a vector based on an amplitude and a phase of the first detection signal is a first signal vector, and a vector based on an amplitude and a phase of the second detection signal is a second signal vector,
wherein one of a sum or a difference of the first signal vector and the second signal vector is a first vibration vector, and the other one of the sum or the difference is a second vibration vector,
wherein a vector component in a same direction as the first vibration vector is a same-direction component, and a vector component in a normal direction of the first vibration vector is a normal-direction component, and
wherein the signal corresponding to the second vibration component is detected from a difference between the same-direction components of the first signal vector and the second signal vector, a difference between the normal-direction components of the first signal vector and the second signal vector, and a ratio set in accordance with a magnitude of the first vibration vector.

11. The driving device according to claim 5,
wherein the first detection signal is a first signal vector, and the second detection signal is a second signal vector,
wherein one of a sum or a difference of the first signal vector and the second signal vector is a first vibration vector, and the other one of the sum or the difference is a second vibration vector,
wherein a vector component in a same direction as the first vibration vector is a same-direction component, and a vector component in a normal direction of the first vibration vector is a normal-direction component, and
wherein the signal corresponding to the second vibration component is detected from the same-direction component of the second vibration vector, the normal-direction component of the second vibration vector, and a ratio set in accordance with a magnitude of the first vibration vector.

12. The driving device according to claim 5,
wherein one signal of a sum signal or a difference signal of the first detection signal and the second detection signal is a reference signal, and the other signal of the sum signal or the difference signal is a measurement object signal,
wherein a phase of the reference signal is a reference phase, and
wherein the signal corresponding to the second vibration component is detected by performing interval integration on the measurement object signal in a phase interval set relative to the reference phase.

13. The driving device according to claim 5,
wherein one signal of a sum signal or a difference signal of the first detection signal and the second detection signal is a reference signal, and the other signal of the sum signal or the difference signal is a measurement object signal,
wherein a phase of the reference signal is a reference phase, and
wherein the signal corresponding to the second vibration component is detected by performing synchronous detection on the measurement object signal using a referential signal generated with a phase difference set relative to the reference phase.

14. The driving device according to claim 5,
wherein a first comparison signal corresponding to the first detection signal and a second comparison signal corresponding to the second detection signal are generated based on at least one of an amplitude, a phase difference, or a frequency of voltages based on the first signal and the second signal, and
wherein the signal corresponding to the second vibration component is detected from a difference between the first detection signal and the first comparison signal and a difference between the second detection signal and the second comparison signal.

15. The driving device according to claim 5,
wherein one of a first comparison signal corresponding to a sum of the first detection signal and the second detection signal or a second comparison signal corresponding to a difference between the first detection signal and the second detection signal is generated based on at least one of an amplitude, a phase difference, or a frequency of voltages based on the first signal and the second signal, and
wherein the signal corresponding to the second vibration component is detected from a difference between the sum of the first detection signal and the second detection signal, and the first comparison signal, or a difference between the difference between the first detection signal and the second detection signal, and the second comparison signal.

16. The driving device according to claim 5, wherein the speed between the vibrating body and the contact body is detected based on the superimposition voltage component, an amplitude of a sum or an amplitude of a difference of the first detection signal and the second detection signal, and a phase difference between the first signal and the second signal or between the first drive voltage and the second drive voltage.

17. The driving device according to claim 5,
wherein the vibrating body has a first natural vibration and a second natural vibration, and
wherein the first natural vibration is excited in accordance with one of a sum or a difference of the first drive voltage and the second drive voltage, and the second natural vibration is excited in accordance with the other one of the sum or the difference.

18. The driving device according to claim 1,
wherein the electro-mechanical energy conversion element is configured to be applied with a first drive voltage and a second drive voltage based on a first signal and a second signal that are independent of each other,
wherein the first vibration component includes a drive vibration in a first direction generated based on the first drive voltage, and a drive vibration in a second direction generated based on the second drive voltage,
wherein the second vibration component includes a vibration component in at least one of the first direction or the second direction, and
wherein the signal corresponding to the second vibration component is detected from a first detection signal for detecting a vibration component in a same direction as a direction of the drive vibration in the first direction including the drive vibration in the first direction, and a second detection signal for detecting a vibration component in a same direction as a direction of the drive vibration in the second direction including the drive vibration in the second direction.

19. The driving device according to claim 18, wherein the signal corresponding to the second vibration component is detected from a difference between an amplitude of a sum of the first detection signal and the second detection signal, and an amplitude of a difference between the first detection signal and the second detection signal.

20. The driving device according to claim 18, wherein the signal corresponding to the second vibration component is detected from at least one of a parameter that changes due to an inclination, an inclination angle, a length of a minor axis, a length of a major axis, a height, or a width in a Lissajous diagram drawn by using the first detection signal and the second detection signal.

21. The driving device according to claim 20, wherein the Lissajous diagram is drawn with a first axis as the first detection signal and a second axis as the second detection signal.

22. The driving device according to claim 20, wherein the Lissajous diagram is drawn with a first axis as a sum signal of the first detection signal and the second detection signal, and a second axis as a difference signal of the first detection signal and the second detection signal.

23. The driving device according to claim 18,
wherein a vector based on the first detection signal is a first vibration vector, and a vector based on the second detection signal is a second vibration vector, wherein a vector component in a same direction as the first vibration vector is a same-direction component, and a vector component in a normal direction of the first vibration vector is a normal-direction component, and
wherein the signal corresponding to the second vibration component is detected from the same-direction component of the second vibration vector, the normal-direction component of the second vibration vector, and a ratio set in accordance with a magnitude of the first vibration vector.

24. The driving device according to claim 18,
wherein a vector based on an amplitude and a phase of the first detection signal is a first vibration vector, and a vector based on an amplitude and a phase of the second detection signal is a second vibration vector,
wherein a vector component in a same direction as the first vibration vector is a same-direction component, and a vector component in a normal direction of the first vibration vector is a normal-direction component, and
wherein the signal corresponding to the second vibration component is detected from a difference between the same-direction component of a sum of the first vibration vector and the second vibration vector and the same-direction component of a difference between the first vibration vector and the second vibration vector, a difference between the normal-direction component of the sum of the first vibration vector and the second vibration vector and the normal-direction component of the difference between the first vibration vector and the second vibration vector, and a ratio set in accordance with a magnitude of the first vibration vector.

25. The driving device according to claim 18,
wherein one signal of the first detection signal or the second detection signal is a reference signal, and the other signal of the first detection signal or the second detection signal is a measurement object signal,
wherein a phase of the reference signal is a reference phase, and
wherein the signal corresponding to the second vibration component is detected by performing interval integration on the measurement object signal in a phase interval set relative to the reference phase.

26. The driving device according to claim 18,
wherein one signal of the first detection signal or the second detection signal is a reference signal, and the other signal of the first detection signal or the second detection signal is a measurement object signal,
wherein a phase of the reference signal is a reference phase, and
wherein the signal corresponding to the second vibration component is detected by performing synchronous detection on the measurement object signal using a referential signal generated with a phase difference set relative to the reference phase.

27. The driving device according to claim 18,
wherein one of a first comparison signal corresponding to the first detection signal or a second comparison signal corresponding to the second detection signal is generated based on an amplitude, a phase difference, and a frequency of voltages based on the first signal and the second signal, and
wherein the signal corresponding to the second vibration component is detected from a difference between the first detection signal and the first comparison signal or a difference between the second detection signal and the second comparison signal.

28. The driving device according to claim 18, wherein the speed between the vibrating body and the contact body is detected based on the superimposition voltage component, an amplitude of the first detection signal, and an amplitude or a phase difference of the first signal and the second signal or of the first drive voltage and the second drive voltage.

29. The driving device according to claim 5, wherein the speed between the vibrating body and the contact body is detected based on the superimposition voltage component, and a frequency, an amplitude, and a phase difference of the first signal and the second signal or of the first drive voltage and the second drive voltage.

30. The driving device according to claim 5,
wherein the first vibration component is composed of the drive vibration in the first direction in which the elastic body vibrates in a direction perpendicular to contact surfaces of the elastic body and the contact body at the contact surfaces, and the drive vibration in the second direction in which the elastic body vibrates in a relative movement direction of the elastic body and the contact body at the contact surfaces, and
wherein the second vibration component is composed of a vibration component in a same direction as a direction of the drive vibration in the first direction and a vibration component in a same direction as a direction of the drive vibration in the second direction.

31. The driving device according to claim 18,
wherein the vibrating body has a first natural vibration and a second natural vibration, and
wherein the first drive voltage excites the first natural vibration, and the second drive voltage excites the second natural vibration.

32. The driving device according to claim 5, wherein the vibrating body is annular, and has a first electrode interval and a second electrode interval provided at different positions of the electro-mechanical energy conversion element.

33. The driving device according to claim 5,
wherein the vibrating body includes a plurality of independent vibrating bodies,
wherein the respective electro-mechanical energy conversion elements provided in the plurality of vibrating bodies are electrically connected in series, and
wherein the first drive voltage and the second drive voltage are applied to both ends of the electro-mechanical energy conversion elements connected in series.

34. The driving device according to claim 5, wherein the first detection signal and the second detection signal are signals corresponding to outputs of the electro-mechanical energy conversion element.

35. The driving device according to claim 5, wherein the first detection signal and the second detection signal are signals corresponding to currents flowing by the first drive voltage and the second drive voltage.

36. The driving device according to claim 35, wherein the signals corresponding to the currents are signals corresponding to mechanical arm currents proportional to a vibration speed of the vibrating body.

37. The driving device according to claim 5, wherein the signal corresponding to the second vibration component changes relative to the speed between the vibrating body and the contact body.

38. The driving device according to claim 5, wherein an amplitude of the drive vibration in the first direction is controlled by setting a frequency or an amplitude of the first signal and the second signal that are independent of each other.

39. The driving device according to claim 1, wherein the driving device detects a force between the vibrating body and the contact body based on a reference value of a predetermined speed and the speed.

40. The driving device according to claim 39, wherein the driving device detects a displacement between the vibrating body and the contact body based on an integral value of the speed.

41. The driving device according to claim 1, wherein the driving device controls the vibration type actuator based on a signal of a speed command and the detected speed.

42. The driving device according to claim 39, wherein the driving device controls the vibration type actuator based on a signal of a force command and the detected force.

43. The driving device according to claim 40, wherein the driving device controls the vibration type actuator based on a signal of a displacement command and the detected displacement.

44. The driving device according to claim 43, further comprising:
a position detector configured to detect a position of the contact body,
wherein the driving device generates the signal of the displacement command based on a signal of a position command and the detected position.

45. The driving device according to claim 41, further comprising:
a position detector configured to detect a position of the contact body,
wherein the driving device generates the signal of the speed command based on a signal of a position command and the detected position.

46. The driving device according to claim 42, wherein the driving device generates the signal of the force command based on a signal of a speed command and the detected speed.

47. A vibration type driving device comprising:
a vibration type actuator including a vibrating body including an elastic body and an electro-mechanical energy conversion element, and a contact body that comes into contact with the elastic body; and
the driving device according to claim 1,
wherein the vibrating body and the contact body relatively move in a predetermined movement direction by a vibration of the vibrating body.

48. An optical device comprising:
an optical element; and
the vibration type driving device according to claim 47 that drives the optical element.

49. An image pickup device comprising:
an image pickup element; and
the vibration type driving device according to claim 47 that drives the image pickup element.

50. An electronic device comprising:
a member; and
the vibration type driving device according to claim 47 that drives the member.
